(19) United States
(12) Patent Application Publication
(10) Pub. No.: US 2023/0044129 A1
(43) Pub. Date: Feb. 9, 2023

(54) Polyoxometalates Comprising Noble Metals and Metal Cluster Units Thereof

(71) Applicants: Ali S. Mougharbel, Bremen (DE); Helge Jaensch, Grimbergen (BE); Ananthu Rajan, Bremen (DE); Saurav Bhattacharya, Bremen (DE); Ulrich Kortz, Bremen (DE)

(72) Inventors: Ali S. Mougharbel, Bremen (DE); Helge Jaensch, Grimbergen (BE); Ananthu Rajan, Bremen (DE); Saurav Bhattacharya, Bremen (DE); Ulrich Kortz, Bremen (DE)

(21) Appl. No.: 17/778,404

(22) PCT Filed: Nov. 6, 2020
(86) PCT No.: PCT/EP2020/081254

§ 371 Date: May 19, 2022

(30) Foreign Application Priority Data
Nov. 21, 2019 (EP) 19210637.5

(51) Int. Cl. C07F 17/02; C01G 55/00; C01G 5/00; C01G 41/00

(52) U.S. Cl. CPC C07F 17/02; C01G 55/002; C01G 5/006; C01G 41/006

(57) ABSTRACT

The invention relates to polyoxometalates represented by the formula (Aₙ)m⁺[(MR′ₜ)ₛO_{y}H_{q}R_{z}(X₈W₄₈₊ᵣO₁₈₄₊₄ᵣ)]^{m-} or solvates thereof, corresponding supported polyoxometalates, and processes for their preparation, as well as corresponding metal cluster units, optionally in the form of a dispersion in a liquid carrier medium or immobilized on a solid support, and processes for their preparation, as well as their use in conversion of organic substrate.

### CROSS REFERENCE TO RELATED APPLICATIONS

This application claims the benefit of European Patent Application Serial No. 19210637.5, filed 21 Nov. 2019.

### FIELD OF THE INVENTION

This invention relates to new polyoxometalates (POMs) and metal cluster units. Furthermore, this invention relates to processes for the preparation of said new POMs and metal cluster units and to their use in catalytic reactions with organic molecules.

### BACKGROUND OF THE INVENTION

POMs are a unique class of inorganic metal-oxygen clusters. They consist of a polyhedral cage structure or framework bearing a negative charge which is balanced by cations that are usually external to the cage, and may also contain internally or externally located heteroatom(s) or guest atom(s). The framework of POMs comprises a plurality of metal atoms, which can be the same or different, bonded to oxygen atoms. In the plurality of known POMs, the framework metals are dominated by a few elements including transition metals from Group 5 and Group 6 in their high oxidation states, e.g., tungsten (VI), molybdenum (VI), vanadium (V), niobium (V) and tantalum (V).

The first example in the POM family is the so-called Keggin anion [XM₁₂O₄₀]ⁿ⁻ with X being a heteroatom selected from a variety of elements, e.g., P, and M being a Group 5 or Group 6 metal such as Mo or W. These anions consist of an assembly of corner- and edge-shared MO₆ octahedra of the metals of Groups 5 or 6 around a central XO₄ tetrahedron.

One structural motif that has been intensively studied in the field of POMs is the crown-shaped heteropolyanion [H₇P₈W₄₈O₁₈₄]³³⁻, which species is composed of four [H₂P₂W₁₂O₄₈]¹²⁻ fragments which are linked by capping tungsten atoms resulting in a cyclic [P₈W₄₈O₁₈₄]- arrangement having central cavity of around 10 Å diameter (Inorg. Chem. 1985, 24, 4610-4614; Inorg. Synth. 1990, 27, 110). The polyanion [H₇P ₈W₄₈O₁₈₄]³³⁻ has been found a suitable catalyst for the hydrogen evolution reaction (Energy Environ. Sci. 2016, 9, 1012-1023). Initially, it was concluded that the highly stable [H₇P₈W₄₈O₁₈₄]³³⁻ heteropolyanion does not give complexes with divalent or trivalent transition-metal ions.

However, in 2005 Kortz and co-workers proved this assumption wrong. The wheel-shaped [Cu₂₀Cl(OH)₂₄(H₂O)₁₂(P₈W₄₈O₁₈₄)]₂₅₋ ion has been the first transition-metal-substituted derivative of the [H₇P₈W₄₈O₁₈₄]³³⁻ template and incorporated more paramagnetic 3d metal ions than any other polyoxotungstate at the time. The Cl atom occupies the central cavity surrounded by the 20 Cu atoms, wherein 8 of the Cu ions are coordinated distorted octahedral by oxygen, and 4 of the Cu ions are coordinated square-pyramidal by oxygen, while the remaining 8 Cu ions are coordinated square-planar by oxygen (Angew. Chem. Int. Ed. 2005, 44, 3777-3780). The properties of this POM have been also been studied (J. Am. Chem. Soc. 2006, 128, 10103-10110, Chem. Eur. J. 2009, 15, 7490-7497, Electrochem. Commun. 2005, 7, 841-847, Inorg. Chem. 2006, 45, 2866-2872 and Langmuir 2009, 25, 13000-13006) and the respective Br and I analogues have also been prepared (Inorg. Chem. 2009, 48, 11636-11645).

Kortz and co-workers also accomplished the synthesis of a Fe₁₆-species, i.e., [P₈W₄₈O₁₈₄Fe¹⁶(OH)₂₈(H₂O)₄]²⁰⁻, by using the heteropolyanion [H₇P₈W₄₈O₁₈₄]³³⁻ template in a reaction with different iron species containing Fe^{II} (in presence of O₂) or Fe^{III} ions. The compound has 16 edge- and corner-sharing FeO₆ octahedra (Chem. Eur. J. 2008, 14, 1186-1195). WO 2008/118619 A1 suggests that this Fe₁₆-species may only be a representative of a broader class of [P₈W₄₈O₁₈₄]-based POMs containing 16 transition metal atoms in its central cavity which could be illustrated by the general formula [H_{q}M₁₆X₈W₄₈O₁₈₄(HO)₃₂]^{m-} with M being selected from the group of transition metals and X being selected from As and/or P.

The related open wheel compounds [Fe₁₆O₂(OH)₂₃(H₂O)₉(P₈W₄₉O₁₈₉)Ln₄(H₂O)₂₀]¹¹⁻ (with Ln=Eu or Gd) resulted from the controlled ring opening of the [P₈W₄₈O₁₈₄]-wheel in aqueous solution at pH 4 and 80° C. in the presence of Fe^{III}, Eu^{III}/Gd^{III}, and H₂O₂ (Chem. Eur. J. 2012, 18, 6163-6166). In this context it has been found that a bending of the [P₈W₄₈O₁₈₄] macrocycle without ring-opening is possible; in [(RAs^{V}O)₄P^{V}₈W^{VI}₄₈O₁₈₄]³²⁻ (with R=C₆H₅ or p-(H₂N)C₆H₄) the four {RAs^{V}O} units are covalently bound to the two inner rims of the [P₈W₄₈O₁₈₄] wheel through As—O—W bonds, wherein the bending of the [P₈W₄₈O₁₈₄] macrocycle occurs due to the presence of short As—O bonds (Inorg. Chem. 2017, 56, 13822-13828).

[K⊂P₈W₄₈O₁₈₄(H₄W₄O₁₂)₂Ln₂(H₂O)₁₀]¹³⁻ (with Ln=La, Ce, Pr or Nd) was obtained by reaction of acidic aqueous solutions of the cyclic polytungstate anion [P₈W₄₈O₁₈₄]⁴⁰⁻ with early lanthanide cations under hydrothermal or conventional conditions, wherein the cavity of the original anion is occupied by Ln³⁺ cations and W₄O₁₂ groups; more precisely, the polytungstate shell rather consists of four subunits, i.e., two P₂W₁₂O₄₈ and two P₂W₁₆O₆₀ units giving a W₅₆-based shell. The new anions are linked by additional Ln³⁺ into a 3D network (Inorg. Chem. 2007, 46, 1737-1740). Owing to the different radii of the Ln and Mn ions in {[Ln₂(μ-OH)₄(H₂O)ₓ]₂(H₂₄P₈W₄₈O₁₈₄)}¹²⁻ (with Ln=Nd, Sm or Tb) and {[K(H₂O)]₈[Mn₈(H₂O)₁₆](H₄P₈W₄₈O₁₈₄)}¹²⁻, the four large Ln ions are disordered over eight positions and divided into two {Ln₂} units located on two sides of the cavity of the [P₈W₄₈O₁₈₄] wheel, whereas the eight small manganese ions bond to the inside of the [P₈W₄₈O₁₈₄] wheel (Eur. J. Inorg. Chem. 2013, 1693-1698).

The synthesis of a corresponding Ru derivative starting from the [H₇P₈W₄₈O₁₈₄]³³⁻ template was only accomplished by using additional organic ligands. The reaction of [Ru(p-cymene)Cl₂]₂ with [H₇P₈W₄₈O₁₈₄]³³⁻ in aqueous acidic medium results in the organometallic derivative [{K(H₂O)}₃{Ru(p-cymene)(H₂O)}₄P₈W₄₉O₁₈₆(H₂O)₂]²⁷⁻ having in addition to the four {Ru(p-cymene)(H₂O)} units, an additional WO₆ unit resulting in a P₈W₄₉-shell unit. Each Ru atom coordinates 3 O atoms in addition to the aromatic cymene unit (Dalton Trans. 2007, 2627-2630 and Eur. J. Inorg. Chem. 2010, 3195-3200).

Recently a post-transition metal-containing representative has been prepared based on the [H₇P₈W₄₈O₁₈₄]³³⁻ template. In [K_{4.5}⊂(ClSn)₈P₈W₄₈O₁₈₄]^{17.5-} all eight Sn²⁺ ions are incorporated into the inner cavity of the cyclic {P₈W₄₈O₁₈₄} unit, in particular having eight {ClSn} groups, with each Sn²⁺ ion in trigonal pyramidal geometry and the chloride ligand pointing towards the center of the cavity (Dalton Trans. 2015, 41, 19200-19206).

However, the main focus on [H₇P₈W₄₈O₁₈₄]³³⁻-based POMS clearly lies on early and/or light transition metal atoms. In this context, [Co₄(H₂O)₁₆P₈W₄₈O₁₈₄]³²⁻; [Mn₄(H₂O)₁₆P₈W₄₈O₁₈₄(WO₂(H₂O)₂)₂]²⁸⁻; [Ni₄(H₂O)₁₆P₈W₄₈O₁₈₄(WO₂(H₂O)₂)₂]²⁸⁻; and [(VO₂)₄(P₈W₄₈O₁₈₄)]³⁶⁻ have been synthesized in aqueous-acidic medium from the precursor [H₇P₈W₄₈O₁₈₄]³³⁻ using one-pot reactions. Each of the Co, Mn, and Ni ions is coordinated to 6 oxygen atoms while the V ion is coordinated to 4 oxygen atoms. The Co and V analogues have the common [P₈W₄₈O₁₈₄] wheel while the Mn and Ni analogues have framework structures containing two additional W atoms resulting in P₈W₅₀-shell units (Inorg. Chem. 2010, 49, 4949-4959). In this context, differences in electrochemical properties of [P₈W₄₈O₁₈₄Fe₁₆(OH)₂₈(H₂O)₄]²⁰⁻; [Co₄(H₂O)₁₆P₈W₄₈O₁₈₄]³²⁻; and [Ni₄(H₂O)₁₆P₈W₄₈O₁₈₄(WO₂(H₂O)₂)₂]²⁸⁻ were studied with respect to their electrocatalytic performances (Electrochimica Acta 2015, 176, 1248-1255).

The V-containing representative [K₈⊂{V^{V}₄V^{IV}₂O₁₂(H₂O)₂}₂{P₈W₄₈O₁₈₄}]²⁴⁻ contains linked vanadium oxide cavity-capping groups based on two octahedra and four tetrahedra with V^{IV} and V^{V} centers, respectively (Angew. Chem. Int. Ed. 2007, 46, 4477-4480).

LiK₁₄Na₉[P₈W₄₈O₁₈₄Cu₂₀(N₃)₆(OH)₁₈].60H₂O contains two {Cu₅(OH)₄}⁶⁺ and two {Cu₅(OH)₂(μ_{1,1,3,3}-N₃)}⁷⁺ subunits, wherein each of the five Cu^{II} ions in each subunit forms a square pyramid with two μ₃-hydroxo ligands connecting the apical Cu^{II} center to the four basal copper cations (Inorg. Chem. 2007, 46, 5292-5301).

[{Co₁₀(H₂O)₃₄(P₈W₄₈O₁₈₄)}]²⁰⁻ and [{Co₁₀(H₂O)₄₄(P₈W₄₈O₁₈₄)}]²⁰⁻ have six Co atoms in the central cavity and four external cobalt(II) ions linking adjacent polyanions resulting in 1D chains and 3D networks, respectively (Cryst. Eng. Commun. 2009, 11, 36-39).

In Na₈Li₈Co₅[Co_{5.5}(H₂O)₁₉P₈W_{48.5}O₁₈₄].60 H₂O, K₂Na₄Li₁₁Co₅[Co₇(H₂O)₂₈P₈W₄₈O₁₈₄]Cl.59 H₂O, and K₂Na₄LiCo₁₁[Co₈(H₂O)₃₂P₈W₄₈O₁₈₄](CH₃COO)₄Cl.47 H₂O the cyclic cavity of the polyanion accommodates 5.5, 7, and 8 cobalt ions, respectively, with external cobalt-containing units linking adjacent [P₈W₄₈O₁₈₄] wheel units resulting in 2D networks and 3D networks (Chem-Asian J. 2014, 9, 470-478).

In [Mn₈(H₂O)₄₈P₈W₄₈O₁₈₄]²⁴⁻ the 8 manganese atoms are linking the outer edges of adjacent [P₈W₄₈O₁₈₄] wheel units, whereas the cavity is free of heavy metal atoms and, in addition to solvent water molecules, contains only the alkali-metal K and Li cations, which may be replaced by copper ions upon addition of copper nitrate (Nat. Chem. 2010, 2, 308-312). In the related derivatives [Mn₁₄(H₂O)₃₀P₈W₄₈O₁₈₄]¹²⁻ and [Mn₁₄(H₂O)₂₆P₈W₄₈O₁₈₄]¹²⁻, 12 manganese atoms are located on the outer edges linking adjacent [P₈W₄₈O₁₈₄] wheel units whereas 2 manganese atoms are located within the wheel unit (Inorg. Chem. 2011, 50, 136-143).

In [Mn₈(H₂O)₂₆(P₈W₄₈O₁₈₄)]²⁴⁻ and [Mn₆(H₂O)₂₂(P₈W₄₈O₁₈₄){WO₂(H₂O)₂}_{1.5}]²⁵⁻ four and six Mn^{II} centers are located inside the [P₈W₄₈O₁₈₄] cavity, respectively, while two other Mn^{II} centers are coordinated to the outer rim (J. Mol. Struct. 2011, 994, 104-108).

[{P₈W₄₈O₁₈₄}{Mo^{VI}O₂}₄{(H₂O)(O═)Mo^{V}(μ₂-O)₂(O═)Mo^{V}(μ₂-H₂O)(μ₂-O)₂Mo^{V}(═O)(μ₂-O)₂Mo^{V}(═O)(H₂O)}₂]³²⁻ has two neutral tetranuclear {Mo^{V}₄O₁₀(H₂O)₃} aggregates acting as handles and four {Mo^{VI}O₂}²⁺ units connected to the [P₈W₄₈O₁₈₄] ring via Mo—O—W bonds, wherein the {Mo^{V}₄O₁₀(H₂O)₃} unit contains two diamagnetic {Mo^{V}₂O₄}²⁺-type units (Chem. Commun. 2009, 7491-7493). The related derivatives [K₄{Mo₄O₄S₄(H₂O)₃(OH)₂}₂(WO₂)(P₈W₄₈O₁₈₄)]³⁰⁻ and [{Mo₄O₄S₄(H₂O)₃(OH)₂}₂(P₈W₄₈O₁₈₄)]³⁶⁻ have two disordered {Mo₄O₄S₄(H₂O)₃(OH)₂}²⁺ “handles” connected on both sides of the [P₈W₄₈O₁₈₄] ring with internal alkali cations (Inorg. Chem. 2012, 51, 2349-2358).

Also outside the above [P₈W₄₈O₁₈₄]-based class of POMs, there have been increasing efforts towards the modification of POMs with various organic and/or transition metal complex moieties, in general, with the aim of generating new catalyst systems as well as functional materials with interesting optical, electronic, magnetic and medicinal properties. In particular, transition metal-substituted POMs (TMSPs) have attracted continuously growing attention as they can be rationally modified on the molecular level including size, shape, charge density, acidity, redox states, stability, solubility etc.

For example, U.S. Pat. No. 4,864,041 demonstrates the general potential of POMs as catalysts for the oxidation of organic compounds. A variety of different POMs with different metal species was investigated, including those with W, Mo, V, Cu, Mn, Fe, Fe and Co.

WO 2010/021600 A1 discloses a method for preparing POMs and reducing them. Thus, for example metallic nanoparticles can be prepared.

As is already evident from the above discussion on the [P₈W₄₈O₁₈₄]-based class of POMs, to date many 3d transition metal-containing POMs are known, but still only a minority of POMs contains 4d and 5d metals. However, the introduction of 4d and 5d metals, especially of late 4d and 5d metals, in a POM would be of fundamental interest en route to new, more efficient and more selective catalysts. Especially Rh, Ir, Pd, Pt, Ag and/or Au-containing POMs would be of high interest, because they are expected to be thermally and oxidatively stable and to possess highly attractive catalytic properties.

Two reviews on POMs containing late transition metals and noble metals (Coord. Chem. Rev. 2011, 255, 1642-1685 and Angew. Chem. Int. Ed. 2012, 51, 9492-9510) reveal that, although there is a noticeable development in this area in recent years, the number and variety, in particular of Rh, Ir, Pd, Pt, Ag and/or Au-containing POMs, is still limited. This is not surprising as Rh, Ir, Pd, Pt, Ag and/or Au suffer from an intrinsic lack of reactivity when it comes to the formation of POMs as these late transition metals are far less reactive, in particular in the formation of bonds to oxygen, as compared to early transition metals. This is in accordance with the Pearson acid-base concept as Rh, Ir, Pd, Pt, Ag and/or Au form soft Lewis acids whereas oxygen forms a strong Lewis base. This intrinsic lack of reactivity of Rh, Ir, Pd, Pt, Ag and/or Au in the preparation of POMs is also evident from the above discussion on the [P₈W₄₈O₁₈₄]-based class of POMs; although this class of POMS has been studied extensively, none of the [H₇P₈W₄₈O₁₈₄]³³⁻ template-based POMs contains any of Rh, Ir, Pd, Pt, Ag and/or Au.

However, for other POM subclasses, in recent years, first Rh, Ir, Pd, Pt, Ag and/or Au-containing POMs have been prepared. For example, Kortz and coworkers have found [Pd₇V₆O₂₄(OH)₂]⁶⁻ containing compounds being stable in the solid state and after redissolution when exposed to air and light (Angew. Chem. Int. Ed. 2010, 49, 7807-7811).

In other POMs it was possible to incorporate minor proportions of noble metal atoms, based on the overall metal content of the POM framework. For example, Cronin and coworkers found three Pd-containing POMs K₂₈[H₁₂Pd₁₀Se₁₀W₅₂O₂₀₆], K₂₆[H₁₄Pd₁₀Se₁₀W₅₂O₂₀₆] and Na₄₀[Pd₆Te₁₉W₄₂O₁₉₀] demonstrating the structural complexity of some of the late transition metal-containing POMs (Inorg. Chem. Front. 2014, 1, 178-185).

WO 2007/142729 A1 discloses a class of Pd and W as well as Pt and W-based POMs and mixtures thereof with the general formula [M_{y}(H₂O)(p.y)X₂W₂₂O₇₄(OH)₂]^{m-} with M being Pd, Pt, and mixtures thereof, y being 1 to 4, p being the number of water molecules bound to one M and being 3 to 5 and X being Sb, Bi, As, Se and Te. Protocols for the preparation of these POMs were provided. Furthermore, the POMs were found to be useful as catalysts.

WO 2008/089065 A1 discloses a class of W-based POMs including late transition metals with the formula [M_{y}(H₂O)ₚX_{z}Z₂W₁₈O₆₆]^{m-} with M being Cu, Zn, Pd and Pt, X being selected from the group of halides and Z being Sb, Bi, As, Se and Te. The POMs prepared are useful as catalysts.

WO 2007/142727 A1 discloses a class of transition metal-based POMs including W having the formula [M₄(H₂O)₁₀(XW₉O₃₃)₂]^{m-} with M being a transition metal and X being selected from As, Sb, Bi, Se and Te. These POMs are particularly useful as catalysts featuring high levels of conversion in selective alkane oxidation.

US 2005/0112055 A1 discloses a POM including three different transition metals Ru, Zn and W with the formula Na₁₄[Ru₂Zn₂(H₂O)₂(ZnW₉O₃₄)₂]. This particular POM was found to be highly efficient as an electrocatalyst in the generation of oxygen.

WO 2007/139616 A1 discloses a class of W-based POMs including Ru with the formula [Ru₂(H₂O)₆X₂W₂₀O₇₀]^{m-} with X being selected from Sb, Bi, As, Se, and Te. Protocols for the preparation of these POMs are described. Furthermore, the POMs were found to be useful as catalysts.

WO 2009/155185 A1 discloses a class of Ru and W-based POMs provided by the general formula [Ru₂L₂(XW₁₁O₃₉)₂WO₂]^{m-} with L being a ligand and X being Si, Ge, B and mixtures thereof. The POMs are useful as catalysts and precursors for the preparation of mixed metal-oxide catalysts.

In pursuit of noble metal-rich POM frameworks having a significantly higher noble metal-content as compared to previously known noble metal atom-containing POMs, i.e., POM frameworks containing a major proportion of noble metal atoms based on the overall metal content of said POM frameworks, Kortz and coworkers prepared the star-shaped polyoxo-15-palladate(II) [Pd_{0.4}Na_{0.6}⊂Pd₁₅P₁₀O₅₀H_{6.6}]¹²⁻ (Dalton Trans. 2009, 9385-9387), the double-cuboid-shaped copper(II)-containing polyoxo-22-palladate(II) [Cu^{II}₂Pd^{II}₂₂P^{V}₁₂O₆₀(OH)₈]²⁰⁻ comprising two {CuPd₁₁} fragments (Angew. Chem. Int. Ed. 2011, 50, 2639-2642), and the polyoxo-22-palladate [Na₂Pd^{II}₂₂O₁₂(As^{V}O₄)₁₅(As^{V}O₃OH)]²⁵⁻ comprising two {NaPd₁₁} units (Dalton Trans. 2016, 45, 2394-2398).

In 2008, Kortz and coworkers reported the first representative of a new and highly promising class of noble metal-rich POMs, i.e., the molecular palladium-oxo polyanion [Pd₁₃As₈O₃₄(OH)₆]⁸⁻ (Angew. Chem. Int. Ed. 2008, 47, 9542-9546). Twelve palladium atoms surround the thirteenth, the central palladium atom, resulting in a distorted icosahedral arrangement {PdPd₁₂O₈}. Each oxygen atom of the ‘inner’ PdO₈ fragment is coordinated by the central Pd atom and by three ‘external’ palladiums being situated on a trigonal face of a cuboctahedron. In 2009, two further representatives of said class of POMs have been reported, the discrete anionic PhAsO₃H₂- and SeO₂-derived palladium(II)-oxo clusters [Pd₁₃(As^{V}Ph)₈O₃₂]⁶⁻ and [Pd₁₃Se^{IV}₈O₃₂]⁶⁻ (Inorg. Chem. 2009, 48, 7504-7506).

In US 2009/0216052 A1 closely related POM analogues are disclosed based on this common structural motif comprising [M₁₃X₈R_{q}O_{y}]^{m-} with M being selected from Pd, Pt, Au, Rh, Ir, and mixtures thereof, while X is a heteroatom such as As, Sb, Bi, P, Si, Ge, B, Al, Ga, S, Se, Te, and mixtures thereof. These POMs in general were demonstrated to be promising candidates for the further development of useful catalysts and precursors for mixed metal-oxide catalysts and metal clusters (also referred to as metal-clusters).

Kortz and coworkers also developed a related subclass of POMs displaying a similar structural arrangement but a slightly different elemental composition. In the [MPd₁₂P₈O₄₀H_{z}]^{m-} polyanions the ‘inner’ MO₈ motif is also surrounded by twelve square-planar PdO₄ units and M is represented by Mn^{II}, Fe^{III}, Co^{II}, Cu^{II} and Zn^{II} (Chem. Eur. J. 2012, 18, 6167-6171).

In this context, Kortz and coworkers found that in the [MO₈Pd₁₂L₈]ⁿ⁻ polyanions the 8-fold coordinated guest metal ions M, which are incorporated in the cuboidal {Pd₁₂O₈L₈} shell, can be selected from Sc^{III}, Mn^{II}, Fe^{III}, Co^{II}, Ni^{II}, Cu^{II}, Zn^{II} and Lu^{III}, while L is represented by PhAsO₃²⁻, PhPO₃²⁻ or SeO₃²⁻ (Inorg. Chem. 2012, 51, 13214-13228).

Furthermore, Kortz and coworkers prepared a series of yttrium- and lanthanide-based heteropolyoxopalladate analogues containing [X^{III}Pd^{II}₁₂O₃₂(AsPh)₈]⁵⁻ cuboid units with X being selected from Y, Pr, Nd, Sm, Eu, Gd, Tb, Dy, Ho, Er, Tm, Yb, and Lu (Chem. Eur. J. 2010, 16, 9076-9085).

In 2014, Kortz and coworkers published the first fully inorganic discrete gold-palladium-oxo polyanion [NaAu₄Pd₈O₈(AsO₄)₈]¹¹⁻ without the stabilization of any organic ligands and with both Au and Pd occupying the atom positions of the metal framework. With regard to the structure, the cubic ‘NaO₈’ moiety is surrounded by 12 noble metal centers, i.e., 4 Au and 8 Pd atoms, forming the classical cuboctahedron, which is capped by eight tetrahedral arsenate groups (Chem. Eur. J. 2014, 20, 8556-8560).

In this context, it has been demonstrated that it is also possible to replace the P, As or Se-based capping groups in a respective {LaPd₁₂}-motif by the naturally occurring amino acid cysteine and thus a dodecanuclear palladium(II)-thio cluster [LaPd₁₂(C₃H₅NO₂S)₃(C₃H₆NO₂S)₂₁] is obtained (Inorg. Chem. 2016, 55, 7811-7813).

Even by replacing only two of the eight As-based capping groups in a {SrPd₁₂}-POM with acetate groups, an unusual low-symmetry open-shell structure [SrPd₁₂O₆(OH)₃(PhAsO₃)₆(OAc)₃]⁴⁻ is obtained, wherein two of the eight ‘inner’ O²⁻ ions are substituted by three OH⁻ ions and thus the central Sr atom is nine-coordinated giving an ‘inner’ SrO₆(OH)₃ motif. Furthermore, [SrPd₁₂O₆(OH)₃(PhAsO₃)₆(OAc)₃]⁴⁻ was found to be rather labile at least partially decomposing under aqueous conditions (Angew. Chem. Int. Ed. 2014, 53, 11974-11978).

Very recently, Kortz and coworkers described two new classes of noble metal-rich POMs (Aₙ)^{m+}{M′ₛ[M″M₁₂X₈O_{y}R_{z}H_{q}]}^{m-} and (Aₙ)^{m+}{M′ₛ[M″M₁₅X₁₀O_{y}R_{z}H_{q}]}^{m-} with M being Pd, Pt, Rh, Ir, Ag, and M′ being Rh, Ir, Pd, Pt, Ag, Au, Cd, Hg (WO 2017/076603 A1 and WO 2017/133898 A1).

However, despite this recent development in the preparation of noble metal-containing POMs and their highly promising catalytic activities and their exceptional potential in the development of new catalysts, representatives of the class of noble metal-containing POMs still suffer from several drawbacks. (i) Primarily due to the metal species used therein noble metal catalysts in general are expensive. Thus, it is particularly desirable to provide catalysts that may be efficiently regenerated. Most noble metal catalysts are notoriously difficult to regenerate. This is mainly due to the fact that under typical oxidative regeneration conditions, spent noble metal particles get (partially) oxidized and become mobile, e.g., when the catalyst is immobilized on a solid support, leading to very significant sintering and consequently reduced activity. Regeneration can be effected without sintering by using, e.g., oxychlorination, but this process is difficult and involves handling highly corrosive media, with the associated hazards. Furthermore, other issues linked to the known noble metal-containing POMs concern (ii) their synthesis as it may be tedious and expensive in some cases mostly due to the multiple reagents and substrates required in their preparation, (iii) their activation in order to enhance or enable their catalytic activity as it requires rather harsh conditions, i.e., significantly elevated temperatures, leading to various decomposition products and thus decreased catalyst quality, purity, concentration and performance, and (iv) their toxicity as some of the known noble metal-containing POMs comprise elements or units that are highly toxic or liberate highly toxic compounds in the process of activation in order to enhance or enable their catalytic activity or in the catalytic process itself.

Thus, there is a need for new and improved POMs containing a noble metal centers showing useful properties in homogeneous or heterogeneous catalytic applications. In this regard, particularly those POMs which solely contain one type of noble metal, i.e., which do contain solely one specific noble metal species, and those which contain more than one different type of noble metal atom species and in particular those POMs which contain a well-defined noble metal core surrounded by a noble metal-free shell unit are highly promising candidates en route to new, more efficient and more selective catalysts due to the well-established unique catalytic properties of noble metals.

Therefore, it is an object of the present invention to provide POMs containing inter alia noble metal atoms. Furthermore, it is an object of the present invention to provide one or multiple processes for the preparation of said POMs. In addition, it is an object of the present invention to provide supported POMs containing inter alia noble metal atoms as well as one or multiple processes for the preparation of said supported POMs. Another object of the present invention is the provision of metal cluster units, in particular the provision of highly dispersed metal cluster unit particles, and processes for the preparation of said metal cluster units either in the form of a dispersion in a liquid carrier medium or in supported form, immobilized on a solid support. Finally, it is an object of the present invention to provide one or multiple processes for the homogeneous or heterogeneous conversion of organic substrate using said optionally supported POM(s) and/or said optionally supported or dispersed metal cluster unit(s).

### SUMMARY OF THE INVENTION

An objective of the present invention among others is achieved by the provision of POMs represented by the formula

(Aₙ)^{m+}[(MR′ₜ)ₛO_{y}H_{q}R_{z}(X₈W₄₈₊ᵣO₁₈₄₊₄ᵣ)]^{m-}

or solvates thereof, wherein
each A independently represents a cation,
n is the number of cations,
each M is independently selected from the group consisting of Pd, Pt, Rh, Ir, Ag and Au,
each X is independently selected from the group consisting of P, As, Se and Te,
each R is independently selected from the group consisting of monovalent anions,
each R′ is independently selected from the group consisting of organometallic ligands,
s is a number from 2 to 12,
y is a number from 0 to 24,
q is a number from 0 to 24,
z is a number selected from 0 or 1,
t is a number selected from 0 or 1,
r is 0, 1 or 2, and
m is a number representing the total positive charge m+ of n cations A and the corresponding negative charge m− of the polyanion [(MR′ₜ)ₛO_{y}H_{q}R_{z}(X₈W₄₈₊ᵣO₁₈₄₊₄ᵣ)].

An objective of the present invention among others is achieved by the provision of a process for the preparation of any one of the POMs provided by the present invention, said process comprising:
(a) reacting at least one source of M and at least one source of {X₈W₄₈₊ᵣO₁₈₄₊₄ᵣ} and optionally at least one source of R and/or R′ to form a salt of the polyanion [(MR′ₜ)ₛO_{y}H_{q}R_{z}(X₈W₄₈₊ᵣO₁₈₄₊₄ᵣ)] or a solvate thereof,
(b) optionally adding at least one salt of A to the reaction mixture of step (a) to form a polyoxometalate (Aₙ)^{m+}[(MR′ₜ)ₛO_{y}H_{q}R_{z}(X₈W₄₈₊ᵣO₁₈₄₊₄ᵣ)]^{m-} or a solvate thereof, and
(c) recovering the polyoxometalate or solvate thereof.

An objective of the present invention among others is achieved by the provision of supported POMs comprising any one of the POMs provided by the present invention or prepared according to the present invention, on a solid support.

An objective of the present invention among others is achieved by the provision of a process for the preparation of the supported POMs provided by the present invention, said process comprising the step of contacting any one of the POMs provided by the present invention or prepared according to the present invention, with a solid support.

An objective of the present invention among others is achieved by the provision of metal cluster units of the formula

(A′_{n′})^{m′+}[M⁰ₛ(X₈W₄₈₊ᵣO₁₈₄₊₄ᵣ)]^{m′-},

wherein
each A′ independently represents a cation,
n′ is the number of cations,
each M⁰ is independently selected from the group consisting of Pd⁰, Pt⁰, Rh⁰, Ir⁰, Ag⁰, and Au⁰,
each X is independently selected from the group consisting of P, As, Se and Te,
s is a number from 2 to 12,
r is 0, 1 or 2, and
m′ is a number representing the total positive charge m′+ of n′ cations A′ and the corresponding negative charge m′− of the metal cluster unit anion [M⁰ₛ(X₈W₄₈₊ᵣO₁₈₄₊₄ᵣ)].

An objective of the present invention among others is achieved by the provision of the metal cluster units provided by the present invention in the form of a dispersion in a liquid carrier medium.

An objective of the present invention among others is achieved by the provision of supported metal cluster units comprising any one of the metal cluster units provided by the present invention immobilized on a solid support.

An objective of the present invention among others is achieved by the provision of a process for the preparation of any one of the metal cluster units provided by the present invention, in the form of a dispersion of said metal cluster units dispersed in a liquid carrier medium, said process comprising the steps of
(a) dissolving any one of the POMs provided by the present invention or prepared according to the present invention in a liquid carrier medium,
(b) optionally providing additive means to prevent agglomeration of the metal cluster units to be prepared, and
(c) subjecting the dissolved POM to chemical or electrochemical reducing conditions sufficient to at least partially reduce said POM into corresponding metal cluster units.

An objective of the present invention among others is achieved by the provision of a process for the preparation of supported metal cluster units, i.e., any one of the metal cluster units provided by the present invention, in the form of metal cluster units immobilized on a solid support, said process comprising the steps of
(a) contacting the dispersion of metal cluster units provided by the present invention or prepared according to the present invention, with a solid support, thereby immobilizing at least part of the dispersed metal cluster units onto the support and obtaining supported metal cluster units; and
(b) optionally isolating the supported metal cluster units.

An objective of the present invention among others is achieved by the provision of a process for the preparation of supported metal cluster units, i.e., any one of the metal cluster units provided by the present invention, in the form of metal cluster units immobilized on a solid support, said process comprising the steps on
(a) subjecting any one of the supported POM provided by the present invention or prepared according to the present invention to chemical or electrochemical reducing conditions sufficient to at least partially reduce said POM into corresponding metal cluster units provided by the present invention; and
(b) optionally isolating the supported metal cluster units.

An objective of the present invention among others is achieved by the provision of a process for the homogeneous or heterogeneous conversion of organic substrate.

In the context of the present invention the term noble metal comprises the following elements: Rh, Ir, Pd, Pt, Ag, and Au.

With regard to the present invention the expressions Group 1, Group 2, Group 3 etc. refer to the Periodic Table of the Elements and the expressions 3d, 4d and 5d metals refer to transition metals of respective Periods 4, 5 and 6 of the Periodic Table of the Elements, i.e., the 4d metal in Group 10 is Pd.

With regard to the present invention the term {X₈W₄₈₊ᵣO₁₈₄₊₄ᵣ} unit describes the structural arrangement of the X₈W₄₈₊ᵣO₁₈₄₊₄ᵣ atoms in (Aₙ)^{m+}[(MR′ₜ)ₛO_{y}H_{q}R_{z}(X₈W₄₈₊ᵣO₁₈₄₊₄ᵣ)]^{m-}.

With regard to the present invention the term {X₈W₄₈₊ᵣO₁₈₄₊₄ᵣ}′ unit describes the structural arrangement of the X₈W₄₈₊ᵣO₁₈₄₊₄ᵣ atoms in (A′_{n′})^{m′+}[m⁰ₛ(X₈W₄₈₊ᵣO₁₈₄₊₄ᵣ)]^{m′-}.

With regard to the present invention the term central cavity describes the space not occupied but surrounded by the X₈W₄₈₊ᵣO₁₈₄₊₄ᵣ atoms in the {X₈W₄₈₊ᵣO₁₈₄₊₄ᵣ} unit or in the {X₈W₄₈₊ᵣO₁₈₄₊₄ᵣ}′ unit.

With regard to the present invention the term guest atoms describes the centrally located Mₛ atoms within the central cavity of the {X₈W₄₈₊ᵣO₁₈₄₊₄ᵣ} unit in (Aₙ)^{m+}[(MR′ₜ)ₛO_{y}H_{q}R_{z}(X₈W₄₈₊ᵣO₁₈₄₊₄ᵣ)]^{m-} or the centrally located M⁰ₛ atoms within the central cavity the {X₈W₄₈₊ᵣO₁₈₄₊₄ᵣ}′ unit in (A′_{n′})^{m′+}[M⁰ₛ(X₈W₄₈₊ᵣO₁₈₄₊₄ᵣ)]^{m′-}.

With regard to the present invention the term polyanion describes the negatively charged structural arrangement [(MR′ₜ)ₛO_{y}H_{q}R_{z}(X₈W₄₈₊ᵣO₁₈₄₊₄ᵣ)].

With regard to the present invention the term X₂W₁₂-based species is any precursor unit capable of forming the {X₈W₄₈₊ᵣO₁₈₄₊₄ᵣ} unit or the {X₈W₄₈₊ᵣO₁₈₄₊₄ᵣ}′ unit, which precursor unit contains 2 X atom and 12 W atoms.

With regard to the present invention the term X₄W₂₄-based species is any precursor unit capable of forming the {X₈W₄₈₊ᵣO₁₈₄₊₄ᵣ} unit or the {X₈W₄₈₊ᵣO₁₈₄₊₄ᵣ}′ unit, which precursor unit contains 4 X atom and 24 W atoms.

With regard to the present invention the term X₈W₄₈-based species is any precursor unit capable of forming the {X₈W₄₈₊ᵣO₁₈₄₊₄ᵣ} unit or the {X₈W₄₈₊ᵣO₁₈₄₊₄ᵣ}′ unit, which precursor unit contains 8 X atom and 48 W atoms.

With regard to the present invention the term metal cluster unit describes the structural arrangement (A′_{n′})^{m′+}[M⁰ₛ(X₈W₄₈₊ᵣO₁₈₄₊₄ᵣ)]^{m′-}.

With regard to the present invention the term metal cluster describes the structural arrangement of the centrally located M⁰ₛ atoms within the {X₈W₄₈₊ᵣO₁₈₄₊₄ᵣ}′ unit within the metal cluster unit (A′_{n′})^{m′+}[M⁰ₛ(X₈W₄₈₊ᵣO₁₈₄₊₄ᵣ)]^{m′-}.

With regard to the present invention the term metal cluster unit anion describes the negatively charged structural arrangement [M⁰ₛ(X₈W₄₈₊ᵣO₁₈₄₊₄ᵣ)].

With regard to the present invention the term immobilizing means to render immobile or to fix the position. In the context of a solid support the term immobilizing describes the adhesion to a surface by means of adsorption, including physisorption and chemisorption. Adsorption is based on interactions between the material to be adsorbed and the surface of the solid support such as van-der-Waals interactions, hydrogen-bonding interactions, ionic interactions, etc.

With regard to the present invention the expression primary particles of POM or POMs primary particles describes isolated particles that contain exactly one negatively charged polyanion [(MR′ₜ)ₛO_{y}H_{q}R_{z}(X₈W₄₈₊ᵣO₁₈₄₊₄ᵣ)]. The POMs primary particles of the present invention are substantially mono-dispersed particles, i.e. the POMs primary particles have a uniform size, corresponding to the size of one polyanion. The expression POMs secondary particles describes agglomerates of POMs primary particles.

With regard to the present invention the term supported POMs describes POMs immobilized on a solid support.

With regard to the present invention the expression primary particles of metal cluster unit or metal cluster unit primary particles describes isolated particles that contain exactly one metal cluster unit (A′_{n′})^{m′+}[M⁰ₛ(X₈W₄₈₊ᵣO₁₈₄₊₄ᵣ)]^{m′-}. The metal cluster unit primary particles of the present invention are substantially mono-dispersed particles, i.e. the metal cluster unit primary particles have a substantially uniform size, corresponding to the size of one metal cluster unit. The expression metal cluster unit secondary particles describes agglomerates of metal cluster unit primary particles.

With regard to the present invention the expression primary particles of metal cluster or metal cluster unit primary particles describes isolated particles that contain exactly one metal cluster M⁰ₛ. The metal cluster primary particles of the present invention are substantially mono-dispersed particles, i.e. the metal cluster primary particles have a substantially uniform size, corresponding to the size of one metal cluster. The expression metal cluster secondary particles describes agglomerates of metal cluster primary particles.

The particle size of the non-aggregated and aggregated POMs, of the non-aggregated and aggregated metal cluster units, and of the non-aggregated and aggregated metal clusters, respectively, can be determined by various physical methods known in the art. If the particles are dispersed in a liquid medium, the particle size can be determined by light scattering. If the particles are supported on a solid support, solid state techniques are required for determining the particle size of the supported particles, and to distinguish between primary particles (non-aggregated) and secondary particles (aggregated). Suitable solid state techniques include scanning electron microscopy (SEM), transmission electron microscopy (TEM), powder X-ray diffraction or crystallography (powder XRD), etc. Another suitable technique for determining the particle size is pulsed chemi-/physisorption.

With regard to the present invention the term supported metal cluster unit describes metal cluster units immobilized on a solid support.

With regard to the present invention the term supported metal cluster describes metal clusters immobilized on a solid support.

With regard to the present invention the term organometallic bond describes a chemical bond containing at least one bond between a carbon atom of an organic molecule and a metal. With regard to the present invention the term organometallic compound describes a compound comprising at least one bond between a carbon atom of an organic molecule and a metal. With regard to the present invention the term organometallic ligand describes an organic molecule capable of forming an organometallic bond/compound with a metal.

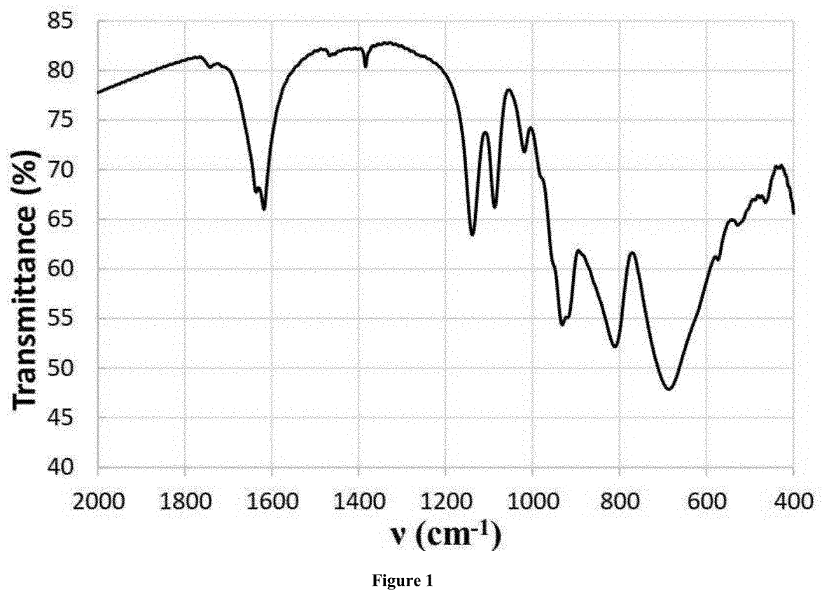

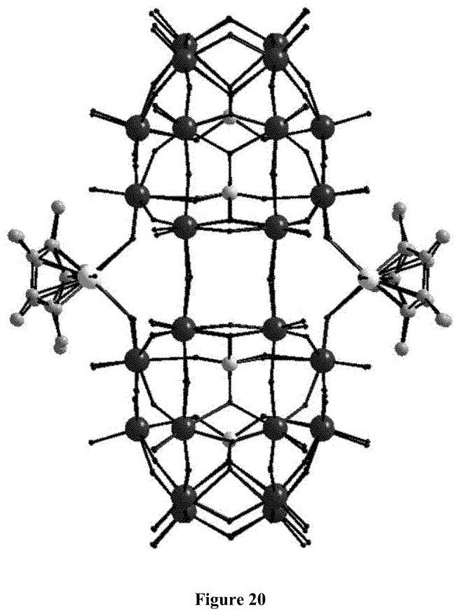

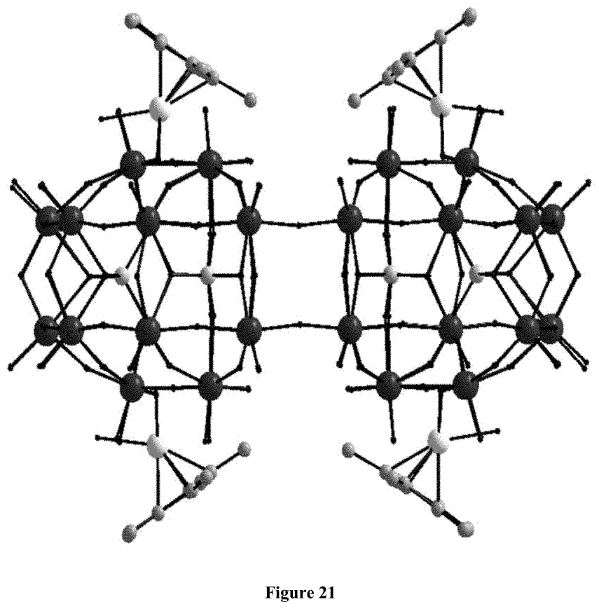

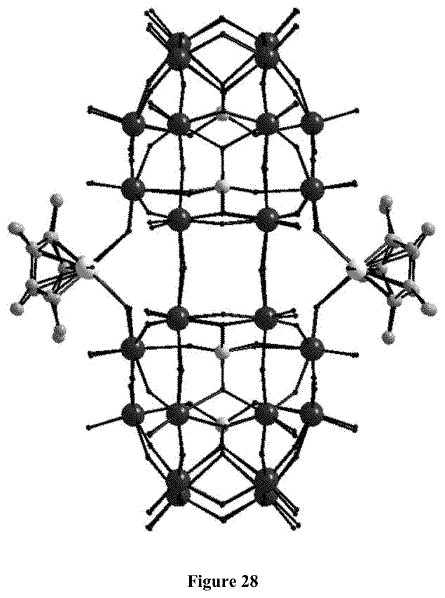

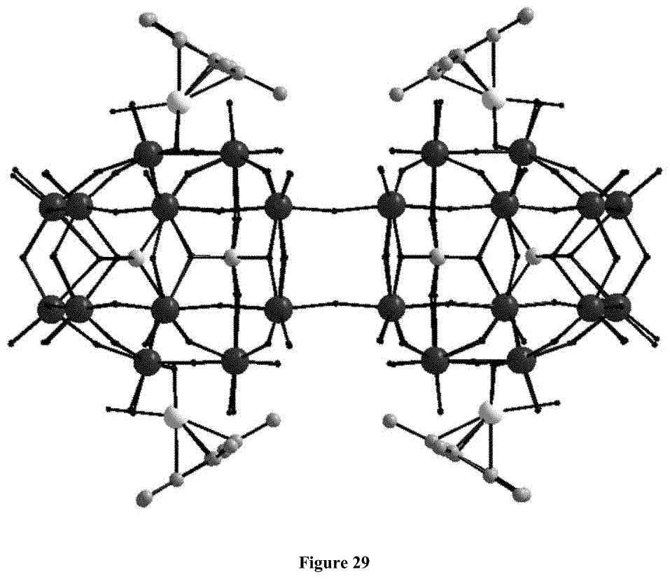

### BRIEF DESCRIPTION OF THE FIGS. 1-31

FIG. 1: Fourier Transform Infrared (FT-IR) spectrum of K₂₀Li₈[Rh₄P₈W₄₈O₁₈₄].86H₂O (“K₂₀Li₈—Rh₄P₈W₄₈”) from 2000 cm⁻¹ to 400 cm⁻¹.

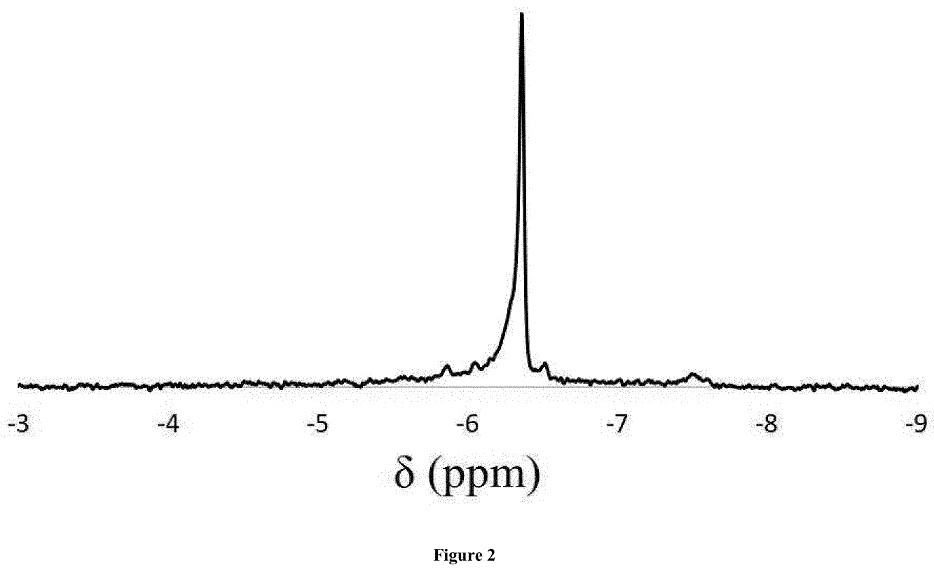

FIG. 2: ³¹P NMR of K₂₀Li₈[Rh₄P₈W₄₈O₁₈₄].86H₂O (“K₂₀Li₈—Rh₄P₈W₄₈”) recorded in D₂O at 20° C.

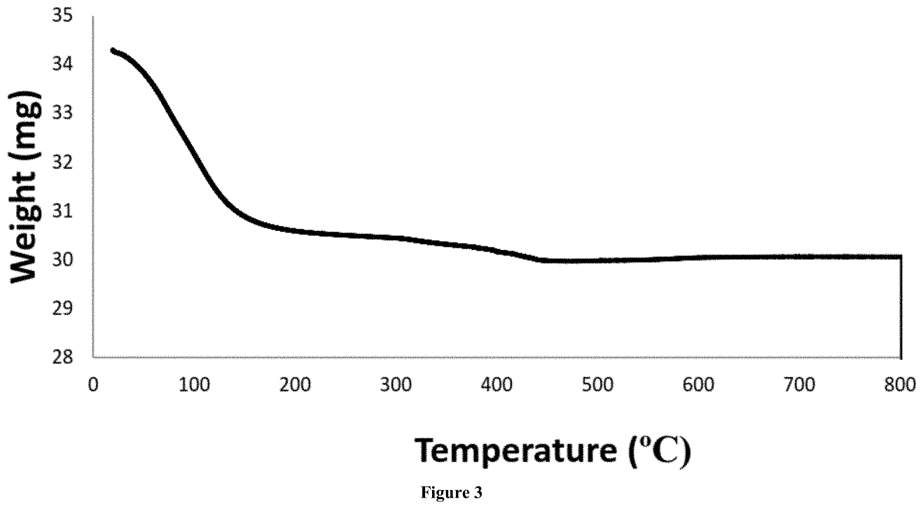

FIG. 3: Thermogravimetric analysis (TGA) curve of K₂₀Li₈[Rh₄P₈W₄₈O₁₈₄].86H₂O (“K₂₀Li₈—Rh₄P₈W₄₈”) from 20° C. to 800° C.

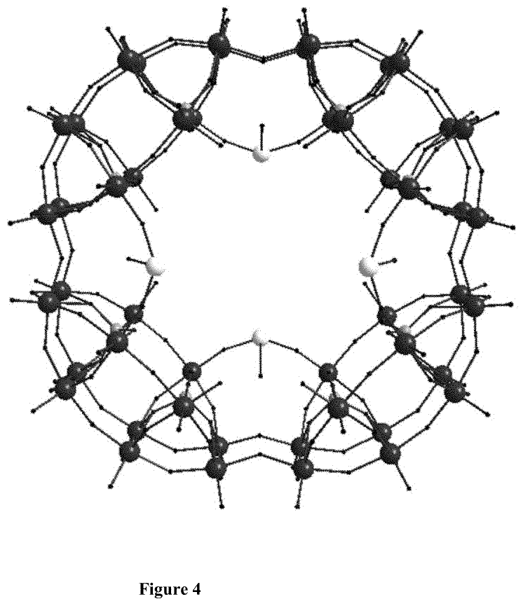

FIG. 4: Ball-and-stick representation of the {Rh₄[P₈W₄₈O₁₈₄]}²⁸⁻ polyanion (“Rh₄P₈W₄₈”). Legend: Rh, White spheres; W, dark Gray spheres; P, light Gray spheres; O, small Black dots.

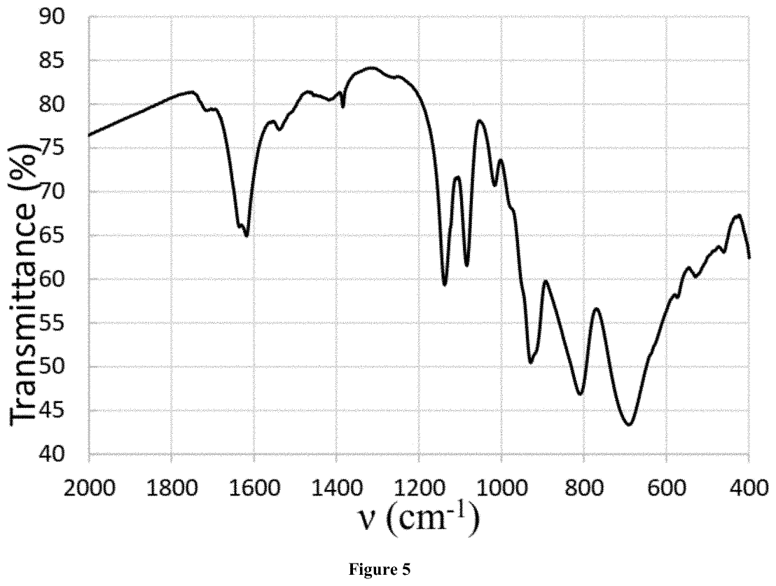

FIG. 5: Fourier Transform Infrared (FT-IR) spectrum of K₂₀Li₅H₇[Pd₄P₈W₄₈O₁₈₄].81H₂O (“K₂₀Li₅H₇—Pd₄P₈W₄₈”) from 2000 cm⁻¹ to 400 cm⁻¹.

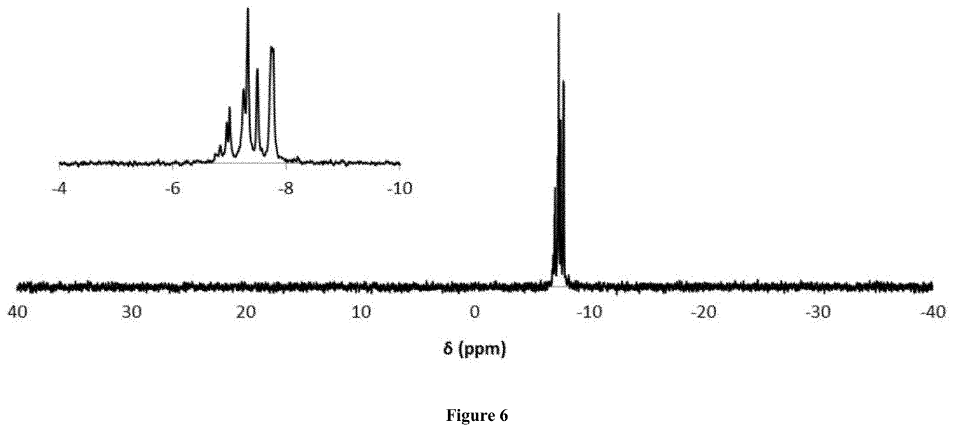

FIG. 6: ³¹P NMR of K₂₀Li₅H₇[Pd₄P₈W₄₈O₁₈₄].81H₂O (“K₂₀Li₅H₇—Pd₄P₈W₄₈”) recorded in D₂O at 20° C.

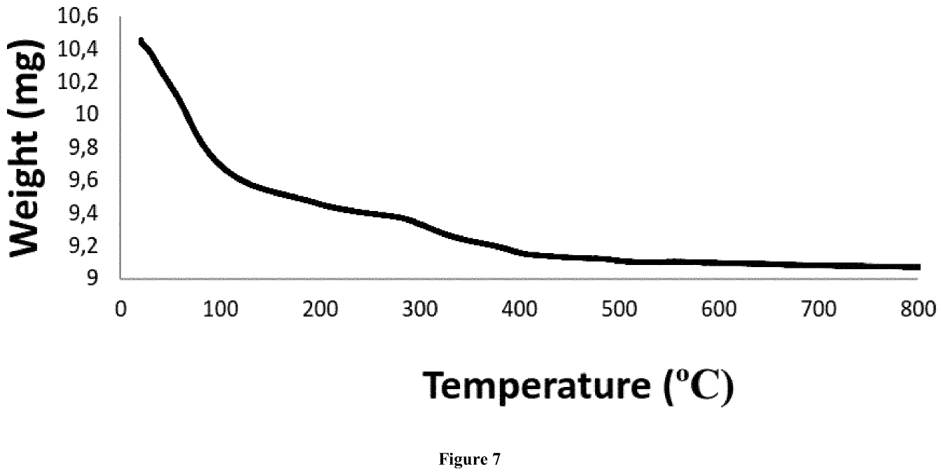

FIG. 7: Thermogravimetric analysis (TGA) curve of K₂₀Li₅H₇[Pd₄P₈W₄₈O₁₈₄].81H₂O (“K₂₀Li₅H₇—Pd₄P₈W₄₈”) from 20° C. to 800° C.

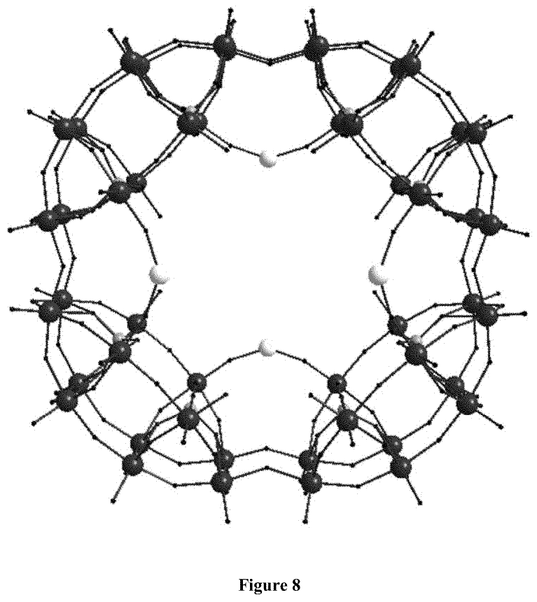

FIG. 8: Ball-and-stick representation of the {Pd₄[P₈W₄₈O₁₈₄]}³²⁻ polyanion (“Pd₄P₈W₄₈”). Legend: Pd, White spheres; W, dark Gray spheres; P, light Gray spheres; O, small Black dots.

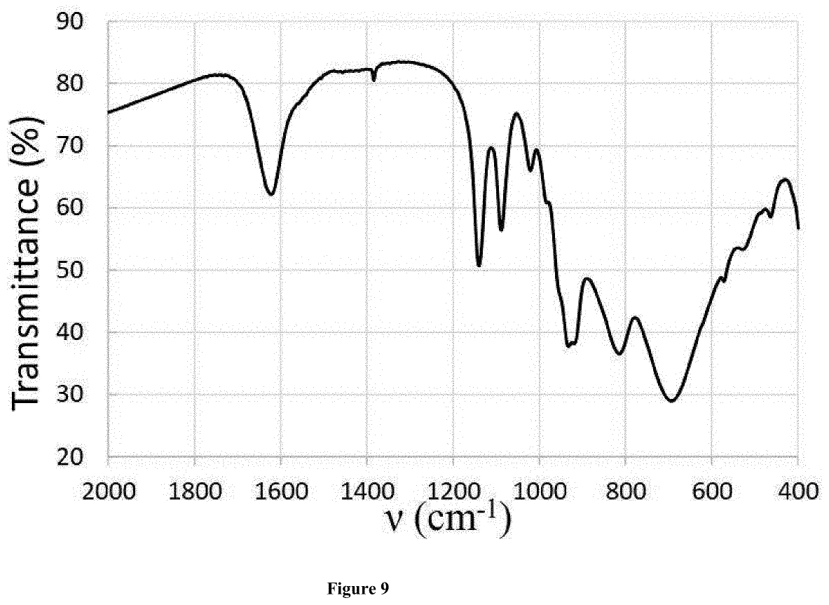

FIG. 9: Fourier Transform Infrared (FT-IR) spectrum of K₂₂Li₁₀H₂[Ir₂P₈W₄₈O₁₈₄].129H₂O (“K₂₂Li₁₀H₂—Ir₂P₈W₄₈”) from 2000 cm⁻¹ to 400 cm⁻¹.

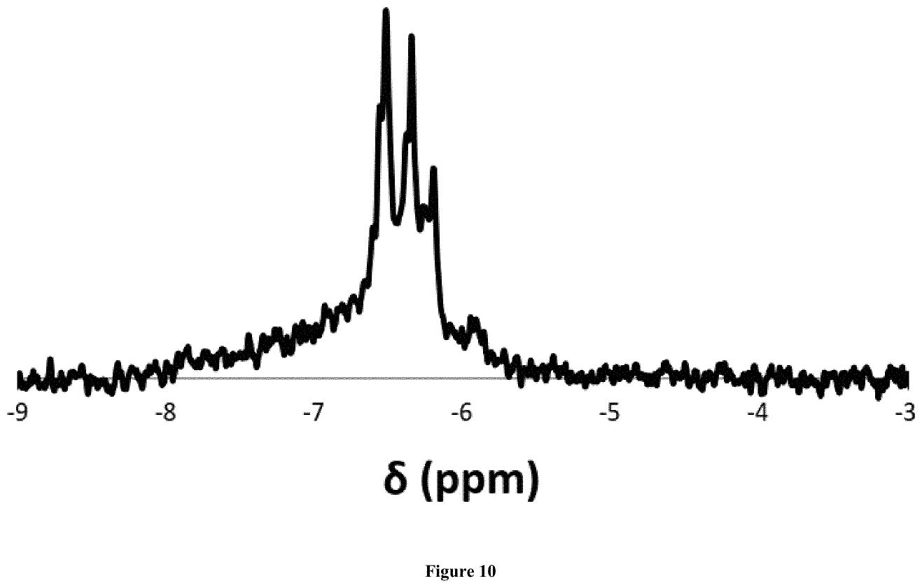

FIG. 10: ³¹P NMR of K₂₂Li₁₀H₂[Ir₂P₈W₄₈O₁₈₄].129H₂O (“K₂₂Li₁₀H₂—Ir₂P₈W₄₈”) recorded in D₂O at 20° C.

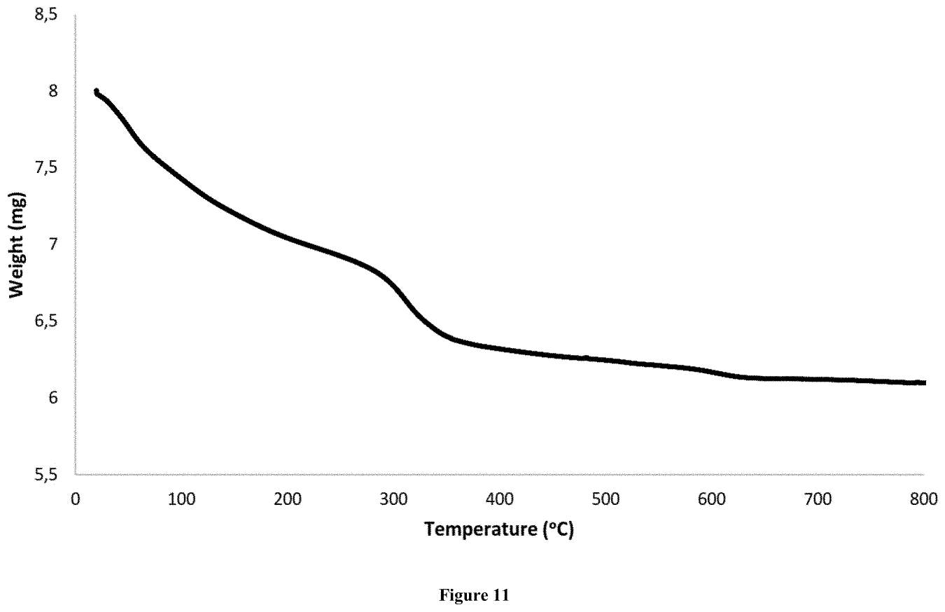

FIG. 11: Thermogravimetric analysis (TGA) curve of K₂₂Li₁₀H₂[Ir₂P₈W₄₈O₁₈₄].129H₂O (“K₂₂Li₁₀H₂—Ir₂P₈W₄₈”) from 20° C. to 800° C.

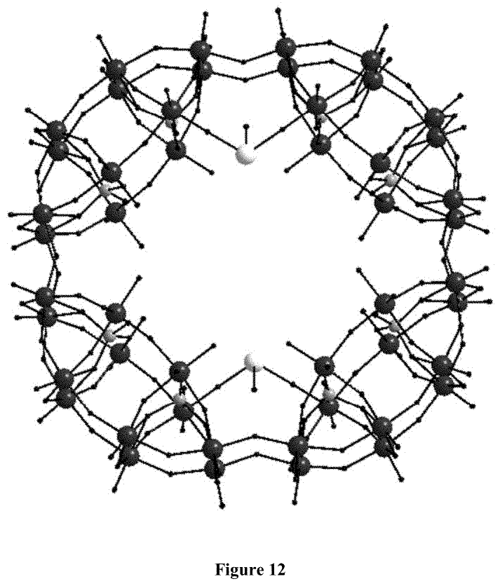

FIG. 12: Ball-and-stick representation of the {Ir₂[P₈W₄₈O₁₈₄]}³⁴⁻ polyanion (“Ir₂P₈W₄₈”). Legend: Ir, White spheres; W, dark Gray spheres; P, light Gray spheres; O, small Black dots.

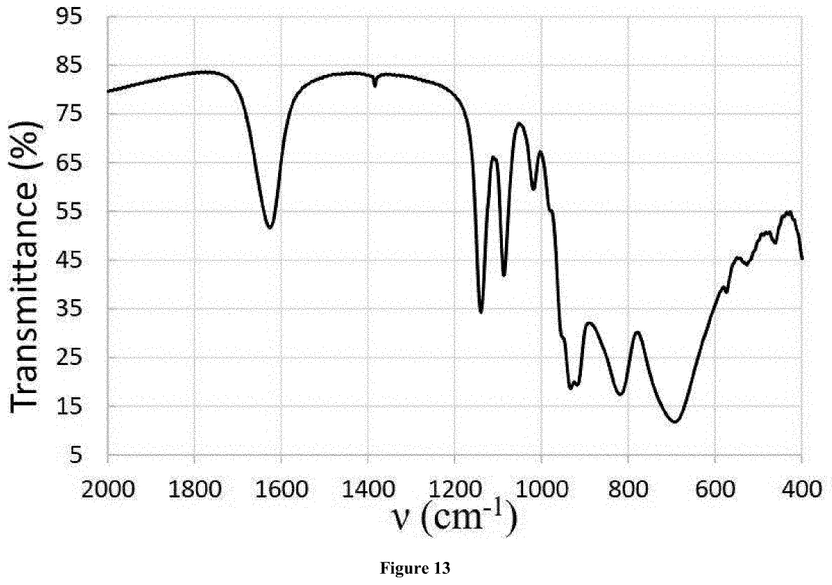

FIG. 13: Fourier Transform Infrared (FT-IR) spectrum of K₂₉Li₂H₅[Pt₂P₈W₄₈O₁₈₄].91H₂O (“K₂₉Li₂H₅—Pt₂P₈W₄₈”) from 2000 cm⁻¹ to 400 cm⁻¹.

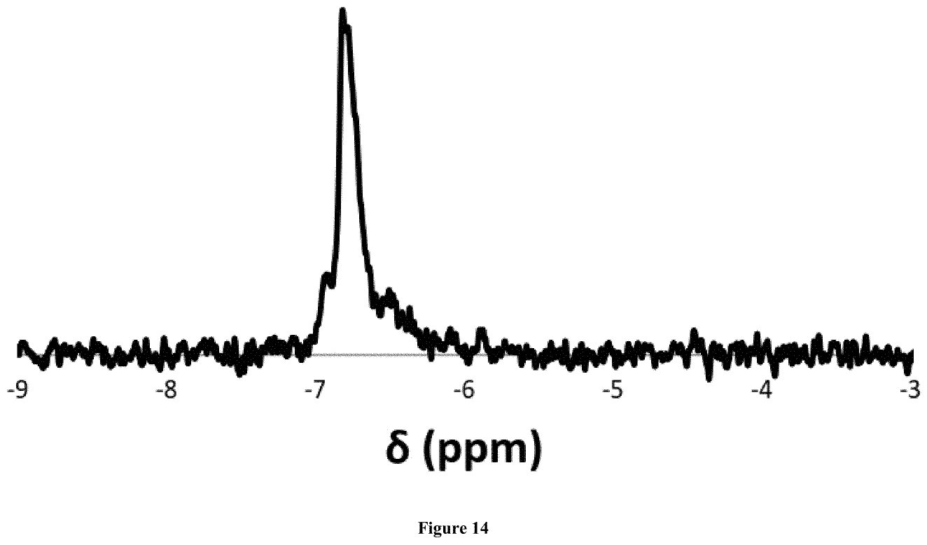

FIG. 14: ³¹P NMR of K₂₉Li₂H₅[Pt₂P₈W₄₈O₁₈₄].91H₂O (“K₂₉Li₂H₅—Pt₂P₈W₄₈”) recorded in D₂O at 20° C.

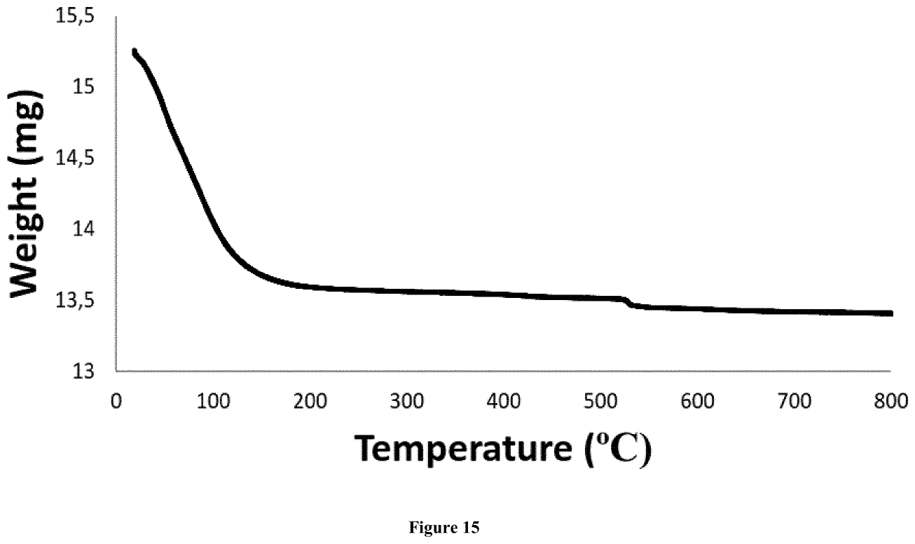

FIG. 15: Thermogravimetric analysis (TGA) curve of K₂₉Li₂H₅[Pt₂P₈W₄₈O₁₈₄].91H₂O (“K₂₉Li₂H₅—Pt₂P₈W₄₈”) from 20° C. to 800° C.

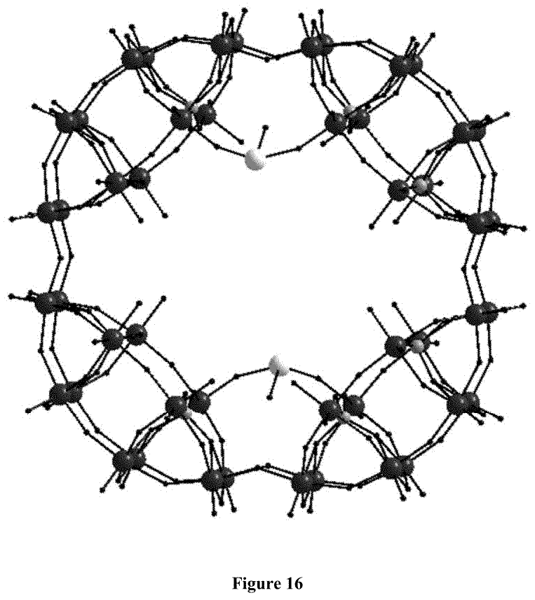

FIG. 16: Ball-and-stick representation of the {Pt₂[P₈W₄₈O₁₈₄]}³⁶⁻ polyanion (“Pt₂P₈W₄₈”). Legend: Pt, White spheres; W, dark Gray spheres; P, light Gray spheres; O, small Black dots.

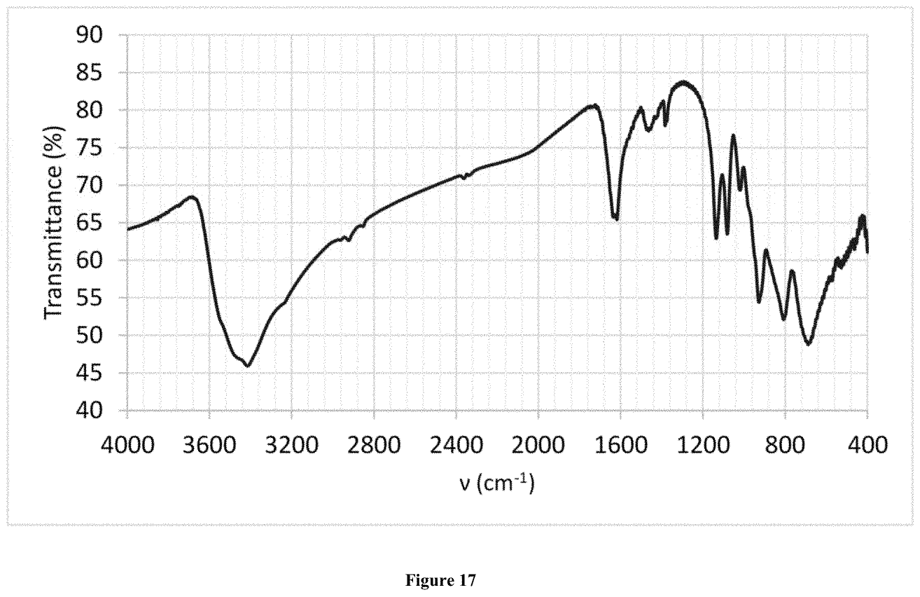

FIG. 17: Fourier Transform Infrared (FT-IR) spectrum of K₁₆Li₁₀H₆[(Rh-Cp*)₄P₈W₄₈(H₂O)₄O₁₈₄].79H₂O (“K₁₆Li₁₀H₆—(RhCp*)₄P₈W₄₈”) from 4000 cm⁻¹ to 400 cm⁻¹.

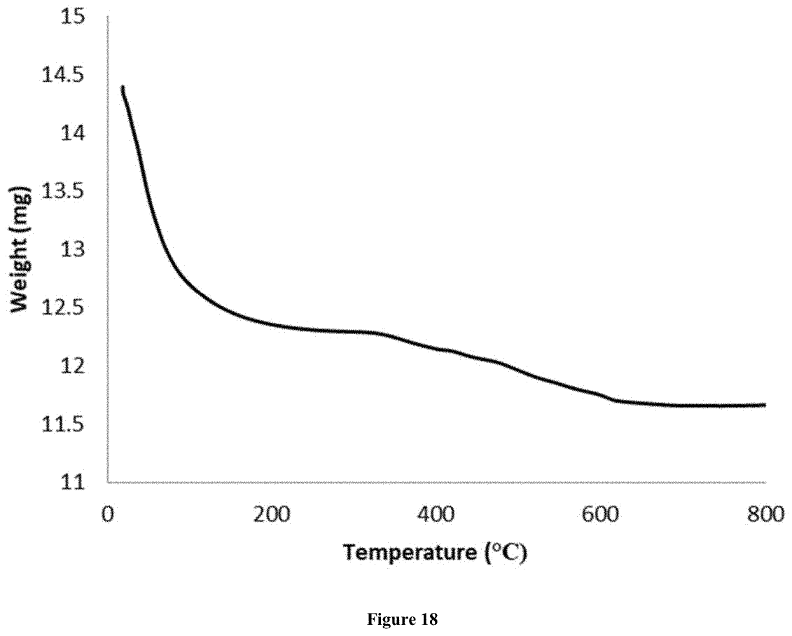

FIG. 18: Thermogravimetric analysis (TGA) curve of K₁₆Li₁₀H₆[(Rh-Cp*)₄P₈W₄₈(H₂O)₄O₁₈₄].79H₂O (“K₁₆Li₁₀H₆—(RhCp*)₄P₈W₄₈”) from 20° C. to 800° C.

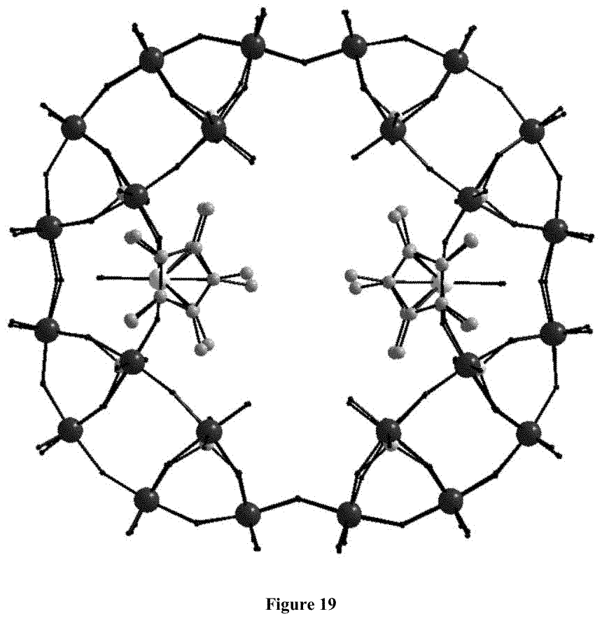

FIGS. 19, 20 and 21: Combined polyhedral and ball-and-stick representations (top view, side view and bottom view) of the {(Rh-Cp*)₄[P₈W₄₈O₁₈₄]}³²⁻ polyanion (“(RhCp*)₄P₈W₄₈”). Legend: Rh, White spheres; W, dark Gray spheres; P, light Gray spheres; O, small Black dots; C, medium Gray spheres.

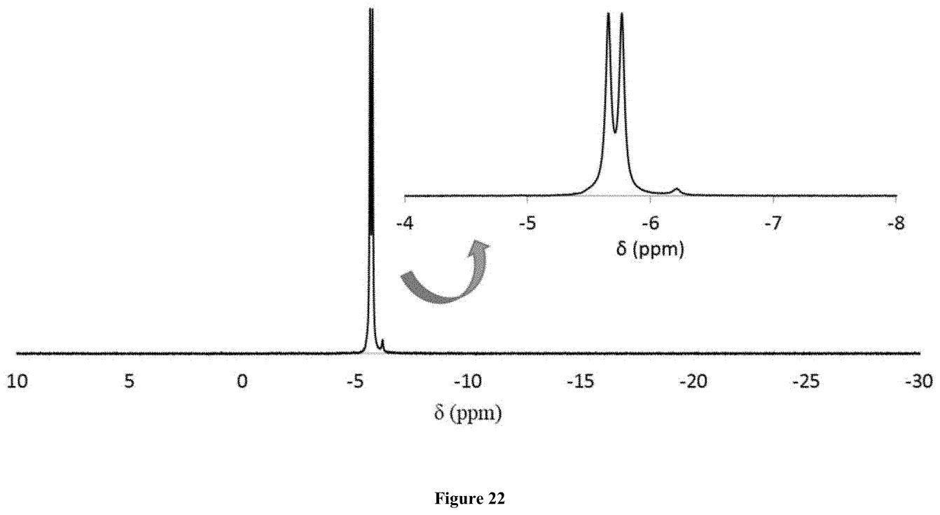

FIG. 22: ³¹P NMR of K₁₆Li₁₀H₆[(Rh-Cp*)₄P₈W₄₈(H₂O)₄O₁₈₄].79H₂O (“K₁₆Li₁₀H₆—(RhCp*)₄P₈W₄₈”) recorded in D₂O at 20° C.

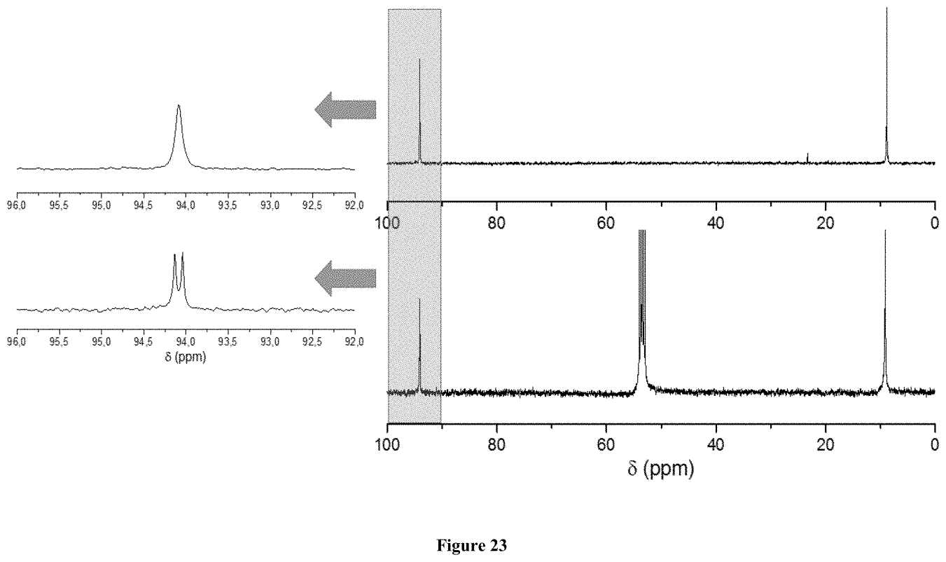

FIG. 23: ¹³C NMR of K₁₆Li₁₀H₆[(Rh-Cp*)₄P₈W₄₈(H₂O)₄O₁₈₄].79H₂O (“K₁₆Li₁₀H₆—(RhCp*)₄P₈W₄₈”) recorded in D₂O at 20° C.

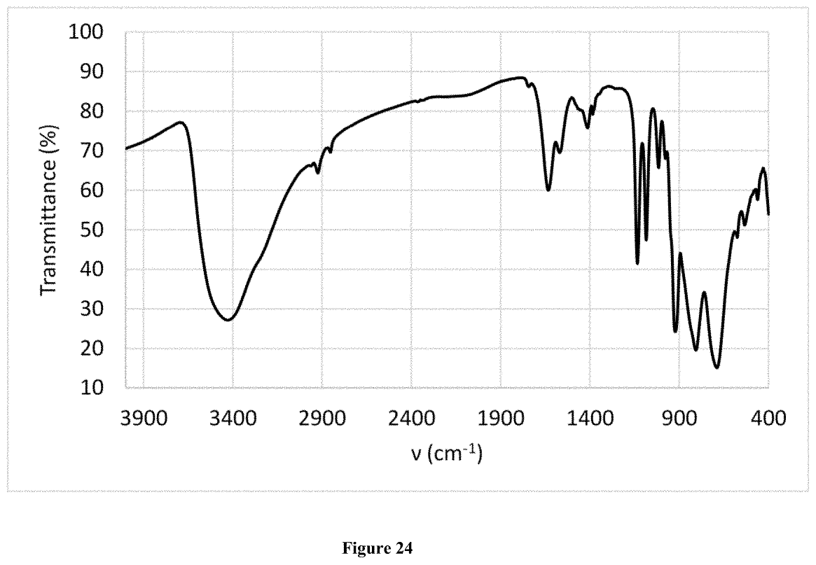

FIG. 24: Fourier Transform Infrared (FT-IR) spectrum of Kₙ₁Liₙ₂Hₙ₃[(Rh-Cp*)₄P₈W₄₉(H₂O)₄O₁₈₈].wH₂O (“A₃₀-(RhCp*)₄P₈W₄₉”) from 3900 cm⁻¹ to 400 cm⁻¹.

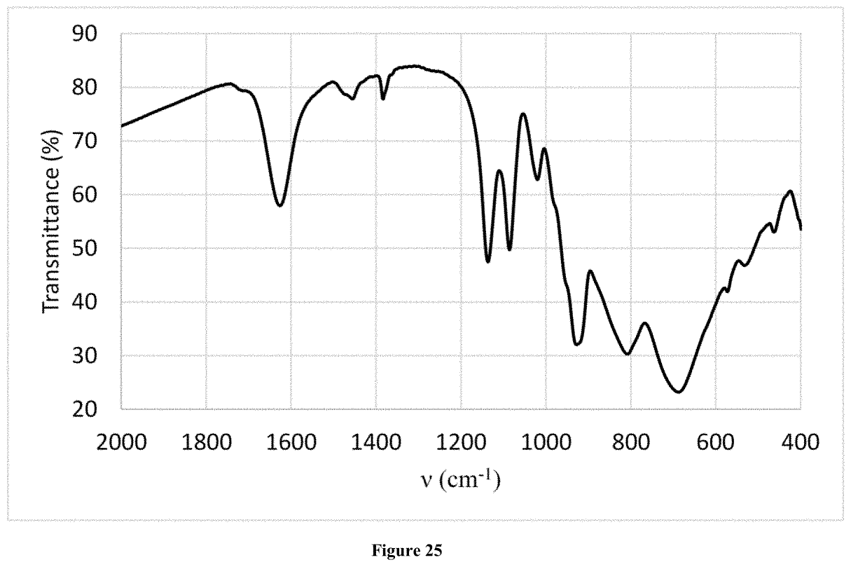

FIG. 25: Fourier Transform Infrared (FT-IR) spectrum of K₁₆Li₁₀H₆[(Ir-Cp*)₄P₈W₄₈(H₂O)₄O₁₈₄].101H₂O (“K₁₆Li₁₀H₆—(IrCp*)₄P₈W₄₈”) from 2000 cm⁻¹ to 400 cm⁻¹.

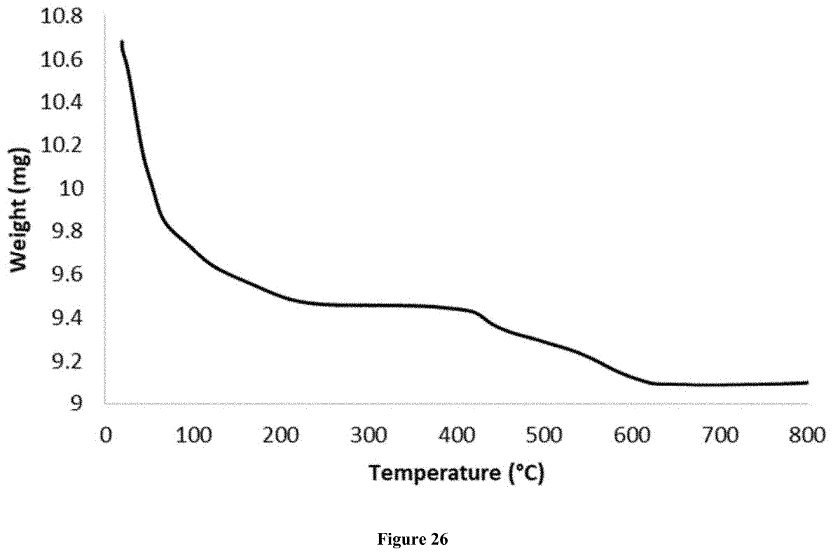

FIG. 26: Thermogravimetric analysis (TGA) curve of K₁₆Li₁₀H₆[(Ir-Cp*)₄P₈W₄₈(H₂O)₄O₁₈₄].101H₂O (“K₁₆Li₁₀H₆—(IrCp*)₄P₈W₄₈”) from 20° C. to 800° C.

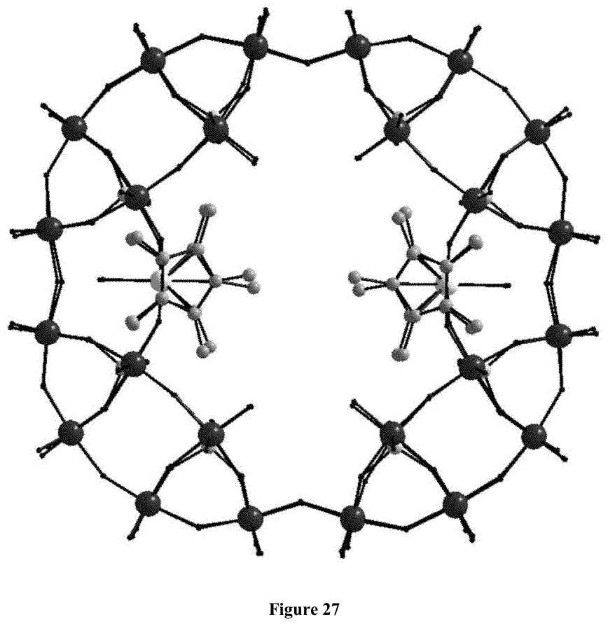

FIGS. 27, 28 and 29: Combined polyhedral and ball-and-stick representations of the {(Ir-Cp*)₄[P₈W₄₈O₁₈₄]}³²⁻ polyanion (“(IrCp*)₄P₈W₄₈”). Legend: Ir, White spheres; W, dark Gray spheres; P, light Gray spheres; O, small Black dots; C, medium Gray spheres.

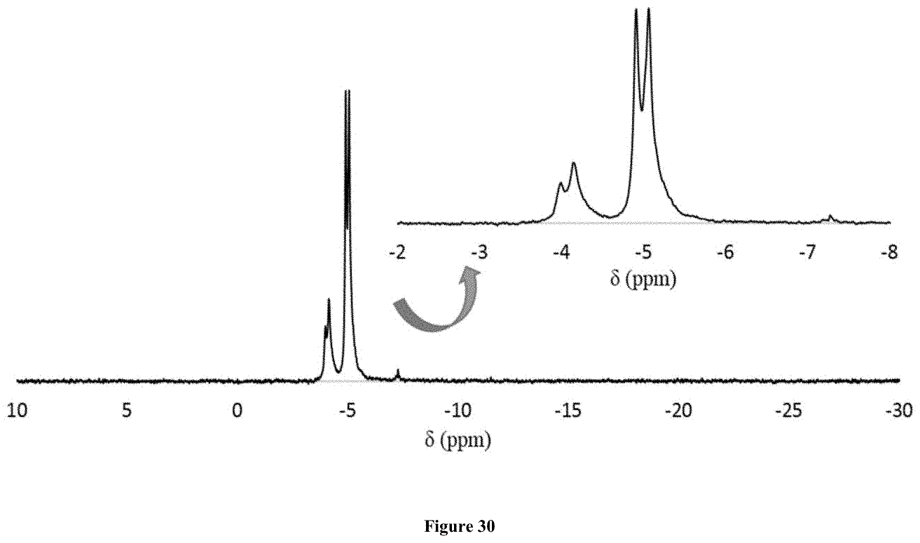

FIG. 30: ³¹P NMR of K₁₆Li₁₀H₆[(Ir-Cp*)₄P₈W₄₈(H₂O)₄O₁₈₄].101H₂O (“K₁₆Li₁₀H₆—(IrCp*)₄P₈W₄₈”) recorded in D₂O at 20° C.

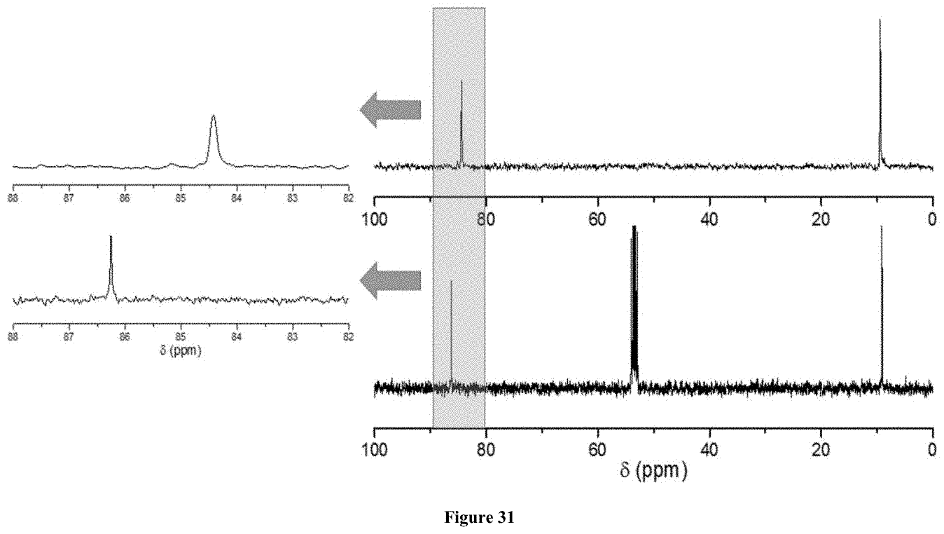

FIG. 31: ¹³C NMR of K₁₆Li₁₀H₆[(Ir-Cp*)₄P₈W₄₈(H₂O)₄O₁₈₄].101H₂O (“K₁₆Li₁₀H₆—(IrCp*)₄P₈W₄₈”) recorded in D₂O at 20° C.

### DETAILED DESCRIPTION

According to one embodiment, the POMs of the present invention are represented by the formula

(Aₙ)^{m+}[(MR′ₜ)ₛO_{y}(X₈W₄₈₊ᵣO₁₈₄₊₄ᵣ)]^{m-}

or solvates thereof, wherein
each A independently represents a cation, preferably each A is independently selected from the group consisting of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof; more preferably from the group consisting of Li, K, Na and combinations thereof,
n is the number of cations,
each M is independently selected from the group consisting of Pd, Pt, Rh, Ir, Ag and Au, preferably Pd, Pt, Rh, and Ir, more preferably Pd, Pt and Rh, most preferably Pd and Pt, in particular Pd,
each X is independently selected from the group consisting of P, As, Se and Te, preferably P and As, more preferably As^{V} and P^{V}, in particular P, preferably P^{V},
each R is independently selected from the group consisting of monovalent anions,
each R′ is independently selected from the group consisting of organometallic ligands, preferably arenes, more preferably benzene (Bz), p-cymene, cyclopentadiene (Cp), or pentamethylcyclopentadiene (Cp*), in particular cyclopentadiene (Cp) or pentamethylcyclopentadiene (Cp*), such as pentamethylcyclopentadiene (Cp*),
s is a number from 2 to 12, in particular s is 2, 4, 6, 8, 10 or 12; preferably s is 2, 4, 6, 8 or 12; more preferably s is 2, 4, 6 or 12; most preferably s is 2, 4 or 6,
y is a number from 0 to 24, in particular y is 0, 2, 4, 6, 8, 10, 12 or 24, preferably y is 0, 2, 4, 6, 8 or 12; more preferably y is 0, 2, 4, 6 or 8; more preferably wherein y is 0, 2, 4 or 8, most preferably y is 0,
t is a number selected from 0 or 1,
r is a number selected from 0, 1 or 2, preferably r is 0 or 1, more preferably r is 0, and
m is a number representing the total positive charge m+ of n cations A and the corresponding negative charge m− of the polyanion [(MR′ₜ)ₛO_{y}(X₈W₄₈₊ᵣO₁₈₄₊₄ᵣ)].

According to a second embodiment, the POMs of the present invention are represented by the formula

(Aₙ)^{m+}[(MR′ₜ)ₛO_{y}R_{z}(X₈W₄₈₊ᵣO₁₈₄₊₄ᵣ)]^{m-}

or solvates thereof, wherein
the A, n, m, M, R′, X, s, y, t and r are the same as defined above,
each R is independently selected from the group consisting of monovalent anions, preferably each R is independently selected from the group consisting of F, Cl, Br, I, CN, N₃, CP, bifluoride (FHF), SH, SCN, NCS, SeCN, CNO, NCO and OCN, more preferably F, Cl, Br, I, CN, and N₃, more preferably Cl, Br, I and N₃, most preferably Cl, Br and I, in particular R is Cl, and
z is a number selected from 0 or 1, in particular z is 1, in particular z is 0.

According to a third embodiment, the POMs of the present invention are represented by the formula

(Aₙ)^{m+}[(MR′ₜ)ₛO_{y}H_{q}R_{z}(X₈W₄₈₊ᵣO₁₈₄₊₄ᵣ)]^{m-}

or solvates thereof, wherein
A, n, m, M, R′, X, R, s, y, t, r and z are the same as defined above, and
q is a number from 0 to 24, preferably q is 0 to 18, more preferably q is 0 to 12; more preferably q is 0 to 10; most preferably q is 0 to 8, in particular q is 0, 1, 2, 3, 4, 5, 6, 7, 8, 9, 10, 11, 12 or 24, more particularly q is 0, 1, 2, 3, 4, 5, 6, 7, 8 or 12; even more particularly q is 0, 2, 4, 5, 6, 7 or 8; for instance q is 2 or 4.

In one preferred variant of the first, second or third embodiments, X₈W₄₈₊ᵣO₁₈₄₊₄ᵣ preferably forms a {X₈W₄₈₊ᵣO₁₈₄₊₄ᵣ} unit having a central cavity, wherein the {X₈W₄₈₊ᵣO₁₈₄₊₄ᵣ} unit is a {X₈W₄₈O₁₈₄} unit for r being 0, a {X₈W₄₈₊₁O₁₈₄₊₄} unit for r being 1 and a {X₈W₄₈₊₂O₁₈₄₊₈} unit for r being 2. Preferably, the {X₈W₄₈O₁₈₄} unit is represented by the following formula 1

wherein each O is presented in small Black dots, each W is presented in dark Gray spheres and each X is presented in light Gray sphere. The {X₈W₄₈O₁₈₄} unit is a wheel-shaped unit, in particular a cyclic fragment consisting of 4 X₂W₁₂-based units, in particular 4 X₂W₁₂O₄₄ units, wherein each X₂W₁₂-based unit (X₂W₁₂O₄₄ unit) is bonded to two adjacent X₂W₁₂-based units (X₂W₁₂O₄₄ units) via 4 O atoms, wherein each of said 4 O atoms is bonded to a different W atom of each X₂W₁₂-based unit (X₂W₁₂O₄₄ unit) and wherein every two X₂W₁₂-based units (X₂W₁₂O₄₄ units) are linked to each other by 2 of said 4 O atoms, wherein in the {X₈W₄₈O₁₈₄} unit each X is linked to 6 different W via a 1 O atom bridge, respectively, and wherein each X is bonded to 4 O and each W is bonded to 6 O. In the {X₈W₄₈O184} unit, 16 W atoms are directed towards the central cavity, each of said 16 W atoms is bonded to a different O atom, wherein these 16 O atoms are directed further towards the central cavity such that the outer boundaries of the central cavity are designated by said 16 O atoms, which 16 O atoms are denoted the 16 inner O atoms in the context of the present invention. Preferably at least one of the M atoms is bonded to the 16 inner O atoms, wherein each of the 16 inner O atoms is bonded to no more than one of the M atoms; more preferably at least one of the M atoms is bonded to two of the 16 inner O atoms; more preferably at least one of the M atoms is bonded to two adjacent O atoms of the 16 inner O atoms, most preferably at least one of the M atoms is bonded to two adjacent O atoms of the 16 inner O atoms, wherein each two adjacent O atoms of the 16 inner O atoms can be assigned to a different, i.e., adjacent, X₂W₁₂-based unit (X₂W₁₂O₄₄ unit). More preferably, in case s is 8 or less than 8, all of the M atoms are bonded to the 16 inner O atoms, wherein each of the 16 inner O atoms is bonded to no more than one of the M atoms; more preferably each of the M atoms is bonded to two of the 16 inner O atoms; more preferably each of the M atoms is bonded to two adjacent O atoms of the 16 inner O atoms, most preferably each of the M atoms is bonded to two adjacent O atoms of the 16 inner O atoms, wherein each two adjacent O atoms of the 16 inner O atoms can be assigned to a different, i.e., adjacent, X₂W₁₂-based unit (X₂W₁₂O₄₄ unit). More preferably, in case s is greater than 8, 8 of the M atoms are bonded to the 16 inner O atoms, wherein each of the 16 inner O atoms is bonded to no more than one of the M atoms; more preferably each of said 8 M atoms is bonded to two of the 16 inner O atoms; more preferably each of said 8 M atoms is bonded to two adjacent O atoms of the 16 inner O atoms, most preferably each of said 8 M atoms is bonded to two adjacent O atoms of the 16 inner O atoms, wherein each two adjacent O atoms of the 16 inner O atoms can be assigned to a different, i.e., adjacent, X₂W₁₂-based unit (X₂W₁₂O₄₄ unit). In case r is 1 or 2, preferably the one or two extra tungsten atoms are in the form of WO₄, in particular WO₄²⁻ groups, preferably occupying respectively one or two of the vacant sites in the cavity of the {X₈W₄₈O₁₈₄} unit as defined above. For instance, if four positions are occupied by noble metals, these one or two extra tungsten atoms are crystallographically disordered over the remaining positions, preferably over the four remaining positions of the overall 8 preferred positions.

In a preferred embodiment, r is 0.

In a second preferred variant of the first, second or third embodiments or of the preferred variant of said embodiments, all M are the same; preferably wherein all M are the same, and are selected from Pd, Pt, Rh, and Ir, more preferably Pd, Pt and Rh, most preferably Pd and Pt, in particular Pd. In the alternative, all M are selected from mixtures of Pd and Pt.

In a third preferred variant of the first, second or third embodiments or of the first or second preferred variant of said embodiments, the {X₈^{W}₄₈₊ᵣO₁₈₄₊₄ᵣ} unit, in particular the {X₈W₄₈O₁₈₄} unit, has a central cavity and all M atoms are located in said central cavity and at least some of the M atoms are bonded to O atoms of the {X₈W₄₈₊ᵣO₁₈₄₊₄ᵣ} unit, in particular the {X₈W₄₈O₁₈₄} unit, wherein said O atoms of the {X₈W₄₈₊ᵣO₁₈₄₊₄ᵣ} unit, in particular the {X₈W₄₈O₁₈₄}, are directed towards the central cavity, more preferably said O atoms of the {X₈W₄₈₊ᵣO₁₈₄₊₄ᵣ} unit, in particular the {X₈W₄₈O₁₈₄} unit, are the 16 inner O atoms. In this variant, in case z is 1, it is further preferred that R is located in the center of the central cavity and R is coordinated to at least one of the M atoms. In this variant, in case z is 0, it is further possible that the center of the central cavity may be occupied by a hydroxide anion OH⁻ being formed by one of the y O atoms and one of the q H atoms and said hydroxide anion OH⁻ is coordinated to at least one of the M atoms.

In a preferred embodiment, the central cavity has a diameter of 6 to 16 Å, more preferably 8 to 14 Å, in particular around 12 Å.

In a preferred embodiment, in the {X₈W₄₈₊ᵣO₁₈₄₊₄ᵣ} unit all of the 184+4r O have an oxidation state of −2, all of the 48+r W have an oxidation state of +6 and all of the 8 X have an oxidation state of +5, in particular X is selected from the group consisting of P^{V} and As^{V}, preferably P^{V}. Preferably, the {X₈W₄₈O₁₈₄} unit has a negative charge of −40, the {X₈W₄₈₊₁O₁₈₄₊₄} unit has a negative charge of −42 and the {X₈W₄₈₊₂O₁₈₄₊₈} unit has a negative charge of −44.

In a preferred embodiment, the noble metal-containing POMs are based on noble metal centers M wherein each M has a d⁶, d⁸ or d¹⁰ valence electron configuration. Based on the d⁶, d⁸ or d¹⁰ valence electron configuration, the oxidation state of the respective M can be identified, so that M is Rh^{III}, Ir^{III}, Pd^{IV} or Pt^{IV}, Rh^{I}, Ir^{I}, Pd^{II}, Pt^{II}, Ag^{III} or Au^{III}, and Ag^{I} or Au^{I}, respectively. Hence the requirement for M having a d⁶, d⁸ or d¹⁰ valence electron configuration is synonymous to M being selected from the group consisting of Rh^{III}, Ir^{III}, Pd^{IV} or Pt^{IV}, Rh^{I}, Ir^{I}, Pd^{II}, Pt^{II}, Ag^{III} or Au^{II}, and Ag^{I} or Au^{I}, respectively. In a more preferred embodiment, the noble metal-containing POMs are based on square planar noble metal centers M wherein each M has a d⁶, d⁸ or d¹⁰ valence electron configuration.

In the POMs according to the present invention, in which t is 1, each R′ is independently selected from the group consisting of organometallic ligands, preferably arenes, more preferably benzene (Bz), p-cymene, cyclopentadiene (Cp), or pentamethylcyclopentadiene (Cp*), in particular cyclopentadiene (Cp) or pentamethylcyclopentadiene (Cp*), such as pentamethylcyclopentadiene (Cp*), most preferably each R′ is bonded to one or more M in the form of an organometallic bond, preferably in the form of at least one M-arene organometallic bond, more preferably in the form of at least one M-benzene (M-Bz), M-p-cymene, M-cyclopentadiene (M-Cp), or M-pentamethylcyclopentadiene (M-Cp*) organometallic bond, in particular in the form of M-cyclopentadiene (M-Cp) or M-pentamethylcyclopentadiene (M-Cp*) organometallic bond, such as in the form of M-pentamethylcyclopentadiene (M-Cp*) organometallic bond. In an especially preferred embodiment, all R′ are the same. Without wishing to be bound by any theory, the organometallic ligand R′ when being attached to the metal M increases its reactivity towards the POM. In most cases, it has been noted that for M being Rh and Ir, only complexes with Rh^{III} and Ir^{III} lead to the formation of the POMs as shown above. In case of using organometallic Rh^{I} and Ir^{I} complexes, in some cases, they tend to be oxidized under the typical reaction conditions leading to the formation of the inorganic Rh and Ir, in particular Rh₄P₈W₄₈ and Ir₂P₈W₄₈, derivatives.

In a preferred embodiment, z is 0. In case the {X₈W₄₈₊ᵣO₁₈₄₊₄ᵣ} unit, in particular in the {X₈W₄₈O₁₈₄} unit, has a central cavity, in this embodiment, the only atoms being located in the central cavity and having a negative oxidation state are one or more oxygen atom, preferably originating from the y O atoms.

In a preferred embodiment, y is 0. In another preferred embodiment, in which y is at least 1, i.e., y is a number from 1 to 24, in particular y is 2, 4, 6, 8, 10, 12 or 24, preferably y is 2, 4, 6, 8 or 12; more preferably y is 2, 4, 6 or 8; more preferably wherein y is 2, 4, or 8, most preferably y is 4 or 8, the y O atoms are located within the polyanion. In this case, the y O atoms may be bonded to the M atoms, wherein each of said O atoms may be bonded to one or more of the M atoms, in particular any of the y O atoms may be bonded to 1, 2, 3, 4, 5 or 6 different M atoms, preferably to 1, 2, 3 or 4 different M atoms, more preferably to 1, 2 or 4 different M atoms, most preferably to 4 different M atoms, in particular to 2 M atoms. Additionally or alternatively to being bonded to one or more of the M atoms, in case q is at least 1, any of the y O atoms may be bonded to any of the q H atoms with the proviso that none of the y O atoms is covalently bonded to more than one of the q H atoms.

In the POMs of the present invention, the cation A can be a Group 1, 2, 3, 4, 5, 6, 7, 8, 9, 10, 11, 12, 13, 14, 15 and 16 metal cation or an organic cation. Preferably, each A is independently selected from the group consisting of cations of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof. More preferably, A is selected from lithium, potassium, sodium cations and combinations thereof.

The number n of cations is dependent on the nature of cation(s) A, namely its/their valence, and the negative charge m of the polyanion which has to be balanced. In any case, the overall charge of all cations A is equal to the charge of the polyanion. In turn, the charge m of the polyanion is dependent on the nature and oxidation state of the metals M and W, the nature and oxidation state of the heteroatoms X, optionally the nature and oxidation state of R′ and the number of oxygen atoms y and protons q and the presence or absence of the monovalent anion R. Thus, m depends on the oxidation state of the atoms present in the polyanion, e.g., it follows from the oxidation states of O (−2), H (+1), X (preferably +5 for As^{V} or P^{V}), M (normally ranging from +1 to +4 such as +4 for Pd^{VI} or Pt^{VI}, such as +3 for Rh^{III}, Ir^{III}, Ag^{III} or Au^{III}, such as +2 for Pd^{II} or Pt^{II}, such as +1 for Rh^{I}, Ag^{I} or Au^{I}), R (normally +1), and W (normally +6). In some embodiments, m ranges from 1 to 48, preferably 8 to 40, more preferably 12 to 36, most preferably 16 to 34, in particular 16, 32, 34, 36. In particular, m is 16, 18, 20, 22, 24, 26, 28, 30, 32, 34, 36, 38. In a preferred embodiment, m is 16, 28, 32, 34, 36, 40, 42 or 44. Thus, n can generally range from 1 to 48, preferably 8 to 40, more preferably 12 to 36, most preferably 16 to 34. In particular, n ranges from 6 to 34 and more particularly is 6, 9, 10, 12, 14, 16, 18, 20, 22, 24, 26, 28, 30 or 32. In a preferred embodiment, n is 16, 28, 32, 34 or 36.

Generally, A is acting as counterion of the POM and is positioned outside of the polyanion. However, it is also possible that some of the cations A are located within the polyanion. In case the {X₈W₄₈₊ᵣO₁₈₄₊₄ᵣ} unit, in particular the {X₈W₄₈O₁₈₄} unit, has a central cavity, it is also possible that some of the cations A are located within the central cavity. Any cation A being located within the polyanion is not selected from the group of noble metals.

If one or multiple protons are present as counterion(s) in a preferred embodiment, said one or multiple protons q are generally located within the polyanion. In one alternative, said one or multiple protons are acting as counterion(s) of the POM and may be positioned outside or inside the polyanion. In another alternative, said one or multiple protons are located within the polyanion and covalently bonded to oxygen atom(s) of the polyanion with the proviso that no more than one proton is bonded per oxygen. Thus, in case the q H atoms are covalently bonded to O atoms, the q H atoms are covalently bonded to the y O atoms with the proviso that none of the y O atoms is covalently bonded to more than one of the q H atoms, or the q H atoms are covalently bonded to the O atoms of the {X₈W₄₈₊ᵣO₁₈₄₊₄ᵣ} unit with the proviso that none of the O atoms of the {X₈W₄₈₊ᵣO₁₈₄₊₄ᵣ} unit is covalently bonded to more than one of the q H atoms, or combinations thereof.

Generally, q is ranging from 0 to 24. In particular, q is 0 or 4. In a preferred embodiment q is 0, i.e. no group H is present. In another embodiment q is 0 to 22, preferably q is 0 to 18, more preferably q is 0 to 12; more preferably q is 0 to 10; most preferably q is 0 to 8, in particular q is 0, 1, 2, 3, 4, 5, 6, 7, 8, 9, 10, 11, 12 or 24, more particularly q is 0, 1, 2, 6, 4, 5, 6, 7, 8 or 12; even more particularly q is 0, 2, 4, 5, 6, 7 or 8; for example q is 2 or 4. In another embodiment q is 1, 2, 3, 4, 5, 6, 7, 8, 9, 10, 11, 12, 13, 14, 15, or 16. In a preferred embodiment of the present invention the q protons are bonded to oxygen atoms of the polyanion. In a particular embodiment each of said protons is bonded to a different oxygen atom of the polyanion. Thus, in this specific preferred embodiment the POM is best represented by the formulae

(Aₙ)^{m+}[(MR′ₜ)ₛO_{(y-q)}(OH)_{q}R_{z}(X₈W₄₈₊ᵣO₁₈₄₊₄ᵣ)]^{m-}, e.g.,

(Aₙ)^{m+}[(MR′ₜ)ₛO_{(y-q)}(OH)_{q}(X₈W₄₈₊ᵣO₁₈₄₊₄ᵣ)]^{m-}, such as

(Aₙ)^{m+}[(MR′ₜ)ₛ(OH)_{q}(X₈W₄₈₊ᵣO₁₈₄₊₄ᵣ)]^{m-}, or

(Aₙ)^{m+}[(MR′ₜ)ₛO_{y}R_{z}(X₈W₄₈₊ᵣO_{(184+4r-q)}(OH)_{q})]^{m-}, e.g.,

(Aₙ)^{m+}[(MR′ₜ)ₛO_{y}(X₈W₄₈₊ᵣO_{(184+4r-q)}(OH)_{q})]^{m-}, such as

(Aₙ)^{m+}[(MR′ₜ)ₛ(X₈W₄₈₊ᵣO_{(184+4r-q)}(OH)_{q})]^{m-},

or solvates thereof, wherein A, n, m, M, R′, X, R, t, s, y, q, z and r are the same as defined above.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0 and X is P.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, X is P and z is 0.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, X is P and s is 2 or 4.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, X is P, y is 0 and z is 0.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Pd.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Pd, z is 0, s is 4 and X is P.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Pt.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Pt, z is 0, s is 2 and X is P.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Ir.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Ir, z is 0, s is 2 and X is P.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Rh.

Thus, in a preferred embodiment, the invention relates to a POM (Aₙ)^{m+}[(MR′ₜ)ₛO_{y}H_{q}R_{z}(X₈W₄₈₊ᵣO₁₈₄₊₄ᵣ)]^{m-}, wherein r is 0, M is Rh, z is 0, s is 4 and X is P.

Suitable examples of POMs according to the invention are represented by the formulae

(Aₙ)^{m+}[(MR′ₜ)ₛO_{y}H_{q}R_{z}(X₈W₄₈₊ᵣO₁₈₄₊₄ᵣ)]^{m-}, e.g.,

(Aₙ)^{m+}[(MR′ₜ)ₛO_{y}H_{q}(X₈W₄₈O₁₈₄)]^{m-},

(Aₙ)^{m+}[(MR′ₜ)ₛH_{q}R_{z}(X₈W₄₈O₁₈₄)]^{m-},

(Aₙ)^{m+}[(MR′ₜ)ₛO_{y}R_{z}(X₈W₄₈O₁₈₄)]^{m-},

(Aₙ)^{m+}[(MR′ₜ)ₛH_{q}(X₈W₄₈O₁₈₄)]^{m-},

(Aₙ)^{m+}[(MR′ₜ)ₛ(X₈W₄₈O₁₈₄)]^{m-},

(Aₙ)^{m+}[(MR′ₜ)₂O_{y}H_{q}R_{z}(X₈W₄₈O₁₈₄)]^{m-}, such as

(Aₙ)^{m+}[(MR′ₜ)₂O_{y}H_{q}(X₈W₄₈O₁₈₄)]^{m-},

(Aₙ)^{m+}[(MR′ₜ)₂H_{q}R_{z}(X₈W₄₈O₁₈₄)]^{m-},

(Aₙ)^{m+}[(MR′ₜ)₂O_{y}R_{z}(X₈W₄₈O₁₈₄)]^{m-},

(Aₙ)^{m+}[(MR′ₜ)₂H_{q}(X₈W₄₈O₁₈₄)]^{m-},

(Aₙ)^{m+}[(MR′ₜ)₂(X₈W₄₈O₁₈₄)]^{m-},

(Aₙ)^{m+}[(MR′ₜ)₄O_{y}H_{q}R_{z}(X₈W₄₈O₁₈₄)]^{m-}, such as

(Aₙ)^{m+}[(MR′ₜ)₄O_{y}H_{q}(X₈W₄₈O₁₈₄)]^{m-},

(Aₙ)^{m+}[(MR′ₜ)₄H_{q}R_{z}(X₈W₄₈O₁₈₄)]^{m-},

(Aₙ)^{m+}[(MR′ₜ)₄O_{y}R_{z}(X₈W₄₈O₁₈₄)]^{m-},

(Aₙ)^{m+}[(MR′ₜ)₄H_{q}(X₈W₄₈O₁₈₄)]^{m-},

(Aₙ)^{m+}[(MR′ₜ)₄(X₈W₄₈O₁₈₄)]^{m-},

(Aₙ)^{m+}[M₆O_{y}H_{q}R_{z}(X₈W₄₈O₁₈₄)]^{m-}, such as

(Aₙ)^{m+}[M₆O_{y}H_{q}(X₈W₄₈O₁₈₄)]^{m-},

(Aₙ)^{m+}[M₆H_{q}R_{z}(X₈W₄₈O₁₈₄)]^{m-},

(Aₙ)^{m+}[M₆O_{y}R_{z}(X₈W₄₈O₁₈₄)]^{m-},

(Aₙ)^{m+}[M₆H_{q}(X₈W₄₈O₁₈₄)]^{m-},

(Aₙ)^{m+}[M₆(X₈W₄₈O₁₈₄)]^{m-},

(Aₙ)^{m+}[(MR′ₜ)ₛO_{y}H_{q}(P₈W₄₈O₁₈₄)]^{m-}, such as

(Aₙ)^{m+}[(PdCp*)ₛO_{y}H_{q}(P₈W₄₈O₁₈₄)]^{m-}, like

(Aₙ)^{m+}[(PdCp*)₂O_{y}H_{q}(P₈W₄₈O₁₈₄)]^{m-},

(Aₙ)^{m+}[(PdCp*)₄O_{y}H_{q}(P₈W₄₈O₁₈₄)]^{m-},

(Aₙ)^{m+}[(PdCp*)₆O_{y}H_{q}(P₈W₄₈O₁₈₄)]^{m-},

(Aₙ)^{m+}[PtₛO_{y}H_{q}(P₈W₄₈O₁₈₄)]ₘ₋, like

(Aₙ)^{m+}[Pt₂O_{y}H_{q}(P₈W₄₈O₁₈₄)]^{m-},

(Aₙ)^{m+}[Pt₄O_{y}H_{q}(P₈W₄₈O₁₈₄)]^{m-},

(Aₙ)^{m+}[Pt₆O_{y}H_{q}(P₈W₄₈O₁₈₄)]^{m-},

(Aₙ)^{m+}[IrₛO_{y}H_{q}(P₈W₄₈O₁₈₄)]^{m-}, like

(Aₙ)^{m+}[Ir₂O_{y}H_{q}(P₈W₄₈O₁₈₄)]^{m-},

(Aₙ)^{m+}[Ir₄O_{y}H_{q}(P₈W₄₈O₁₈₄)]^{m-},

(Aₙ)^{m+}[Ir₆O_{y}H_{q}(P₈W₄₈O₁₈₄)]^{m-},

(Aₙ)^{m+}[(RhCp*)ₛO_{y}H_{q}(P₈W₄₈O₁₈₄)]^{m-}, like

(Aₙ)^{m+}[(RhCp*)₂O_{y}H_{q}(P₈W₄₈O₁₈₄)]^{m-},

(Aₙ)^{m+}[(RhCp*)₄O_{y}H_{q}(P₈W₄₈O₁₈₄)]^{m-},

(Aₙ)^{m+}[(RhCp*)₆O_{y}H_{q}(P₈W₄₈O₁₈₄)]^{m-},

(Aₙ)²⁸⁺[MₛO_{y}H_{q}R_{z}(X₈W₄₈₊ᵣO₁₈₄₊₄ᵣ)]²⁸⁻, such as

(A₂₈)²⁸⁺[MₛR_{z}(X₈W₄₈₊ᵣO₁₈₄₊₄ᵣ)]²⁸⁻,

(A₁₄)²⁸⁺[MₛR_{z}(X₈W₄₈₊ᵣO₁₈₄₊₄ᵣ)]²⁸⁻,

(Aₙ)²⁸⁺[MₛO_{y}H_{q}R_{z}(X₈W₄₈₊ᵣO₁₈₄₊₄ᵣ)]²⁸⁻,

(Aₙ)²⁸⁺[M₄O_{y}H_{q}R_{z}(X₈W₄₈₊ᵣO₁₈₄₊₄ᵣ)]²⁸⁻,

(Aₙ)³⁰⁺[MₛO_{y}H_{q}R_{z}(X₈W₄₈O₁₈₄)]³⁰⁻, such as

(A₃₀)³⁰⁺[MₛR_{z}(X₈W₄₈O₁₈₄)]³⁰⁻,

(A₁₅)³⁰⁺[MₛR_{z}(X₈W₄₈O₁₈₄)]³⁰⁻,

(Aₙ)³⁰⁺[MₛO_{y}H_{q}R_{z}(P₈W₄₈O₁₈₄)]³⁰⁻,

(Aₙ)³⁰⁺[MₛO_{y}H_{q}R_{z}(X₈W₄₈O₁₈₄)]³⁰⁻,

(Aₙ)³²⁺[MₛO_{y}H_{q}R_{z}(X₈W₄₈₊ᵣO₁₈₄₊₄ᵣ)]³²⁻, such as

(A₃₂)³²⁺[MₛR_{z}(X₈W₄₈₊ᵣO₁₈₄₊₄ᵣ)]³²⁻,

(A₁₆)³²⁺[MₛR_{z}(X₈W₄₈₊ᵣO₁₈₄₊₄ᵣ)]³²⁻,

(Aₙ)³²⁺[MₛO_{y}H_{q}R_{z}(X₈W₄₈₊ᵣO₁₈₄₊₄ᵣ)]³²⁻,

(Aₙ)³²⁺[M₄O_{y}H_{q}R_{z}(X₈W₄₈₊ᵣO₁₈₄₊₄ᵣ)]³²⁻,

(Aₙ)³²⁺[M₂O_{y}H_{q}R_{z}(X₈W₄₈₊ᵣO₁₈₄₊₄ᵣ)]³²⁻,

(Aₙ)³⁴⁺[MₛO_{y}H_{q}R_{z}(X₈W₄₈O₁₈₄)]³⁴⁻, such as

(A₃₄)³⁴⁺[MₛR_{z}(X₈W₄₈O₁₈₄)]³⁴⁻,

(A₁₇)³⁴⁺[MₛR_{z}(X₈W₄₈O₁₈₄)]³⁴⁻,

(Aₙ)³⁴⁺[MₛO_{y}H_{q}R_{z}(P₈W₄₈O₁₈₄)]³⁴⁻,

(Aₙ)³⁴⁺[M₂O_{y}H_{q}R_{z}(X₈W₄₈O₁₈₄)]³⁴⁻,

(Aₙ)³⁶⁺[MₛO_{y}H_{q}R_{z}(X₈W₄₈O₁₈₄)]³⁶⁻, such as

(A₃₆)³⁶⁺[MₛR_{z}(X₈W₄₈O₁₈₄)]³⁶⁻,

(A₁₈)³⁶⁺[MₛR_{z}(X₈W₄₈O₁₈₄)]³⁶⁻,

(Aₙ)³⁶⁺[MₛO_{y}H_{q}R_{z}(P₈W₄₈O₁₈₄)]³⁶⁻,

(Aₙ)³⁶⁺[M₂O_{y}H_{q}R_{z}(X₈W₄₈O₁₈₄)]³⁶⁻.

The invention also includes solvates of the present POMs. A solvate is an association of solvent molecules with a POM. Preferably, water is associated with the POMs and thus, the POMs according to the invention can in particular be represented by the formulae

(Aₙ)^{m+}[(MR′ₜ)ₛO_{y}H_{q}R_{z}(X₈W₄₈₊ᵣO₁₈₄₊₄ᵣ)]^{m-}.wH₂O, e.g.

(Aₙ)^{m+}[(MR′ₜ)ₛO_{y}H_{q}(X₈W₄₈₊ᵣO₁₈₄₊₄ᵣ)]^{m-}.wH₂O,

(Aₙ)^{m+}[(MR′ₜ)ₛH_{q}R_{z}(X₈W₄₈₊ᵣO₁₈₄₊₄ᵣ)]^{m-}.wH₂O,

(Aₙ)^{m+}[(MR′ₜ)ₛO_{(y-q)}(OH)_{q}R_{z}(X₈W₄₈₊ᵣO₁₈₄₊₄ᵣ)]^{m-}.wH₂O, and

(Aₙ)^{m+}[(MR′ₜ)ₛO_{y}R_{z}(X₈W₄₈₊ᵣO_{(184+4r-q)}(OH)_{q})]^{m-}.wH₂O,

wherein
A, n, m, M, X, R, R′, s, y, r, t and z are the same as defined above, and
w represents the number of attracted water molecules per polyanion [MₛO_{y}H_{q}R_{z}(X₈W₄₈₊ᵣO₁₈₄₊₄ᵣ)] and mostly depends on the type of cations A. In some embodiments w is an integer that ranges from 1 to 180, preferably from 20 to 160, more preferably from 50 to 150, most preferably from 80 to 140.

The w H₂O molecules are positioned outside of the polyanion. However, it is also possible that some of the w H₂O molecules are located within the polyanion. In case the {X₈W₄₈₊ᵣO₁₈₄₊₄ᵣ} unit has a central cavity, it is also possible that some of the w H₂O molecules are located within the central cavity.

Suitable examples of the POM solvates according to the invention are represented by the formulae

(Aₙ)^{m+}[(MR′ₜ)ₛO_{y}H_{q}R_{z}(X₈W₄₈₊ᵣO₁₈₄₊₄ᵣ)]^{m-}.wH₂O, e.g.,

(Aₙ)^{m+}[(MR′ₜ)ₛO_{y}H_{q}(X₈W₄₈O₁₈₄)]^{m-}.wH₂O,

(Aₙ)^{m+}[(MR′ₜ)ₛH_{q}R_{z}(X₈W₄₈O₁₈₄)]^{m-}.wH₂O,

(Aₙ)^{m+}[(MR′ₜ)ₛO_{y}R_{z}(X₈W₄₈O₁₈₄)]^{m-}.wH₂O,

(Aₙ)^{m+}[(MR′ₜ)ₛH_{q}(X₈W₄₈ O₁₈₄)]^{m-}.wH₂O,

(Aₙ)^{m+}[(MR′ₜ)ₛ(X₈W₄₈O₁₈₄)]^{m-}.wH₂O,

(Aₙ)^{m+}[(MR′ₜ)₂O_{y}H_{q}R_{z}(X₈W₄₈O₁₈₄)]^{m-}.wH₂O, such as

(Aₙ)^{m+}[(MR′ₜ)₂O_{y}H_{q}(X₈W₄₈O₁₈₄)]^{m-}.wH₂O,

(Aₙ)^{m+}[(MR′ₜ)₂H_{q}R_{z}(X₈W₄₈O₁₈₄)]^{m-}.wH₂O,

(Aₙ)^{m+}[(MR′ₜ)₂O_{y}R_{z}(X₈W₄₈O₁₈₄)]^{m-}.wH₂O,

(Aₙ)^{m+}[(MR′ₜ)₂H_{q}(X₈W₄₈O₁₈₄)]^{m-}.wH₂O,

(Aₙ)^{m+}[(MR′ₜ)₂(X₈W₄₈O₁₈₄)]^{m-}.wH₂O,

(Aₙ)^{m+}[M₄O_{y}H_{q}R_{z}(X₈W₄₈₊ᵣO₁₈₄₊₄ᵣ)]^{m-}.wH₂O, such as

(Aₙ)^{m+}[M₄O_{y}H_{q}(X₈W₄₈₊ᵣO₁₈₄₊₄ᵣ)]^{m-}.wH₂O,

(Aₙ)^{m+}[M₄H_{q}R_{z}(X₈W₄₈₊ᵣO₁₈₄₊₄ᵣ)]^{m-}.wH₂O,

(Aₙ)^{m+}[M₄O_{y}R_{z}(X₈W₄₈₊ᵣO₁₈₄₊₄ᵣ)]^{m-}.wH₂O,

(Aₙ)^{m+}[M₄H_{q}(X₈W₄₈₊ᵣO₁₈₄₊₄ᵣ)]^{m-}.wH₂O,

(Aₙ)^{m+}[M₄(X₈W₄₈₊ᵣO₁₈₄₊₄ᵣ)]^{m-}.wH₂O,

(Aₙ)^{m+}[(MR′ₜ)₆O_{y}H_{q}R_{z}(X₈W₄₈O₁₈₄)]^{m-}.wH₂O, such as

(Aₙ)^{m+}[(MR′ₜ)₆O_{y}H_{q}(X₈W₄₈O₁₈₄)]^{m-}.wH₂O,

(Aₙ)^{m+}[(MR′ₜ)₆H_{q}R_{z}(X₈W₄₈O₁₈₄)]^{m-}.wH₂O,

(Aₙ)^{m+}[(MR′ₜ)₆O_{y}R_{z}(X₈W₄₈O₁₈₄)]^{m-}.wH₂O,

(Aₙ)^{m+}[(MR′ₜ)₆H_{q}(X₈W₄₈O₁₈₄)]^{m-}.wH₂O,

(Aₙ)^{m+}[(MR′ₜ)₆(X₈W₄₈O₁₈₄)]^{m-}.wH₂O,

(Aₙ)^{m+}[(MCp*)ₛO_{y}H_{q}(P₈W₄₈O₁₈₄)]^{m-}.wH₂O, such as

(Aₙ)^{m+}[(PdCp*)ₛO_{y}H_{q}(P₈W₄₈O₁₈₄)]^{m-}.wH₂O, like

(Aₙ)^{m+}[(PdCp*)₂O_{y}H_{q}(P₈W₄₈O₁₈₄)]^{m-}.wH₂O,

(Aₙ)^{m+}[(PdCp*)₄O_{y}H_{q}(P₈W₄₈O₁₈₄)]^{m-}.wH₂O,

(Aₙ)^{m+}[(PdCp*)₆O_{y}H_{q}(P₈W₄₈O₁₈₄)]^{m-}.wH₂O,

(Aₙ)^{m+}[PtₛO_{y}H_{q}(P₈W₄₉O₁₈₈)]^{m-}.wH₂O, like

(Aₙ)^{m+}[Pt₂O_{y}H_{q}(P₈W₄₉O₁₈₈)]^{m-}.wH₂O,

(Aₙ)^{m+}[Pt₄O_{y}H_{q}(P₈W₄₉O₁₈₈)]^{m-}.wH₂O,

(Aₙ)^{m+}[Pt₆O_{y}H_{q}(P₈W₄₉O₁₈₈)]^{m-}.wH₂O,

(Aₙ)^{m+}[IrₛO_{y}H_{q}(P₈W₄₈O₁₈₄)]^{m-}.wH₂O, like

(Aₙ)^{m+}[Ir₂O_{y}H_{q}(P₈W₄₈O₁₈₄)]^{m-}.wH₂O,

(Aₙ)^{m+}[Ir₄O_{y}H_{q}(P₈W₄₈O₁₈₄)]^{m-}.wH₂O,

(Aₙ)^{m+}[Ir₆O_{y}H_{q}(P₈W₄₈O₁₈₄)]^{m-}.wH₂O,

(Aₙ)^{m+}[RhₛO_{y}H_{q}(P₈W₄₈O₁₈₄)]^{m-}.wH₂O, like

(Aₙ)^{m+}[Rh₂O_{y}H_{q}(P₈W₄₈O₁₈₄)]^{m-}.wH₂O,

(Aₙ)^{m+}[Rh₄O_{y}H_{q}(P₈W₄₈O₁₈₄)]^{m-}.wH₂O,

(Aₙ)^{m+}[Rh₆O_{y}H_{q}(P₈W₄₈O₁₈₄)]^{m-}.wH₂O,

(Aₙ)²⁸⁺[(MR′ₜ)ₛO_{y}H_{q}R_{z}(X₈W₄₈O₁₈₄)]²⁸⁻.wH₂O, such as

(A₂₈)²⁸⁺[(MR′ₜ)ₛR_{z}(X₈W₄₈O₁₈₄)]²⁸⁻.wH₂O,

(A₁₄)²⁸⁺[(MR′ₜ)ₛR_{z}(X₈W₄₈O₁₈₄)]²⁸⁻.wH₂O,

(Aₙ)²⁸⁺[(MR′ₜ)ₛO_{y}H_{q}R_{z}(P₈W₄₈O₁₈₄)]²⁸⁻.wH₂O,

(Aₙ)²⁸⁺[(MR′ₜ)₄O_{y}H_{q}R_{z}(X₈W₄₈O₁₈₄)]²⁸⁻.wH₂O,

(Aₙ)³⁰⁺[MₛO_{y}H_{q}R_{z}(X₈W₄₈O₁₈₄)]³⁰⁻.wH₂O, such as

(A₃₀)³⁰⁺[MₛR_{z}(X₈W₄₈O₁₈₄)]³⁰⁻.wH₂O,

(A₁₅)³⁰⁺[MₛR_{z}(X₈W₄₈O₁₈₄)]³⁰⁻.wH₂O,

(Aₙ)³⁰⁺[MₛO_{y}H_{q}R_{z}(P₈W₄₈O₁₈₄)]³⁰⁻.wH₂O,

(Aₙ)³⁰⁺[MₛO_{y}H_{q}R_{z}(X₈W₄₈O₁₈₄)]³⁰⁻.wH₂O,

(Aₙ)³²⁺[(MR′ₜ)ₛO_{y}H_{q}R_{z}(X₈W₄₈O₁₈₄)]³²⁻.wH₂O, such as

(A₃₂)³²⁺[(MR′ₜ)ₛR_{z}(X₈W₄₈O₁₈₄)]³²⁻.wH₂O,

(A₁₆)³²⁺[(MR′ₜ)ₛR_{z}(X₈W₄₈O₁₈₄)]³²⁻.wH₂O,

(Aₙ)³²⁺[(MR′ₜ)ₛO_{y}H_{q}R_{z}(P₈W₄₈O₁₈₄)]³²−.wH₂O,

(Aₙ)³²⁺[(MR′ₜ)₄O_{y}H_{q}R_{z}(X₈W₄₈O₁₈₄)]³²⁻.wH₂O,

(Aₙ)³²⁺[(MR′ₜ)₂O_{y}H_{q}R_{z}(X₈W₄₈O₁₈₄)]³²⁻.wH₂O,

(Aₙ)³⁴⁺[MₛO_{y}H_{q}R_{z}(X₈W₄₈O₁₈₄)]³⁴⁻.wH₂O, such as

(A₃₄)³⁴⁺[MₛR_{z}(X₈W₄₈O₁₈₄)]³⁴⁻.wH₂O,

(A₁₇)³⁴⁺[MₛR_{z}(X₈W₄₈O₁₈₄)]³⁴⁻.wH₂O,

(Aₙ)³⁴⁺[MₛO_{y}H_{q}R_{z}(P₈W₄₈O₁₈₄)]³⁴⁻.wH₂O,

(Aₙ)³⁴⁺[M₂O_{y}H_{q}R_{z}(X₈W₄₈O₁₈₄)]³⁴⁻.wH₂O,

(Aₙ)³⁶⁺[(MR′ₜ)ₛO_{y}H_{q}R_{z}(X₈W₄₈O₁₈₄)]³⁶⁻.wH₂O, such as

(A₃₆)³⁶⁺[(MR′ₜ)ₛR_{z}(X₈W₄₈O₁₈₄)]³⁶⁻.wH₂O,

(A₁₈)³⁶⁺[(MR′ₜ)ₛR_{z}(X₈W₄₈O₁₈₄)]³⁶⁻.wH₂O,

(Aₙ)³⁶⁺[(MR′ₜ)ₛO_{y}H_{q}R_{z}(P₈W₄₈O₁₈₄)]³⁶⁻.wH₂O,

(Aₙ)³⁶⁺[(MR′ₜ)₂O_{y}H_{q}R_{z}(X₈W₄₈O₁₈₄)]³⁶⁻.wH₂O.

In an especially preferred embodiment, the POMs provided by the present invention are in the form of a solution-stable polyanion. The POMs of the present invention can also be in the form crystals, e.g. in the form of primary and/or secondary particles. In an especially preferred embodiment, the POMs provided by the present invention are mainly in the form of primary particles (i.e. non-agglomerated primary particles), that is at least 90 wt % of the POMs are in the form of primary particles, preferably at least 95 wt %, more preferably at least 99 wt %, in particular substantially all the POMs particles are in the form of primary particles.

In a preferred embodiment, w water molecules, if present at all, are not coordinated to protons and/or A cations, while some water molecules may also coordinate to the M cations and/or optional organometallic ligands. In a preferred embodiment, a proportion of the water molecules is not directly attached to the POM framework (Aₙ)^{m+}[(MR′ₜ)ₛO_{y}H_{q}R_{z}(X₈W₄₈₊ᵣO₁₈₄₊₄ᵣ)]^{m-} by coordination but rather indirectly by hydrogen-bonding as water of crystallization. Thus, in a preferred embodiment, the attracted w water molecules, if present at all, are coordinated to A cations and/or possibly exhibit weak interactions by hydrogen bonding to protons of the POM and/or the attracted water molecules, if present at all, are water of crystallization and/or are coordinated to M cations and/or optional organometallic ligands.

In the POMs of the present invention, the guest atoms M may theoretically be replaced or removed without destroying the structural framework of the {X₈W₄₈₊ᵣO₁₈₄₊₄ᵣ} unit. However, the present inventors observed that the guest atoms M remain attached to the {X₈W₄₈₊ᵣO₁₈₄₊₄ᵣ} unit under a variety of conditions, e.g., in aqueous solution at pH values of 1 to 10, preferably 1 to 8, or in the solid state at temperatures of up to 500° C., preferably 400° C.

The diameter of the present POMs primary particles has been found to be about 2 nm determined by single-crystal X-ray diffraction analysis.

Specific examples of structures of specific POMs of the present invention are also illustrated in FIGS. 4, 8, 12, 16, 19, 20, 21, 27, 28 and 29.

In comparison to most known TMSPs (transition metal-substituted POMs), the present POMs are characterized in that at least a significant proportion of the metal atom positions of the POM is occupied by noble metal atoms selected from Rh, Ir, Pd, Pt, Ag, Au, and mixtures thereof. This is surprising as noble-metal-containing POMs are notoriously difficult to prepare. Firstly, 4d and 5d transition metals, like noble metals, are generally less reactive than 3d transition metals. Secondly, late transition metals, like noble metals, are generally less oxophilic than early transition metals. The latter aspect is already evident from the respective assignment of the chemical elements in question within the Pearson acid-base concept (also known as HSAB concept). Negatively charged oxygen forms hard bases, whereas the noble metals as late 4d and 5d transition metals constitute soft acids when being positively charged. In contrast, positively charged early transition metals, in particular early 3d transition metals, are hard acids and, thus, react faster and form stronger bonds with the hard base oxygen, i.e., are highly oxophilic as opposed to noble metals. For this reason many, if not most, of the known TMSPs contain early transition metals, in particular early 3d transition metals, contrary to the present POMs.

Furthermore, in contrast to commonly used noble metal catalysts, including the few known noble metal containing POMs/TMSPs, the present POMs are further characterized in that they show a unique combination of (i) exceptionally high catalytic activity and the (ii) ability of being regenerated very efficiently maintaining most, if not all, of their catalytic activity, which is believed to be associated with the absence of any significant degree of loss or sintering of the expensive noble metals in the regeneration step. While the inventors do not wish to be bound by any particular theory, it is believed that the {X₈W₄₈₊ᵣO₁₈₄₊₄ᵣ} unit, in particular the {X₈W₄₈O₁₈₄} unit, forms a highly stable and robust shell unit, which accommodates and, thus, protects the noble metal species. The present inventors believe that the {X₈W₄₈₊ᵣO₁₈₄₊₄ᵣ} unit, in particular the {X₈W₄₈O₁₈₄} unit, provides a fine balance between shielding the expensive noble metal species in the regeneration step without preventing sufficient access for the substrates to the catalytically active noble metals in the catalytic process step, i.e., the {X₈W₄₈₊ᵣO₁₈₄₊₄ᵣ} unit, in particular the {X₈W₄₈O₁₈₄} unit, provides sufficient shielding for the noble metal species to prevent loss and/or sintering in the regeneration step but not so much shielding that the noble metal species would be deprived of their catalytic activity. In fact, the present inventors observed exceptionally high catalytic activities for the present POMs. Without wishing to be bound by any theory, it is believed that the exceptionally high catalytic activity resides in the unique structure of the present POMs as (i) the shell function of the {X₈W₄₈₊ᵣO₁₈₄₊₄ᵣ} unit, in particular the {X₈W₄₈O₁₈₄} unit, may provide specific template effects for certain substrates enhancing the catalytic process activity, (ii) careful selection of the noble metal species allows for fine-tuning the desired catalytic activity and (iii) the noble metal atoms being arranged in a well-defined, highly ordered, centrally located and easily accessible structural formation provides for a highly efficient use of most, if not all, of the expensive noble metal centers in the catalytic process. The {X₈W₄₈₊ᵣO₁₈₄₊₄ᵣ} unit, in particular the {X₈W₄₈O₁₈₄} unit, imparts not only the unique catalytic activity and regeneratability to the noble metal species, but is also (i) composed of rather inexpensive atom species, (ii) easily accessible by synthesis and (iii) highly stable inter alia allowing for the present POMs to be activated under various conditions (iv) without decomposition, let alone formation of any toxic degradation products.

In another embodiment, the POMs may be further calcined at a temperature not exceeding the transformation temperature of the POM, i.e. the temperature at which the POMs have been proven to be stable (usually at least 800° C. for the present POMs according to their corresponding TGA). Thus, in a preferred embodiment the POMs of the present invention are thermally stable up to temperatures of at least 800° C. For the calcination, common equipment may be used, that is commercially available. Calcination of the POMs may be conducted under an oxygen containing gas such as air, under vacuum, under hydrogen or under an inert gas such as argon or nitrogen, more preferably under inert gas, most preferably under nitrogen. Calcination may help to activate a POM pre-catalyst by forming active sites. Upon heating, POM salts loose water molecules (of water of crystallization) before they start to transform/decompose, e.g. by oxidation. TGA can be used to study the weight loss of the POM salts, and Differential Scanning Calorimetry (DSC) indicates whether each step is endo- or exothermic. Such measurements may be carried out e.g. under nitrogen gas, air, oxygen or hydrogen.

In many cases, however, and in particular if the POM is used as a catalyst or pre-catalyst under reductive conditions, drying of the POM without calcination may be sufficient.

The invention is further directed to a process for preparing POMs according to the invention.

A process for preparing POMs according to the present invention comprises:
(a) reacting at least one source of M and at least one source of {X₈W₄₈₊ᵣO₁₈₄₊₄ᵣ} and optionally at least one source of R and/or R′ to form a salt of the polyanion [(MR′ₜ)ₛO_{y}H_{q}R_{z}(X₈W₄₈₊ᵣO₁₈₄₊₄ᵣ)] or a solvate thereof,
(b) optionally adding at least one salt of A to the reaction mixture of step (a) to form a polyoxometalate (Aₙ)^{m+}[(MR′ₜ)ₛO_{y}H_{q}R_{z}(X₈W₄₈₊ᵣO₁₈₄₊₄ᵣ)]^{m-} or a solvate thereof, and
(c) recovering the polyoxometalate or solvate thereof
wherein A, n, m, M, X, R, R′, s, y, q, r, t and z are the same as defined above.

In step (a) of said process at least one source of {X₈W₄₈₊ᵣO₁₈₄₊₄ᵣ} is used, especially one source of {X₈W₄₈₊ᵣO₁₈₄₊₄ᵣ}. Generally, in a preferred embodiment of the present invention, the at least one source of {X₈W₄₈₊ᵣO₁₈₄₊₄ᵣ} is an X₂W₁₂-based species, an X₄W₂₄-based species, an X₈W₄₈-based species, or a combination thereof, wherein the X₂W₁₂-based species and/or the X₄W₂₄-based species form an X₈W₄₈-based species in situ. In a preferred embodiment, the X₂W₁₂-based species forms an X₈W₄₈-based species in situ by intermediately forming an X₄W₂₄-based species. In case r is 1 or 2, preferably the one or two extra tungsten atoms are formed by decomposition of the at least one source of {X₈W₄₈₊ᵣO₁₈₄₊₄ᵣ}, in particular by decomposition of the X₂W₁₂-based species, the X₄W₂₄-based species, or the X₈W₄₈-based species, preferably by decomposition of the X₄W₂₄-based species.

In a preferred embodiment, the at least one source of {X₈W₄₈₊ᵣO₁₈₄₊₄ᵣ} is a X₈W₄₈-based species, in particular a water-soluble [X₈W₄₈O₁₈₄]⁴⁰⁻ salt, preferably a [X₈W₄₈O₁₈₄]⁴⁰⁻ salt of lithium, sodium, potassium, hydrogen or a combination thereof, more preferably a [X₈W₄₈O₁₈₄]⁴⁰⁻ salt of lithium, potassium, hydrogen or a combination thereof, in particular a [X₈W₄₈O₁₈₄]⁴⁰⁻ salt of a combination of lithium, potassium and hydrogen. In a preferred embodiment, the at least one source of {X₈W₄₈₊ᵣO₁₈₄₊₄ᵣ} is K₂₈Li₅H₇[X₈W₄₈O₁₈₄] as prepared according to Constant (see, e.g., Inorg. Chem. 1985, 24, 4610-4614; Inorg. Synth. 1990, 27, 110).

In a preferred embodiment, the at least one source of {X₈W₄₈₊ᵣO₁₈₄₊₄ᵣ} is a X₄W₂₄-based species, in particular a water-soluble [X₄W₂₄O₉₄]²⁴⁻ salt, preferably a [X₄W₂₄O₉₄]²⁴⁻ salt of lithium, sodium, potassium, hydrogen or a combination thereof, more preferably a [X₄W₂₄O₉₄]²⁴⁻ salt of lithium, potassium, hydrogen or a combination thereof, in particular a [X₄W₂₄O₉₄]²⁴⁻ salt of a combination of lithium, potassium and hydrogen.

In a preferred embodiment, the at least one source of {X₈W₄₈₊ᵣO₁₈₄₊₄ᵣ} is a X₂W₁₂-based species, in particular a water-soluble [X₂W₁₂O₄₈]¹⁴⁻ salt, preferably a [X₂W₁₂O₄₈]¹⁴⁻ salt of lithium, sodium, potassium, hydrogen or a combination thereof, more preferably a [X₂W₁₂O₄₈]¹⁴⁻ salt of lithium, potassium, hydrogen or a combination thereof, in particular a [X₂W₁₂O₄₈]¹⁴⁻ salt of a combination of lithium, potassium and hydrogen. In a preferred embodiment, the at least one source of {X₈W₄₈₊ᵣO₁₈₄₊₄ᵣ} is a X₂W₁₂-based species being a water-soluble [X₂W₁₂O₄₈]¹⁴⁻ salt in situ generated from a [X₂W₁₈O₆₂]⁶⁻ salt, in particular a [X₂W₁₈O₆₂]⁶⁻ salt of lithium, sodium, potassium, hydrogen or a combination thereof.

In another embodiment, the at least one source of {X₈W₄₈₊ᵣO₁₈₄₊₄ᵣ} is a combination of at least one source of W, in particular at least one source of W^{VI}, at least one source of O, in particular at least one source of O^{-II}, at least one source of X, in particular at least one source of X^{V}, preferably at least one source of P^{V} or As^{V}, more preferably at least one source of P^{V}, wherein the conditions in step (a) are such that the {X₈W₄₈₊ᵣO₁₈₄₊₄ᵣ} unit is formed.

In step (a) of said process at least one source of M is used, especially one source of M. Generally, in a preferred embodiment of the present invention as source for the noble metal M atoms can be used Pd^{II} salts such as palladium chloride (PdCl₂), palladium nitrate (Pd(NO₃)₂), palladium acetate (Pd(CH₃COO)₂) and palladium sulphate (PdSO₄); Pt^{II} salts such as potassium tetrachloroplatinate (K₂PtCl₄) and platinum chloride (PtCl₂); Rh^{I} salts such as [(C₆H₅)₃P]₂RhCl(CO) and [Rh(CO)₂Cl]₂, Rh^{III} salts such as rhodium chloride (RhCl₃), or Rh compounds such as rhodocene ([Rh(Cp)₂]), pentamethylcyclopentadienyl rhodium chloride ([Rh(Cp*)Cl₂]₂), benzene rhodium chloride ([Rh(Bz)Cl₂]₂), p-cymene rhodium chloride ([Rh(p-cymene)Cl₂]₂), and rhodium(II) acetate (C₈H₁₂O₈Rh₂); Ir^{I} salts such as [(C₆H₅)₃P]₂IrCl(CO), Ir^{III} salts such as iridium chloride (IrCl₃), or Ir compounds such as pentamethylcyclopentadienyl iridium chloride ([Ir(Cp*)Cl₂]₂), benzene iridium chloride ([Ir(Bz)Cl₂]₂), and p-cymene iridium chloride ([Ir(p-cymene)Cl₂]₂); Au^{III} salts such as gold chloride (AuCl₃), or Au sources such as gold hydroxide (Au(OH)₃) and chloroauric acid (HAuCl₄.aq); and Ag^{III} salts preferably generated with oxidizing reagents from Ag^{I} salts such as silver nitrate (AgNO₃), silver fluoride (AgF) and silver chloride (AgCl). More preferably, the Pd source is PdCl₂ or Pd(CH₃COO)₂; the Pt source is K₂PtCl₄; the Rh source is RhCl₃ or [Rh(Cp*)Cl₂]₂; and the Ir source is IrCl₃ or [Ir(Cp*)Cl₂]₂. In a preferred embodiment the organometallic ligand R′, if present, is introduced in step (a) as a complex with metal M, i.e., the at least one source of M and the at least one source of R′ are the same.

In step (a) of said process optionally at least one source of R is used, especially one source of R. Generally, in a preferred embodiment of the present invention, salts of the monovalent anions selected from the group consisting of F, Cl, Br, I, CN, N₃, CP, FHF, SH, SCN, NCS, SeCN, CNO, NCO and OCN, more preferably F, Cl, Br, I, CN, and N₃, more preferably Cl, Br, I and N₃, most preferably Cl, Br and I, in particular Cl. Preferably the following cations may be used in the salts: Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof. More preferably lithium, potassium or sodium, in particular NaCl, LiCl, NaBr, KBr and NaI may be used.

In a preferred embodiment, step (a) of said process is carried out in an aqueous solution. In a preferred embodiment, minor amounts of organic solvent, such as, 40 to 0.01 vol % based on the total volume of the reaction mixture, preferably 30 to 0.05 vol %, 20 to 0.1 vol %, 10 to 0.2 vol %, 5 to 0.5 vol % or 3 to 1 vol %, may be added to the aqueous solution. In particular, if any of the starting materials has only a low solubility in water it is possible to dissolve the respective starting material in a small volume of organic solvent and then adding this solution to an aqueous solution of the remaining starting materials or vice versa. Examples of suitable organic solvents include, but are not limited to acetonitrile, acetone, toluene, DMF, DMSO, ethanol, methanol, n-butanol, sec-butanol, isobutanol and mixtures thereof. It is also possible to use emulsifying agents to allow the reagents of step (a) of said process to undergo a reaction.

Furthermore, in a preferred embodiment of the present invention, in step (a) of said process, the concentration of the noble metal ions originating from the at least one source of M ranges from 0.001 to 1 mole/l, preferably from 0.002 to 0.5 mole/l, more preferably from 0.005 to 0.1 mole/l, the concentration of the X₈W₄₈-based species originating from the sources of {X₈W₄₈₊ᵣO₁₈₄₊₄ᵣ} ranges from 0.0001 to 0.1 mole/l, preferably 0.0003 to 0.05 mole/l, more preferably 0.0005 to 0.01 mole/l, optionally the concentration of the R′-containing starting material ranges from 0.001 to 5 mole/l, preferably 0.002 to 0.5 mole/l, more preferably 0.005 to 0.1 mole/l and optionally the concentration of the R-containing starting material ranges from 0.001 to 1 mole/l, preferably 0.002 to 0.5 mole/l, more preferably 0.005 to 0.1 mole/l.

Furthermore, in a preferred embodiment, the pH of the aqueous solution in step (a) of said process ranges from 1 to 10, preferably from 1.5 to 9 and more preferably from 2 to 8. Most preferably, the pH is from about 3 to about 7, for instance from about 3.5 to about 6.5. Generally, in a preferred embodiment of the present invention a buffer solution can be used for maintaining the pH value in a certain range.

In a preferred embodiment of the present invention the buffer is a phosphate or acetate buffer or a mixture thereof and preferably said phosphate or acetate buffer is derived from H₃PO₄, NaH₂PO₄, Na₂HPO₄, Na₃PO₄, KH₂PO₄, K₂HPO₄, K₃PO₄, NaKHPO₄, NaK₂PO₄, Na₂KPO₄, Na(CH₃CO₂), K(CH₃CO₂), Mg(CH₃CO₂)₂, Ca(CH₃CO₂)₂, CH₃CO₂H or mixtures thereof, preferably H₃PO₄, NaH₂PO₄, Na₂HPO₄, Na₃PO₄, Na(CH₃CO₂), K(CH₃CO₂), CH₃CO₂H or mixtures thereof, and most preferably NaH₂PO₄, Na₂HPO₄, Na(CH₃CO₂), Li(CH₃CO₂) or mixtures thereof, in particular NaH₂PO₄, Na(CH₃CO₂) or mixtures thereof. It is more preferred to have either a phosphate or an acetate buffer, whereas it is less preferred to have a mixture of phosphate and acetate buffer. In a preferred embodiment of the present invention said phosphate buffer is preferably derived from NaH₂PO₄, whereas said acetate buffer is preferably derived from Li(CH₃CO₂), Na(CH₃CO₂) or mixtures thereof. In a very preferred embodiment of the present invention the buffer is an acetate buffer and is preferably derived from Li(CH₃CO₂), Na(CH₃CO₂) or mixtures thereof.

Generally, in an embodiment of the present invention, additional base or acid solution can be used for adjusting the pH to a certain value. It is particularly preferred to use aqueous sodium hydroxide or H₂SO₄ solution having a concentration of 1 M. In another embodiment, the concentration of the aqueous base or acid solution (preferably aqueous sodium hydroxide or H₂SO₄ solution) is from 0.1 to 12 M, preferably 0.2 to 8 M, more preferably from 0.5 to 6 M, most preferably about 1 M. Generally, in a very preferred embodiment of the present invention additional acid solution can be used for adjusting the pH to a certain pH value. It is particularly preferred to use aqueous H₂SO₄ solution having a concentration of 0.1 M. In another embodiment, the concentration of the acid solution (preferably aqueous H₂SO₄ solution) is from 0.1 to 12 M, preferably 0.2 to 8 M, more preferably from 0.5 to 6 M, most preferably about 1 M.

In the context of the present invention the pH of the aqueous solution in step (a) of said process refers to the pH as measured at the end of the reaction. In the preferred embodiment where e.g. an aqueous sodium hydroxide solution is used for adjusting the pH-value, the pH is measured after the adjustment at the end of the reaction. pH values are at 20° C., and are determined to an accuracy of ±0.05 in accordance with the IUPAC Recommendations 2002 (R. P. Buck et al., Pure Appl. Chem., Vol. 74, No. 11, pp. 2169-2200, 2002).

A suitable and commercially available instrument for pH measurement is the Mettler Toledo FE20 pH meter. The pH calibration is carried out as 2-point calibration using a pH=4.01 standard buffer solution and a pH=7.00 standard buffer solution. The resolutions are: 0.01 pH; 1 mV; and 0.1° C. The limits of error are: ±0.01 pH; ±1 mV; and ±0.5° C.

A very preferred embodiment of the present invention is said process, wherein in step (a) the at least one source of M and at least one source of {X₈W₄₈₊ᵣO₁₈₄₊₄ᵣ} and optionally at least one source of R and/or R′ are dissolved in a solution of acetate buffer derived from lithium or sodium acetate, preferably an 0.5 to 1.5 M acetate buffer derived from lithium or sodium acetate, in particular a 0.75 to 1.25 M acetate buffer derived from lithium or sodium acetate, and most preferred a 1.0 M acetate buffer derived from lithium or sodium acetate.

In step (a) of the process of the present invention, further additives may be used. In one embodiment H₂O₂ (preferably 30 wt % in water) is added. Without wishing to be bound by any theory, it is believed that the H₂O₂ (re)oxidizes the metal species to desired oxidation state. In one embodiment propylene oxide is added. Without wishing to be bound by any theory, it is believed that the propylene oxide facilitates the formation of oxygen bridges.

In a preferred embodiment, in step (a) of the process of the present invention, a perchlorate salt is added as a further additive, preferably lithium or sodium perchlorate or mixtures thereof, in particular lithium perchlorate. Preferably the perchlorate salt is added as a 1 M solution in water. Without wishing to be bound by any theory, it is believed that the perchlorate facilitates solubility.

Any of the above additives may be used individually or in combination as well as in combination with other additives commonly used in the art.

In step (a) of the process of the present invention, the reaction mixture is typically heated to a temperature of from 20° C. to 100° C., preferably from 50° C. to 90° C., preferably from 60° C. to 85° C., preferably from 60° C. to 80° C., and most preferably about 75° C.

In step (a) of the process of the present invention, the reaction mixture is typically heated for about 10 min to about 4 h, more preferably for about 30 min to 2 h, most preferably for about 90 min. Further, it is preferred that the reaction mixture is stirred during step (a).

With regard to the present invention the term crude mixture relates to an unpurified mixture after a reaction step and is thereby used synonymously with reaction mixture of the preceding reaction step.

In a preferred embodiment of the process of the present invention, between step (a) and (b), the crude mixture is filtered. Preferably, the crude mixture is filtered immediately after the end of step (a), i.e. immediately after the stirring is turned off, and is then optionally cooled. Alternatively, if applicable the heated crude mixture is cooled first, preferably to room temperature, and subsequently filtered. The purpose of this filtration is to remove solid impurities after step (a). Thus, the product of step (a) remains in the filtrate.

In a preferred embodiment, in case cation A is not present in the crude mixture or filtrate already, or the concentration of A in the crude mixture or filtrate should be increased, in step (b) of the process, a salt of the cation A can be added to the reaction mixture of step (a) of the process or to its corresponding filtrates to form (Aₙ)^{m+}[(MR′ₜ)ₛO_{y}H_{q}R_{z}(X₈W₄₈₊ᵣO₁₈₄₊₄ᵣ)]^{m-}. Preferably, the salt of A is added as a solid or in the form of an aqueous solution. The counterions of A can be selected from the group consisting of any stable, non-reducing, water-soluble anion, e.g., halides, nitrate, sulfate, acetate, phosphate. Preferably, the acetate or phosphate salt is used. However, the addition of extra cations A in step (b) of the process is not necessary if the desired cations are already present during step (a) of the process, for example, as a component of the buffer preferably used as solvent in step (a) of the process or a component of any of the sources of {X₈W₄₈₊ᵣO₁₈₄₊₄ᵣ}, M or optionally R and/or R′ including, for example, palladium and platinum cations themselves. Preferably, all desired cations are already present during step (a) of the process, so that optional addition of extra cations is not necessary.

In step (c) of the process of the present invention, the POMs according to the invention or solvates thereof, formed in step (a) or (b) of said process, are recovered. For example, isolation of the POMs or solvates thereof can be effected by common techniques including bulk precipitation or crystallization. In a preferred embodiment of the present invention the POMs are isolated as crystalline or amorphous solids, preferably as crystalline solids. Crystallization or precipitation can be effected by common techniques such as evaporation or partial evaporation of the solvent, cooling, change of solvent, solvents or solvent mixtures, addition of crystallization seeds, etc. In a preferred embodiment the addition of cation A in step (b) of the process can induce crystallization or precipitation of the desired POM (Aₙ)^{m+}[(MR′ₜ)ₛO_{y}H_{q}R_{z}(X₈W₄₈₊ᵣO₁₈₄₊₄ᵣ)]^{m-}, wherein fractional crystallization is preferable. In a preferred embodiment, fractional crystallization might be accomplished by the slow addition of a specific amount of cation A to the reaction mixture of step (a) of the process or to its corresponding filtrates which might be beneficial for product purity and yield.

A preferred embodiment of the present invention is such a process wherein water is used as solvent and the at least one source of M is a water-soluble salt of Ir, Rh, Pt or Pd, preferably selected from K₂PtCl₄, PtCl₂, Pd(CH₃COO)₂, PdCl₂, Pd(NO₃)₂, PdSO₄, IrCl₃, or RhCl₃; and the at least one source of {X₈W₄₈₊ᵣO₁₈₄₊₄ᵣ} is K₂₈Li₅H₇P₈W₄₈O₁₈₄ or K₁₆Li₂H₆P₄W₂₄O₉₄.

A preferred embodiment of the present invention is such a process wherein water is used as solvent and the at least one source of M is a water-soluble salt of Ir, Rh, Pt or Pd, preferably selected from the group Cp*-containing organometallic complexes of Ir, Rh, Pt or Pd, such as [Ir(Cp*)Cl₂]₂ or [Rh(Cp*)Cl₂]₂; and the at least one source of {X₈W₄₈₊ᵣO₁₈₄₊₄ᵣ} is K₂₈Li₅H₇P₈W₄₈O₁₈₄ or K₁₆Li₂H₆P₄W₂₄O₉₄.

A preferred embodiment of the present invention is such a process wherein water is used as solvent containing 1 M lithium or sodium acetate and the at least one source of M is a water-soluble salt of Ir, Rh, Pt or Pd selected from K₂PtCl₄, Pd(CH₃COO)₂, IrCl₃, or RhCl₃; and the at least one source of {X₈W₄₈₊ᵣO₁₈₄₊₄ᵣ} is K₂₈Li₅H₇P₈W₄₈O₁₈₄ or K₁₆Li₂H₆P₄W₂₄O₉₄.

A preferred embodiment of the present invention is such a process wherein water is used as solvent containing 1 M lithium or sodium acetate and the at least one source of M is a water-soluble salt of Ir, Rh, Pt or Pd selected from the group Cp*-containing organometallic complexes of Ir, Rh, Pt or Pd, such as [Ir(Cp*)Cl₂]₂ or [Rh(Cp*)Cl₂]₂; and the at least one source of {X₈W₄₈₊ᵣO₁₈₄₊₄ᵣ} is K₂₈Li₅H₇P₈W₄₈O₁₈₄ or K₁₆Li₂H₆P₄W₂₄O₉₄.

A most preferred embodiment of the present invention is a process wherein in step (a) at least one source of M is used and all M are the same, preferably wherein all M are Pd, preferably wherein all M are Pt, preferably wherein all M are Rh, preferably wherein all M are Ir. Another most preferred embodiment of the present invention is a process wherein in step (a) at least one source of M is used and M is a mixture of Pd and Pt.

According to one embodiment, the present POMs can be immobilized on a solid support. The present invention thus also relates to supported POMs comprising the POMs of the present invention or prepared by the process of the present invention on a solid support. Suitable supports include but are not limited to materials having a high surface area and/or a pore size which is sufficient to allow the POMs to be loaded, e.g., polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous materials, like mesoporous silica, such as SBA-15 and MCM-41, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof and modified compounds thereof Preferred supports are, for instance, mesoporous silica, more preferably SBA-15 or MCM-41, most preferably SBA-15. A variety of such solid supports is commercially available or can be prepared by common techniques. Furthermore, there are various common techniques to modify or functionalize solid supports, for example with regard to the size and shape of the surface or the atoms or groups available for bonding on the surface.

In a preferred embodiment of the present invention the immobilization of the POMs to the surface of the solid support is accomplished by means of adsorption, including physisorption and chemisorption, preferably physisorption. The adsorption is based on interactions between the POMs and the surface of the solid support such as van-der-Waals interactions, hydrogen-bonding interactions, ionic interactions, etc.

In a preferred embodiment the negatively charged polyanions [(MR′ₜ)ₛO_{y}H_{q}R_{z}(X₈W₄₈₊ᵣO₁₈₄₊₄ᵣ)] are adsorbed predominantly based on ionic interactions. Therefore, a solid support bearing positively charged groups is preferably used, in particular a solid support bearing groups that can be positively charged by protonation. A variety of such solid supports is commercially available or can be prepared by common techniques. In one embodiment the solid support is functionalized with positively charged groups, preferably groups that are positively charged by protonation, and the negatively charged polyanion [(MR′ₜ)ₛO_{y}H_{q}R_{z}(X₈W₄₈₊ᵣO₁₈₄₊₄ᵣ)] is linked to said positively charged groups by electrostatic interactions. In a preferred embodiment the solid support, preferably mesoporous silica, more preferably SBA-15 or MCM-41, most preferably SBA-15, is functionalized with moieties bearing positively charged groups, preferably tetrahydrocarbyl ammonium groups, more preferably groups that can be positively charged by protonation, most preferably mono-functionalized amino groups —NH₂. Preferably said groups are attached to the surface of the solid support by covalent bonds, preferably via a linker that comprises one or more, preferably one, of said groups, preferably an alkyl, aryl, alkenyl, alkynyl, hetero-alkyl, hetero-cycloalkyl, hetero-alkenyl, hetero-cycloalkenyl, hetero-alkynyl, hetero-aryl or cycloalkyl linker, more preferably an alkyl, aryl, hetero-alkyl or hetero-aryl linker, more preferably an alkyl linker, most preferably a methylene, ethylene, n-propylene, n-butylene, n-pentylene, n-hexylene linker, in particular a n-propylene linker. Preferably said linkers are bonded to any suitable functional group present on the surface of the solid support, such as to hydroxyl groups. Preferably said linkers are bonded to said functional groups present on the surface of the solid support either directly or via another group or atom, most preferably via another group or atom, preferably a silicon-based group, most preferably a silicon atom. In a most preferred embodiment of the present invention the POMs are supported on (3-aminopropyl)triethoxysilane (apts)-modified SBA-15.

In the supported POMs of the present invention, the POMs that are immobilized on the solid support are in the form of primary and/or secondary particles. In an especially preferred embodiment, the immobilized POMs particles are mainly in the form of primary particles (i.e. non-agglomerated primary particles), that is at least 90 wt % of the immobilized POMs particles are in the form of primary particles, preferably at least 95 wt %, more preferably at least 99 wt %, in particular substantially all the immobilized POMs particles are in the form of primary particles.

The invention is further directed to processes for preparing supported POMs according to the invention. Solid supports used in the context of this invention are as defined above. In a preferred embodiment of the present invention the surface of the solid supports is modified with positively charged groups, more preferably groups that can be positively charged by protonation. Those charged solid supports can be prepared by techniques well established in the art, for example by surface modification of a mesoporous silica, such as SBA-15, with a suitable reagent bearing a positively charged group or a group that can be positively charged by protonation, such as 3-aminopropyltriethoxysilane (apts), is conducted by heating, preferably under reflux, under inert gas atmosphere, such as argon or nitrogen, in an inert solvent with a suitable boiling point, such as hexane, heptane or toluene, for a suitable time, such as 4-8 hours, and finally the modified solid support is isolated, preferably by filtration, purified, preferably by washing, and dried, preferably under vacuum by heating, most preferably under vacuum by heating at about 100° C.

The optionally treated support may be further calcined at a temperature of 500° C. to 800° C. For the calcination, common equipment may be used, that is commercially available. Calcination of the optionally treated support may for instance be conducted under an oxygen containing gas such as air, under vacuum, under hydrogen or under an inert gas such as argon or nitrogen, more preferably under inert gas, most preferably under nitrogen.

The POMs according to the present invention or prepared by the process of the present invention can be immobilized on the surface of the solid support by contacting said POMs with the solid support. The present invention therefore also relates to a process for the preparation of supported POMs, comprising the step of contacting the POMs provided by the present invention or prepared according to the present invention with the solid support, thereby immobilizing at least part of the POMs onto the support; and optionally isolating the resulting supported POMs.

Said contacting may be conducted employing common techniques in the art, such as blending both the solid support and the POM in the solid form. In a preferred embodiment the POM is mixed with a suitable solvent, preferably water or an aqueous solvent, and the solid support is added to this mixture. In a more preferred embodiment the solid support is mixed with a suitable solvent, preferably water or an aqueous solvent, and the POM is added to this mixture. In case a solid support with groups that can be positively charged by protonation is used, the mixture is preferably acidified, for instance by addition of H₂SO₄, HNO₃ or HCl, most preferably by addition of H₂SO₄ or HNO₃, so that the pH value of the mixture ranges from 0.1 to 6, preferably from 1 to 4 and more preferably from 1.5 to 3, most preferably about 2. The mixture comprising POM, solid support and solvent is preferably stirred, typically for 1 min to 24 h, more preferably for 30 min to 15 h, more preferably for 1 h to 12 h, most preferably for 6 h to 10 h, in particular about 8 h. While stirring, the mixture may be at a temperature of from 20° C. to 100° C., preferably from 20° C. to 80° C., preferably from 20° C. to 60° C., preferably from 20° C. to 40° C., and most preferably about 25° C. Afterwards, the supported POM can be kept in the solvent as suspension or can be isolated. Isolation of the supported POM from the solvent may be performed by any suitable method in the art, such as by filtration, evaporation of the solvent, centrifugation or decantation, preferably by filtration or removal of the solvent in vacuum, more preferably by filtration. The isolated supported POMs may then be washed with a suitable solvent, preferably water or an aqueous solvent, and dried. Supported POMs may be dried in an oven at a temperature of e.g. about 100° C.

In another embodiment, the supported POMs may be further calcined at a temperature not exceeding the transformation temperature of the POM, i.e. the temperature at which the POMs have been proven to be stable (usually at least 800° C. for the present POMs according to their corresponding TGA). Thus, in a preferred embodiment the POMs of the present invention are thermally stable up to temperatures of at least 800° C. For the calcination, common equipment may be used, that is commercially available. Calcination of the supported POMs may for instance be conducted under an oxygen containing gas such as air, under vacuum, under hydrogen or under an inert gas such as argon or nitrogen, more preferably under inert gas, most preferably under nitrogen.

In many cases, however, and in particular if the supported POM is used as a catalyst or pre-catalyst under reductive conditions, drying of the supported POM without calcination may be sufficient.

In supported POMs, the POM loading levels on the solid support may be up to 30 wt % or even more but are preferably up to 10 wt %, for instance up to 5 wt % or even up to 2 wt %. Accordingly, the POM loading level on the solid support is typically 0.01 to 30 wt %, particularly 0.05 to 20 wt %, more particularly 0.1 to 10 wt %, often 0.2-6 wt %, more often 0.3-5 wt %, and most often 0.5-2 wt %. POM loading levels on the solid support can be determined by elemental analysis such as Inductively Coupled Plasma Mass Spectrometry (ICP-MS) analysis, for instance using a Varian Vista MPX.

According to one embodiment, the present invention also relates to a metal cluster of the formula

(A′_{n′})^{m′+}[M⁰ₛ(X₈W₄₈₊ᵣO₁₈₄₊₄ᵣ)]^{m′-}

wherein;
each A′ independently represents a cation, preferably each A′ is independently selected from the group consisting of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof; more preferably from the group consisting of Li, K, Na and combinations thereof
n′ is the number of cations,
each M⁰ is independently selected from the group consisting of Pd⁰, Pt⁰, Rh⁰, Ir⁰, Ag⁰, and Au⁰, preferably Pd⁰, Pt⁰, Rh⁰, Ir⁰, and Au⁰, more preferably Pd⁰, Pt⁰, Ir⁰, and Rh⁰, most preferably Pd⁰ and Pt⁰, in particular Pd⁰,
each X is independently selected from the group consisting of P, As, Se and Te, preferably P and As, preferably As^{V} and P^{V}, in particular P, preferably P^{V},
s is a number from 2 to 12, in particulars is 2, 4, 6, 8, 10 or 12; preferably s is 2, 4, 6, 8 or 12; more preferably s is 2, 4, 6 or 12; most preferably s is 2, 4 or 6,
r is a number selected from 0, 1 or 2, preferably r is 0 or 1, more preferably r is 0, and
m′ is a number representing the total positive charge m′+ of n′ cations A′ and the corresponding negative charge m′− of the metal cluster unit anion [M⁰ₛ(X₈W₄₈₊ᵣO₁₈₄₊₄ᵣ)].

In a preferred embodiment, X₈W₄₈O₁₈₄ preferably forms a {X₈W₄₈₊ᵣO₁₈₄₊₄ᵣ}′ unit, preferably the {X₈W₄₈₊ᵣO₁₈₄₊₄ᵣ}′ unit has a central cavity, wherein the {X₈W₄₈₊ᵣO₁₈₄₊₄ᵣ}′ unit is a {X₈W₄₈O₁₈₄}′ unit for r being 0, a {X₈W₄₈₊₁O₁₈₄₊₄}′ unit for r being 1 and a {X₈W₄₈₊₂O₁₈₄₊₈}′ unit for r being 2. Preferably, wherein r is 0 and X₈W₄₈O₁₈₄ forms a {X₈W₄₈O₁₈₄}′ unit, the {X₈W₄₈O₁₈₄}′ unit in the metal cluster (A′_{n′})^{m′+}[M⁰ₛ(X₈W₄₈O₁₈₄)]^{m′-} is represented by the following formula 1

wherein each O is presented in small Black dots, each W is presented in dark Gray spheres and each X is presented in light Gray sphere. The {X₈W₄₈O₁₈₄}′ unit is a cyclic fragment consisting of 4 X₂W₁₂-based units, in particular 4 X₂W₁₂O₄₄ units, wherein each X₂W₁₂-based unit (X₂W₁₂O₄₄ unit) is bonded to two adjacent X₂W₁₂-based units (X₂W₁₂O₄₄ units) via 4 O atoms, wherein each of said 4 O atoms is bonded to a different W atom of each X₂W₁₂-based unit (X₂W₁₂O₄₄ unit) and wherein every two X₂W₁₂-based units (X₂W₁₂O₄₄ units) are linked to each other by 2 of said 4 O atoms, wherein in the {X₈W₄₈O₁₈₄}′ unit each X is linked to 6 different W via a 1 O atom bridge, respectively, and wherein each X is bonded to 4 O and each W is bonded to 6 O. In the {X₈W₄₈O₁₈₄}′ unit, 16 W atoms are directed towards the central cavity, each of said 16 W atoms is bonded to a different O atom, wherein these 16 O atoms are directed further towards the central cavity such that the outer boundaries of the central cavity are designated by said 16 O atoms, which 16 O atoms are denoted the 16 inner O atoms in the context of the present invention. In case r is 1 or 2, preferably the one or two extra tungsten atoms occupy respectively one or two of the vacant sites in the cavity of the {X₈W₄₈O₁₈₄}′ unit as defined above.

In a preferred embodiment, r is 0.

In a preferred embodiment, all M⁰ in the metal cluster (A′_{n′})^{m′+}[M⁰ₛ(X₈W₄₈₊ᵣO₁₈₄₊₄ᵣ)]^{m′-} are the same; preferably wherein all M⁰ are the same and are selected from Pd⁰, Pt⁰, Rh⁰, and Ir⁰, more preferably Pd⁰, Pt⁰ and Rh⁰, most preferably Pd⁰ and Pt⁰, in particular Pd⁰. In the alternative, all M are selected from mixtures of Pd⁰ and Pt⁰.

In a preferred embodiment, the {X₈W₄₈₊ᵣO₁₈₄₊₄ᵣ}′ unit, in particular in the {X₈W₄₈O₁₈₄}′ unit, in the metal cluster (A′_{n′})^{m′+}[M⁰ₛ(X₈W₄₈₊ᵣO₁₈₄₊₄ᵣ)]^{m′-} has a central cavity and all M⁰ atoms are located in said central cavity.

In a preferred embodiment, the central cavity in the {X₈W₄₈₊ᵣO₁₈₄₊₄ᵣ}′ unit, in particular in the {X₈W₄₈O₁₈₄}′ unit, in the metal cluster (A′_{n′})^{m′+}[M⁰ₛ(X₈W₄₈₊ᵣO₁₈₄₊₄ᵣ)]^{m′-} has a diameter of 6 to 14 Å, more preferably 8 to 12 Å, in particular around 10 Å.

In a preferred embodiment, in the {X₈W₄₈₊ᵣO₁₈₄₊₄ᵣ}′ unit, in particular in the {X₈W₄₈O₁₈₄}′ unit, all of the 184+4r O have an oxidation state of −2, all of the 48+r W have an oxidation state of +6, +5 or +4 and all of the 8 X have an oxidation state of +5, in particular X is selected from the group consisting of P^{V} and As^{V}, preferably P^{V}. Preferably, in case r is 0, the {X₈W₄₈O₁₈₄}′ unit has a negative charge of −10 to −40. In case not all of the 48 W have an oxidation state of +6 in the {X₈W₄₈O₁₈₄}′ unit the W have an oxidation state of +5 or +4 may be oxidized to have an oxidation state of +6 upon air oxidation under standard conditions (273.15 K (0° C., 32° F.) and 10⁵ Pa (1 bar)). In case all of the 48 W have an oxidation state of +6 in the {X₈W₄₈O₁₈₄}′ unit, the {X₈W₄₈O₁₈₄}′ unit in the metal cluster (A′_{n′})^{m′+}[M⁰ₛ(X₈W₄₈O₁₈₄)]^{m′-} is identical to the preferred {X₈W₄₈O₁₈₄} unit in the POM (Aₙ)^{m+}[(MR′ₜ)ₛO_{y}H_{q}R_{z}(X₈W₄₈O₁₈₄)]^{m-}, wherein all of the 184 O have an oxidation state of −2, all of the 48 W have an oxidation state of +6 and all of the 8 X have an oxidation state of +5. In case not all of the 48 W have an oxidation state of +6 in the {X₈W₄₈O₁₈₄}′ unit, the {X₈W₄₈O₁₈₄}′ unit in the metal cluster (A′_{n′})^{m′+}[M⁰ₛ(X₈W₄₈O₁₈₄)]^{m′-} may be converted into the preferred {X₈W₄₈O₁₈₄} unit in the POM (Aₙ)^{m+}[(MR′ₜ)ₛO_{y}H_{q}R_{z}(X₈W₄₈O₁₈₄)]^{m-}, wherein all of the 184 O have an oxidation state of −2, all of the 48 W have an oxidation state of +6 and all of the 8 X have an oxidation state of +5, upon air oxidation under standard conditions (273.15 K (0° C., 32° F.) and 10⁵ Pa (1 bar)).

In the metal clusters of the present invention, the cation A′ can be a Group 1, 2, 3, 4, 5, 6, 7, 8, 9, 10, 11, 12, 13, 14, 15 and 16 metal cation or an organic cation. Preferably, each A′ is independently selected from the group consisting of cations of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof. More preferably, A′ is selected from lithium, potassium, sodium cations and combinations thereof.

The number n of cations is dependent on the nature of cation(s) A′, namely its/their valence, and the negative charge m′ of the polyanion which has to be balanced. In any case, the overall charge of all cations A′ is equal to the charge of the metal cluster unit anion [M⁰ₛ(X₈W₄₈₊₁O₁₈₄₊₄)]. In turn, the charge m of the metal cluster unit anion [M⁰ₛ(X₈W₄₈₊₁O₁₈₄₊₄)] is dependent on the nature and oxidation state of the W atoms, and the nature and oxidation state of the heteroatoms X. Thus, m depends on the oxidation state of the atoms present in the polyanion, e.g., it follows from the oxidation states of O (−2), X (preferably +5 for As^{V} or P^{V}), M⁰ (0) and W (normally +6, and +5 or +4 for some W atoms). In some embodiments, m′ ranges from 1 to 44, preferably 8 to 40, more preferably 12 to 40, most preferably 16 to 40, in particular 16, 32, 34, 36, or 40. In particular, m′ is 16, 18, 20, 22, 24, 26, 28, 30, 32, 34, 36, 38, 40, 42 or 44. In a preferred embodiment, m′ is 16, 28, 32, 34, 36 or 38. Thus, n′ can generally range from 1 to 40, preferably 8 to 40, more preferably 12 to 40, most preferably 16 to 40. In particular, n′ ranges from 6 to 40 and more particularly is 6, 9, 10, 12, 14, 16, 18, 20, 22, 24, 26, 28, 30, 32 or 40. In a preferred embodiment, n′ is 16, 28, 32, 34, 36 or 40.

Generally, A′ is acting as counterion of the metal cluster and is positioned outside of the metal cluster unit anion [M⁰ₛ(X₈W₄₈₊₁O₁₈₄₊₄)]. However, it is also possible that some of the cations A′ are located within the metal cluster unit anion [M⁰ₛ(X₈W₄₈₊₁O₁₈₄₊₄)]. In case the {X₈W₄₈₊₁O₁₈₄₊₄}′ unit has a central cavity, it is also possible that some of the cations A′ are located within the central cavity. Any cation A′ being located within the metal cluster unit anion [M⁰ₛ(X₈W₄₈₊₁O₁₈₄₊₄)] is not selected from the group of noble metals.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0 and X is P.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, X is P and s is 2 or 4.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, X is P and M is Pd.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, M is Pd, s is 4 and X is P.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, and M is Pt.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, M is Pt, s is 2 and X is P.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, and M is Ir.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, M is Ir, s is 2 and X is P.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, and M is Rh.

Thus, in a preferred embodiment, the invention relates to a metal cluster (A′_{n′})^{m′+}[M⁰ₛ(X₈W₄₈₊ᵣO₁₈₄₊₄ᵣ)]^{m′-}, wherein r is 0, and M is Rh, s is 4 and X is P.

Suitable examples of metal cluster (A′_{n′})^{m′+}[M⁰ₛ(X₈W₄₈₊ᵣO₁₈₄₊₄ᵣ)]^{m′-}, according to the invention are represented by the formulae

(A′_{n′})^{m′+}[M⁰ₛ(X₈W₄₈₊ᵣO₁₈₄₊₄ᵣ)]^{m′-}, e.g.,

(A′_{n′})^{m′+}[M⁰ₛ(P₈W₄₈O₁₈₄)]^{m′-}, such as

(A′_{n′})^{m′+}[Pd⁰ₛ(P₈W₄₈O₁₈₄)]^{m′-}, like

(A′_{n′})^{m′+}[Pd⁰₂(P₈W₄₈O₁₈₄)]^{m′-},

(A′_{n′})^{m′+}[Pd⁰₄(P₈W₄₈O₁₈₄)]^{m′-},

(A′_{n′})^{m′+}[Pd⁰₆(P₈W₄₈O₁₈₄)]^{m′-},

(A′_{n′})^{m′+}[Pd⁰₈(P₈W₄₈O₁₈₄)]^{m′-},

(A′_{n′})^{m′+}[Pt⁰ₛ(P₈W₄₈O₁₈₄)]^{m′-}, like

(A′_{n′})^{m′+}[Pt⁰₂(P₈W₄₈O₁₈₄)]^{m′-},

(A′_{n′})^{m′+}[Pt⁰₄(P₈W₄₈O₁₈₄)]^{m′-},

(A′_{n′})^{m′+}[Pt⁰₆(P₈W₄₈O₁₈₄)]^{m′-},

(A′_{n′})^{m′+}[Pt⁰₈(P₈W₄₈O₁₈₄)]^{m′-},

(A′_{n′})^{m′+}[Ir⁰ₛ(P₈W₄₈O₁₈₄)]^{m′-}, like

(A′_{n′})^{m′+}[Ir⁰₂(P₈W₄₈O₁₈₄)]^{m′-},

(A′_{n′})^{m′+}[Ir⁰₄(P₈W₄₈O₁₈₄)]^{m′-},

(A′_{n′})^{m′+}[Ir⁰₆(P₈W₄₈O₁₈₄)]^{m′-},

(A′_{n′})^{m′+}[Ir⁰₈(P₈W₄₈O₁₈₄)]^{m′-},

(A′_{n′})^{m′+}[Rh⁰ₛ(P₈W₄₈O₁₈₄)]^{m′-}, like

(A′_{n′})^{m′+}[Rh⁰₂(P₈W₄₈O₁₈₄)]^{m′-},

(A′_{n′})^{m′+}[Rh⁰₄(P₈W₄₈O₁₈₄)]^{m′-},

(A′_{n′})^{m′+}[Rh⁰₆(P₈W₄₈O₁₈₄)]^{m′-},

(A′_{n′})^{m′+}[Rh⁰₈(P₈W₄₈O₁₈₄)]^{m′-},

(A′_{n′})^{m′+}[M⁰ₛ(As₈W₄₈O₁₈₄)]^{m′-}, such as

(A′_{n′})^{m′+}[Pd⁰ₛ(As₈W₄₈O₁₈₄)]^{m′-},

(A′_{n′})^{m′+}[Pt⁰ₛ(As₈W₄₈O₁₈₄)]^{m′-},

(A′_{n′})^{m′+}[Ir⁰ₛ(As₈W₄₈O₁₈₄)]^{m′-},

(A′_{n′})^{m′+}[Rh⁰ₛ(As₈W₄₈O₁₈₄)]^{m′-},

(A′_{n′})⁴⁰⁺[M⁰ₛ(X₈W₄₈O₁₈₄)]⁴⁰⁻, such as

(A′_{n′})⁴⁰⁺[M⁰ₛ(P₈W₄₈O₁₈₄)]⁴⁰⁻,

(A′_{n′})⁴⁰⁺[Pd⁰ₛ(X₈W₄₈O₁₈₄)]⁴⁰⁻,

(A′_{n′})⁴⁰⁺[Pt⁰ₛ(X₈W₄₉O₁₈₄)]⁴⁰⁻,

(A′_{n′})⁴⁰⁺[Ir⁰ₛ(X₈W₄₈O₁₈₄)]⁴⁰⁻,

(A′_{n′})⁴⁰⁺[Rh⁰ₛ(X₈W₄₈O₁₈₄)]⁴⁰⁻,

(A′₄₀)⁴⁰⁺[M⁰ₛ(X₈W₄₈O₁₈₄)]⁴⁰⁻, like

(A′₄₀)⁴⁰⁺[Pd⁰ₛ(X₈W₄₈O₁₈₄)]⁴⁰⁻,

(A′₄₀)⁴⁰⁺[Pt⁰ₛ(X₈W₄₈O₁₈₄)]⁴⁰⁻,

(A′₄₀)⁴⁰⁺[Ir⁰ₛ(X₈W₄₈O₁₈₄)]⁴⁰⁻,

(A′₄₀)⁴⁰⁺[Rh⁰ₛ(X₈W₄₈O₁₈₄)]⁴⁰⁻,

(A′₂₀)⁴⁰⁺[M⁰ₛ(X₈W₄₈O₁₈₄)]⁴⁰⁻, like

(A′₂₀)⁴⁰⁺[Pd⁰ₛ(X₈W₄₈O₁₈₄)]⁴⁰⁻,

(A′₂₀)⁴⁰⁺[Pt⁰ₛ(X₈W₄₈O₁₈₄)]⁴⁰⁻,

(A′₂₀)⁴⁰⁺[Ir⁰ₛ(X₈W₄₈O₁₈₄)]⁴⁰⁻,

(A′₂₀)⁴⁰⁺[Rh⁰ₛ(X₈W₄₈O₁₈₄)]⁴⁰⁻,

(A′_{n′})³⁸⁺[M⁰ₛ(X₈W₄₈O₁₈₄)]³⁸⁻,

(A′_{n′})³⁶⁺[M⁰ₛ(X₈W₄₈O₁₈₄)]³⁶⁻,

(Li_{n′})^{m′+}[M⁰ₛ(X₈W₄₈O₁₈₄)]^{m′-},

(Na_{n′})^{m′+}[M⁰ₛ(X₈W₄₈O₁₈₄)]^{m′-},

(K_{n′})^{m′+}[M⁰ₛ(X₈W₄₈O₁₈₄)]^{m′-}.

The metal clusters of the present invention are in the form of primary and/or secondary particles. In an especially preferred embodiment, the metal clusters provided by the present invention are mainly in the form of primary particles (i.e., non-agglomerated primary particles), that is at least 90 wt % of the metal clusters are in the form of primary particles, preferably at least 95 wt %, more preferably at least 99 wt %, in particular substantially all the metal clusters are in the form of primary particles. This includes metal clusters dispersed in liquid carrier media. The metal clusters of the present invention preferably have a primary particle size of about 1.5-2.5 nm, for instance about 2.0 nm on average.

In the metal clusters of the present invention, the guest atoms M⁰ may theoretically be replaced or removed without destroying the structural framework of the {X₈W₄₈₊ᵣO₁₈₄₊₄ᵣ}′ unit. However, the present inventors observed that guest atoms M⁰ remain attached to the {X₈W₄₈₊ᵣO₁₈₄₊₄ᵣ}′ unit under a variety of conditions, e.g., in aqueous solution at pH values of 1 to 10, preferably 1 to 8, or in the solid state at temperatures up 500° C., preferably 400° C.

In a further embodiment, the metal clusters are dispersed in a liquid carrier medium, thereby forming a dispersion of metal clusters. In one embodiment of the present invention the liquid carrier medium is an organic solvent, optionally combined with one or more dispersing agents. The organic solvent is preferably capable of dissolving the POMs used as starting material for the preparation of the metal clusters, for instance liquid n-alkanes, e.g., hexane or heptane.

The dispersing agent (or surfactant) is added to the liquid carrier medium to prevent agglomeration of the primary particles of metal cluster. Preferably, the dispersing agent is present during formation of the primary particles of metal cluster. An example of a surfactant useful as dispersing agent is citric acid or citrate. The dispersing agent preferably forms micelles, each micelle containing one primary particle of metal cluster thereby separating the primary particles from each other and preventing agglomeration thereof.

In another further embodiment, the metal clusters can be immobilized on a solid support thereby forming supported metal clusters. Suitable supports include but are not limited to materials having a high surface area and/or a pore size which is sufficient to allow the metal clusters to be loaded, e.g., polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous materials, like mesoporous silica, such as SBA-15 and MCM-41, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof and modified compounds thereof. Preferred supports are, for instance, mesoporous silica, more preferably SBA-15 or MCM-41, most preferably SBA-15.

A variety of such solid supports is commercially available or can be prepared by common techniques. Furthermore, there are various common techniques to modify or functionalize solid supports, for example with regard to the size and shape of the surface or the atoms or groups available for bonding on the surface. In a preferred embodiment of the present invention the immobilization of the metal clusters to the surface of the solid support is accomplished by means of adsorption, including physisorption and chemisorption, preferably physisorption. The adsorption is based on interactions between the metal clusters and the surface of the solid support, such as van-der-Waals interactions.

In the supported metal clusters of the present invention, the metal clusters that are immobilized on the solid support are in the form of primary and/or secondary particles. In an especially preferred embodiment, the immobilized metal cluster particles are mainly in the form of primary particles (i.e., non-agglomerated primary particles), that is at least 90 wt % of the immobilized metal cluster particles are in the form of primary particles, preferably at least 95 wt %, more preferably at least 99 wt %, in particular substantially all the immobilized metal cluster particles are in the form of primary particles.

In the supported metal clusters of the present invention, the metal cluster loading levels on the solid support may be up to 30 wt % or even more, but are preferably up to 10 wt %, for instance up to 5 wt % or even up to 2 wt %. Accordingly, the metal cluster loading level on the solid support is typically of 0.01 to 30 wt %, particularly 0.05 to 20 wt %, more particularly 0.1 to 10 wt %, often 0.2-6 wt %, more often 0.3-5 wt %, and most often 0.5-2 wt %. Metal cluster loading levels on the solid support can be determined by elemental analysis such as Inductively Coupled Plasma Mass Spectrometry (ICP-MS) analysis, for instance using a Varian Vista MPX.

The invention is further directed to processes for preparing metal clusters according to the invention.

Among the preferred processes for preparing any one of the metal clusters of the present invention is a process for the preparation of a dispersion of said metal clusters dispersed in liquid carrier media. Said process comprises:
(a) dissolving any one of the POMs provided by the present invention or prepared according to the present invention in a liquid carrier medium,
(b) optionally providing additive means to prevent agglomeration of the metal clusters to be prepared, preferably adding compounds capable of preventing agglomeration of metal clusters to be prepared, more preferably adding surfactants to enable micelle formation, and
(c) subjecting the dissolved POM to chemical or electrochemical reducing conditions sufficient to at least partially reduce said POM into corresponding metal clusters.

In a preferred embodiment in step (a), the liquid carrier medium capable of dissolving the POM used for the preparation of the metal clusters is an organic solvent, such as liquid n-alkanes, e.g., hexane or heptane.

In a preferred embodiment in step (b), classical capping groups such as diverse types of inorganic and organic anions, such as carboxylates, e.g., citrate, may be used to prevent agglomeration of the metal clusters to be prepared.

In a preferred embodiment in step (c), the chemical reducing conditions comprise the use of a reducing agent selected from organic and inorganic materials which are oxidizable by Pd^{II} and Pd^{IV}, Pt^{II} and Pt^{IV}, Rh^{I} and Rh^{III}, Ir^{I} and Ir^{III}, Ag^{I} and Ag^{III} and Au^{I} and Au^{III}. Such a chemical reduction can for example be effected by using borohydrides, aluminohydrides, hydrazine, CO or hydrogen, preferably hydrogen, more preferably hydrogen at elevated temperature and pressure, preferably by using hydrogen. In the alternative, the POM in step (c) is reduced electrochemically using a common electrochemical cell.

The metal clusters of the present invention can be immobilized on the surface of a solid support. The present invention therefore also relates to processes for the preparation of supported metal clusters according to the present invention. A first process for the preparation of supported metal clusters comprises contacting the dispersion of metal clusters provided by the present invention or prepared according to the present invention with a solid support, thereby immobilizing at least part of the dispersed metal clusters onto the support; and optionally isolating the supported metal clusters.

In a preferred embodiment, the solid support is added to the dispersion of metal clusters. The resulting mixture is preferably stirred, typically for 1 min to 24 h, more preferably for 30 min to 15 h, more preferably for 1 h to 12 h, most preferably for 6 h to 10 h, in particular about 8 h. While stirring, preferably the mixture is heated to a temperature of from 20° C. to 100° C., preferably from 20° C. to 80° C., preferably from 20° C. to 60° C. preferably from 20° C. to 40° C., and most preferably about 25° C. Afterwards, the supported metal clusters are preferably isolated. Isolation of the supported metal clusters from the solvent may be performed by any suitable method in the art, such as by filtration, evaporation of the solvent, centrifugation or decantation, preferably by filtration or removal of the solvent in vacuum, more preferably by filtration. The isolated supported metal clusters may then be washed with a suitable solvent, preferably water or an aqueous solvent, and dried, for instance by heating under vacuum.

Another suitable process for the preparation of supported metal clusters according to the present invention comprises: subjecting supported POM provided by the present invention or prepared according to the present invention to chemical or electrochemical reducing conditions sufficient to at least partially reduce said POM into corresponding metal clusters; and optionally isolating the supported metal clusters.

In a preferred embodiment, the chemical reducing conditions comprise the use of a reducing agent selected from organic and inorganic materials which are oxidizable by Pd^{II} and Pd^{IV}, Pt^{II} and Pt^{IV}, Rh^{I} and Rh^{III}, Ir^{I} and Ir^{III}, Ag^{I} and Ag^{III}, and Au^{I} and Au^{III}. Such a chemical reduction can for example be effected by using borohydrides, aluminohydrides, hydrazine, CO or hydrogen, preferably hydrogen, more preferably hydrogen at elevated temperature and pressure. In the alternative, the POM is reduced electrochemically using a common electrochemical cell.

The invention is also directed to the use of optionally supported POMs provided by the present invention or prepared according to the present invention and/or optionally supported or dispersed metal clusters provided by the present invention or prepared according to the present invention, for catalyzing homogeneous and heterogeneous conversion of organic substrates.

In a preferred embodiment, conversion may refer to homogeneous or heterogeneous reduction and/or hydroprocessing and/or hydrocracking and/or (hydro)desulfurization and/or oxidation of organic substrate.

In a preferred embodiment the process for the homogeneous or heterogeneous conversion of organic substrate comprises contacting said organic substrate with the optionally supported POMs provided by the present invention or prepared according to the present invention and/or optionally supported or dispersed metal clusters provided by the present invention or prepared according to the present invention.

Since the M metal atoms are not fully sterically shielded by the polyanion framework, various noble metal coordination sites are easily accessible to the organic substrate and therefore high catalytic activities are achieved. Further, the thermal stability of the optionally supported POMs of the present invention permits their use under a variety of reaction conditions.

It is contemplated that the optionally supported POMs of the present invention can be activated by any process described herein or any process known in the art, preferably by increasing the accessibility to their noble metal atoms M. Thus, it might be possible that the optionally supported POMs are reductively converted into metal cluster-like structures or even into metal clusters under the conversion reaction conditions and it might be possible that said metal cluster-like structures or said metal clusters are in fact the catalytically active species. Nevertheless, the optionally supported POMs of the present invention give excellent results in homogeneous and heterogeneous conversion of organic substrates, regardless of the specific nature of the actually catalytically active species.

Another useful aspect of this invention is that the optionally supported POMs and optionally supported or dispersed metal clusters of the present invention can be recycled and used multiple times for the conversion of organic molecules, i.e., without significant loss of the expensive noble metals. While the inventors do not wish to be bound by any particular theory, it is believed that the {X₈W₄₈O₁₈₄} unit and the {X₈W₄₈O₁₈₄}′ unit forms a highly stable and robust shell unit, which accommodates and, thus, protects the noble metal species. The present inventors believe that the {X₈W₄₈₊ᵣO₁₈₄₊₄ᵣ} unit, in particular the {X₈W₄₈O₁₈₄}, unit and the {X₈W₄₈₊ᵣO₁₈₄₊₄ᵣ}′ unit, in particular the {X₈W₄₈O₁₈₄}′ unit, provide a fine balance between shielding the expensive noble metal species in the regeneration step without preventing sufficient access for the substrates to the catalytically active noble metals in the catalytic process step, i.e., the {X₈W₄₈₊ᵣO₁₈₄₊₄ᵣ} unit, in particular the {X₈W₄₈O₁₈₄}, unit and the {X₈W₄₈₊ᵣO₁₈₄₊₄ᵣ} unit, in particular the {X₈W₄₈O₁₈₄}′ unit, provide sufficient shielding for the noble metal species to prevent sintering in the regeneration step but not so much shielding that the noble metal species would be deprived of the catalytic activity. The underlying considerations set forth in more detail hereinabove in the context of the optionally supported POMs apply equally to the optionally supported or dispersed metal clusters of the present invention.

In a preferred embodiment this invention thus also relates to a process for converting organic substrates comprising the steps:
(a) contacting a first organic substrate with one or more optionally supported POMs and/or one or more supported metal clusters,
(b) recovering the one or more optionally supported POMs and/or one or more supported metal clusters;
(c) contacting the one or more optionally supported POMs and/or one or more supported metal clusters with a solvent at a temperature of 50° C. or more, and/or hydrogen stripping the one or more optionally supported POMs and/or the one or more supported metal clusters at elevated temperature, and/or calcining the one or more optionally supported POMs and/or the one or more supported metal clusters at elevated temperature under an oxygen containing gas, e.g. air, or under an inert gas, e.g. nitrogen or argon, to obtain a recycled one or more optionally supported POMs and/or one or more supported metal clusters;
(d) contacting the recycled one or more optionally supported POMs and/or one or more supported metal clusters with a second organic substrate which may be the same as or different from the first organic substrate; and
(e) optionally repeating steps (b) to (d).

The contacting of organic substrate with optionally supported POM and/or supported metal cluster in step (a) may, e.g., be carried out in a continuously stirred tank reactor (CSTR), a fixed bed reactor, a fluidized bed reactor or a moving bed reactor.

Thus, e.g., the optionally supported POMs and/or supported metal clusters of the present invention can be collected after a conversion reaction, washed with a polar or non-polar solvent such as acetone and then dried under heat (typically 50° C. or more, alternately 75° C. or more, alternately 100° C. or more, alternately 125° C. or more) for 30 minutes to 48 hours, typically for 1 to 24 hours, more typically for 2 to 10 hours, more typically for 3 to 5 hours.

Alternatively to or in addition to the washing, the optionally supported POMs and/or supported metal clusters may be subjected to hydrogen stripping at elevated temperature. Preferably, the hydrogen stripping is carried out at a temperature of 50° C. or higher, more preferably at a temperature of 75° C. or higher and most preferably at a temperature of 100° C. or higher.

Alternatively to or in addition to the washing and/or hydrogen stripping, the optionally supported POMs and/or supported metal clusters may be calcined at elevated temperature under an oxygen containing gas, e.g., air, or under an inert gas, e.g., nitrogen or argon. Preferably, the calcination is carried out at a temperature in the range from 75° C. to 150° C., such as from 90° C. to 120° C. or from 120° C. to 150° C.

The washing and/or hydrogen stripping and/or calcining has/have the effect of regenerating the optionally supported POMs and/or supported metal clusters for recycling.

The recycled optionally supported POMs and/or supported metal clusters of the present invention may be used on fresh organic molecules, or on recycled organic molecules from a recycle stream.

It is preferred to use supported POMs and/or supported metal clusters of the present invention as catalysts with regard to recovery and recycling of the catalyst in the conversion processes described herein. Advantageously, the supported POMs and/or supported metal clusters of the present invention may be recycled and used again under the same or different reaction conditions. Typically the supported POMs and/or supported metal clusters are recycled at least 1 time, preferably at least 4 times, preferably at least 8 times, preferably at least 12 times, preferably at least 100 times.

Thus, this invention also relates to a process for converting organic substrates which process comprises contacting a first organic substrate with one or more supported POMs and/or supported metal clusters of the present invention, thereafter recovering the supported POMs and/or supported metal clusters of the present invention, contacting the supported POMs and/or supported metal clusters of the present invention with a solvent (such as acetone) at a temperature of 50° C. or more, and/or hydrogen stripping the supported POMs and/or supported metal clusters at elevated temperature, and/or calcining the supported POMs and/or supported metal clusters to obtain recycled supported POMs and/or supported metal clusters of the present invention, thereafter contacting the recycled supported POMs and/or supported metal clusters of the present invention with a second organic substrate, which may be the same as or different from the first organic substrate, this process may be repeated many times, preferably at least 4 times, preferably at least 8 times, preferably at least 12 times, preferably at least 100 times.

Due to the definite stoichiometry of POMs, the optionally supported POMs of the present invention can also be used as a precursor for mixed metal-oxide catalysts.

Metal clusters of the present invention, optionally supported or dispersed in a liquid carrier medium, can be described as nanocatalysts of M at the atomic or molecular level, i.e., particles of M having an average diameter of about 1.5-2.5 nm, for instance about 2.0 nm, obtained by reduction of the POMs. In the case of the preferred embodiment, wherein all M are the same, nanocatalysts with at least one noble atom species are obtained. In another embodiment in which at least one or more M are different among each other, nanocatalysts with more than one noble atom species, such as 2 to 6 noble atom species, preferably 2, 3 or 4, more preferably 2 or 3, most preferably 2, are obtained. Thus, the bottom-up approach of the present invention allows for the preparation of noble metal-rich customized nanocatalysts of very well defined size and shape, in which two or more than two metal species can be selected individually from groups that contain or consist of the noble metal elements Rh, Ir, Pd, Pt, Ag, and Au.

The obtained metal clusters can be used for a wide range of catalytic applications such as in fuel cells, for detection of organic substrates, selective hydrogenation, reforming, hydrocracking, hydrogenolysis and oligomerization. Besides immobilizing the present POMs on a matrix surface and subsequently reducing them, the deposition of the POMs on a surface matrix and their reduction can also be carried out simultaneously.

In addition, e.g., the POMs according to the invention can be used to produce modified electrodes by electrochemical deposition of the POM on an electrode surface such as a glassy carbon (GC) electrode surface. The obtained deposits contain predominantly M⁰ such as Rh⁰, Ir⁰, Pd⁰, Pt⁰, Ag⁰, Au⁰, and preferably mixtures thereof with very small amounts Mχ⁺ such as Pd^{II} and Pd^{IV}, Pt^{II} and Pt^{IV}, Rh^{I} and Rh^{III}, Ir^{I} and Ir^{III}, Ag^{I} and Ag^{III} and Au^{I} and Au^{III} and mixtures thereof, preferably Pd^{II}, Pt^{II}, Rh^{I}, Ir^{I}, Ag^{I}, and Au^{I}. In a preferred embodiment, the obtained deposits provide improved electrochemical behaviors like improved kinetics of electrocatalytic processes compared to a film deposited using a conventional precursor of M. For example, electrodes modified with a deposit of the present POMs can be used for the electrochemical reduction of organic substrates. It has been found that such modified electrodes show a very small overpotential and a remarkably high shelf life.

### EXAMPLES

The invention is further illustrated by the following examples.

### Example 1a

### Synthesis of K₂₀Li₈[Rh₄P₈W₄₈O₁₈₄].86H₂O

RhCl₃ (0.02 g, 0.063 mmol) and K₂₈Li₅H₇P₈W₄₈O₁₈₄.92H₂O (0.1 g, 0.0068 mmol (for preparation see, e.g., Inorg. Chem. 1985, 24, 4610-4614; Inorg. Synth. 1990, 27, 110)) were dissolved in a mixture of 1 M lithium acetate solution (5 mL, pH 7.0) and 0.5 ml ethanol. While stirring, 200 μl of a 1 M lithium perchlorate solution were added. The solution was heated in a water bath to 80° C. for 60 min during which the solution turned dark green; without wishing to be bound by any theory the observed colour change could be due to the in situ formation of Rhodium (II) acetate dimer. Finally, 0.5 ml of 30% H₂O₂ were added dropwise and the solution was stirred for an additional 60 min at 80° C. The final orange-yellow solution was allowed to cool to room temperature and left for crystallization in an open vial. Orange octahedral crystals started to form after approximately 2 to 3 days, which were collected by filtration and air-dried after one week. Yield: 0.04 g (40% based on W). This product was analyzed by XRD, IR, elemental analysis, TGA and ³¹P NMR and was identified as {Rh₄[P₈W₄₈O₁₈₄]}²⁸⁻ polyanion (“Rh₄P₈W₄₈”), isolated as hydrated salt K₂₀Li₈[Rh₄P₈W₄₈O₁₈₄].86H₂O (“K₂₀Li₈—Rh₄P₈W₄₈”). The product was found to be identical to the product of the below experiment 1b.

### Example 1b

### Synthesis of K₂₀Li₈[Rh₄P₈W₄₈O₁₈₄].86H₂O

RhCl₃ (0.02 g, 0.063 mmol) was dissolved in 0.5 ml H₂O. The initial pH of this solution was around 1.5 and was adjusted to 13.2 with 150 μl of 6 m NaOH solution. (Solution A). K₂₈Li₅H₇P₈W₄₈O₁₈₄.92H₂O (0.1 g, 0.0068 mmol (for preparation see, e.g., Inorg. Chem. 1985, 24, 4610-4614; Inorg. Synth. 1990, 27, 110)) was dissolved in a mixture of 1 M lithium acetate solution (5 mL, pH 4.0) and 200 μl of a 1 M lithium perchlorate solution (Solution B). The solutions A and B were then mixed and heated in a water bath at 80° C. for 60 min. The final orange solution was allowed to cool to room temperature and left for crystallization in an open vial. Orange octahedral crystals started to form after approximately 2 to 3 days, which were collected by filtration and air-dried after one week. Yield: 0.037 g (37% based on W). This product was analyzed by XRD, IR, elemental analysis, TGA and ³¹P NMR and was identified as {Rh₄[P₈W₄₈O₁₈₄]}²⁸⁻ polyanion (“Rh₄P₈W₄₈”), isolated as hydrated salt K₂₀Li₈[Rh₄P₈W₄₈O₁₈₄].86H₂O (“K₂₀Li₈—Rh₄P₈W₄₈”). The product was found to be identical to the product of the above experiment 1a.

### Example 2

### Analysis of “K₂₀Li₈—Rh₄P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm⁻¹ due to metal-oxygen stretching and bending vibrations: 1636 (s), 1618 (s), 1384 (w), 1138 (s), 1087(s), 1019 (m), 931 (s), 920 (s), 810 (s), 686 (s), 573 (w), 528 (w), 464 (w). The FT-IR spectrum is shown in FIG. 1. Absorption bands between 1138 and 920 cm⁻¹ are attributed to the phosphate heterogroups. The absorption band near 1636 cm⁻¹ belongs to asymmetric vibrations of the crystal waters.

Elemental analysis for “K₂₀Li₈—Rh₄P₈W₄₈” calculated (found): K 5.25(5.1), Li 0.37(0.41), Rh 2.77(2.46), P 1.67(1.68), W 59.4(58.64).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 3). Only one weight-loss step was observed on the thermogram below 800° C. This result is in good agreement with that obtained by elemental analysis to determine the amount of water of crystallization present in the POM.

### Example 3

### Single Crystal X-Ray Diffraction (XRD) Data and Analysis of “K₂₀Li₈—Rh₄P₈W₄₈”

Besides IR, elemental analysis and TGA the product was also characterized by single-crystal XRD. The crystal was mounted in Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all lithium and potassium counter cations by XRD, due to crystallographic disorder. The exact number of counter cations and crystal water in the POM were thus based on elemental analysis and TGA. Compound “K₂₀Li₈—Rh₄P₈W₄₈” crystallizes in the tetragonal space group I4/m. Crystallographic data are detailed in Table 1.

TABLE 1
Crystal data for “K₂₀Li₈-Rh₄P₈W₄₈”

| | |
|---|---|
| Empirical formula | K₂₀Li₈Rh₄P₈W₄₈O₁₈₄•86H₂O |
| Formula weight, g/mol | 14814 |
| Crystal system | Tetragonal |
| Space group | I4/m |
| a, Å | 25.6138 (9) |
| b, Å | 25.6138 (9) |
| c, Å | 21.6978 (8) |
| α, ° | 90 |
| β, ° | 90 |
| γ, ° | 90 |
| Volume, Å³ | 14235.2 (11) |
| Z | 4 |
| D_{calc}, g/cm³ | 3.077 |
| Absorption coefficient, mm⁻¹ | 19.773 |
| F (000) | 11400.0 |
| Theta range for data collection, ° | 1.124 to 25.999 |
| Completeness to Θₘₐₓ % | 99.9% |
| Index ranges | −28 <= h <= 31, |
| | −31 <= k <= 31, |
| | −26 <= l <= 26 |
| Reflections collected | 58225 |
| Independent reflections | 7189 |
| R (int) | 0.1081 |
| Absorption correction | Semi-empirical |
| | from equivalents |
| Data/restraints/parameters | 8182/0/194 |
| Goodness-of-fit on F² | 1.015 |
| R₁^{[a]}, wR₂^{[b]} (I > 2σ(I)) | R₁ = 0.0567, |
| | wR₂ = 0.1880 |
| R₁^{[a]}, wR₂^{[b]} (all data) | R₁ = 0.0922, |
| | wR₂ = 0.2308 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 4

### Structure of the “Rh₄P₈W₄₈” Polyanion

The structure of the “Rh₄P₈W₄₈” polyanion is displayed in FIG. 4. The four rhodium atoms are encapsulated in the cavity formed by the wheel-shaped {P₈W₄₈O₁₈₄} unit.

### Example 5

### ³¹P NMR Spectrum of “K₂₀Li₈—Rh₄P₈W₄₈”

“K₂₀Li₈—Rh₄P₈W₄₈” crystals were dissolved in D₂O. ³¹P NMR spectrum was recorded at 20° C. on a 400 MHz JEOL ECX instrument, using 5 mm tube with resonance frequency 161.6 MHz. The chemical shift is reported with respect to the reference 85 wt % H₃PO₄. The ³¹P NMR spectrum is shown in FIG. 2. “K₂₀Li₈—Rh₄P₈W₄₈” shows a single peak at −6.36 ppm.

### Example 6

### Synthesis of K₂₀Li₅H₇[Pd₄P₈W₄₈O₁₈₄].81H₂O

Pd(CH₃COO)₂ (0.013 g, 0.057 mmol) and K₂₈Li₅H₇P₈W₄₈O₁₈₄.92H₂O (0.050 g, 0.0034 mmol (for preparation see, e.g., Inorg. Chem. 1985, 24, 4610-4614; Inorg. Synth. 1990, 27, 110)) were dissolved in 1 M lithium acetate solution (5 mL, pH 3.0). While stirring, 100 μl of a 1 M lithium perchlorate solution were added and the solution was heated in a water bath to 70° C. for 60 min. Then the solution was allowed to cool to room temperature, filtered, and the filtrate left for crystallization in an open vial. Yellow octahedral crystals were obtained after approximately 3 weeks, which were collected by filtration and air-dried. Yield: 0.03 g (60% based on W). This product was analyzed by XRD, IR, elemental analysis, TGA and ³¹P NMR and was identified as {Pd₄[P₈W₄₈O₁₈₄]}³²⁻ polyanion (“Pd₄P₈W₄₈”), isolated as hydrated salt K₂₀Li₅H₇[Pd₄P₈W₄₈O₁₈₄].81H₂O (“K₂₀Li₅H₇—Pd₄P₈W₄₈”).

### Example 7

### Analysis of “K₂₀Li₅H₇—Pd₄P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm-1 due to metal-oxygen stretching and bending vibrations: 1635 (s), 1618 (s), 1539 (w), 1418 (w), 1384 (w), 1137 (s), 1084(s), 1016 (m), 928 (s), 809 (s), 691 (s), 574 (w), 529 (w), 461 (w). The FT-IR spectrum is shown in FIG. 5. Absorption bands between 1137 and 928 cm⁻¹ are attributed to the phosphate heterogroups. The absorption band near 1635 cm⁻¹ belongs to asymmetric vibrations of the crystal waters.

Elemental analysis for “K₂₀Li₅H₇—Pd₄P₈W₄₈” calculated (found): K 4.52(4.4), Li 0.43(0.42), Pd 2.90(2.82), P 1.7(1.75), W 60.52(61.05).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 7). Only one weight-loss step was observed on the thermogram below 800° C. This result is in good agreement with that obtained by elemental analysis to determine the amount of water of crystallization present in the POM.

### Example 8

### Single Crystal X-Ray Diffraction (XRD) Data and Analysis of “K₂₀Li₅H₇—Pd₄P₈W₄₈”

Besides IR, elemental analysis and TGA the product was also characterized by single-crystal XRD. The crystal was mounted in Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all lithium and potassium counter cations by XRD, due to crystallographic disorder. The exact number of counter cations and crystal water in the POM were thus based on elemental analysis and TGA. Compound “K₂₀Li₅H₇—Pd₄P₈W₄₈” crystallizes in the tetragonal space group Immm. Crystallographic data are detailed in Table 2.

TABLE 2
Crystal data for “K₂₀Li₅H₇-Pd₄P₈W₄₈”

| | |
|---|---|
| Empirical formula | K₂₀Li₅H₇Pd₄P₈W₄₈O₁₈₄•81H₂O |
| Formula weight, g/mol | 13198 (anhydrous); 14656 (hydrate) |
| Crystal system | Tetragonal |
| Space group | Immm |
| a, Å | 16.2553 (6) |
| b, Å | 25.7909 (8) |
| c, Å | 37.1090 (12) |
| α, ° | 90 |
| β, ° | 90 |
| γ, ° | 90 |
| Volume, Å³ | 15557.5 (9) |
| Z | 2 |
| D_{calc}, g/cm³ | 2.958 |
| Absorption coefficient, mm⁻¹ | 18.491 |
| F (000) | 11992.0 |
| Theta range for data collection, ° | 1.481 to 25.996 |
| Completeness to Θₘₐₓ % | 99.3% |
| Index ranges | −20 <= h <= 20, |
| | −31 <= k <= 29, |
| | −45 <= l <= 45 |
| Reflections collected | 53073 |
| Independent reflections | 8182 |
| R (int) | 0.0875 |
| Absorption correction | Semi-empirical |
| | from equivalents |
| Data/restraints/parameters | 8182/0/228 |
| Goodness-of-fit on F² | 1.211 |
| R₁^{[a]}, wR₂^{[b]} (I > 2σ(I)) | R₁ = 0.0841, |
| | wR₂ = 0.2432 |
| R₁^{[a]}, wR₂^{[b]} (all data) | R₁ = 0.1148, |
| | wR₂ = 0.2621 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 9

### Structure of the “Pd₄P₈W₄₈” Polyanion

The structure of the “Pd₄P₈W₄₈” polyanion is displayed in FIG. 8. The four palladium atoms are encapsulated in the cavity formed by the wheel-shaped {P₈W₄₈O₁₈₄} unit.

### Example 10

### ³¹P NMR Spectrum of “K₂₀Li₅H₇—Pd₄P₈W₄₈”

“K₂₀Li₅H₇—Pd₄P₈W₄₈” crystals were dissolved in D₂O. ³¹P NMR spectrum was recorded at 20° C. on a 400 MHz JEOL ECX instrument, using 5 mm tube with resonance frequency 161.6 MHz. The chemical shift is reported with respect to the reference 85 wt % H₃PO₄. The ³¹P NMR spectrum is shown in FIG. 6. “K₂₀Li₅H₇—Pd₄P₈W₄₈” shows multiple peaks between −6 and −8 ppm due to the disorder, where the four palladium atoms are disordered over 8 positions. As a result, the overall symmetry of the molecule is annihilated resulting in multiple peaks in the ³¹P NMR.

### Example 11

### Synthesis of K₂₂Li₁₀H₂[Ir₂P₈W₄₈O₁₈₄].129H₂O

IrCl₃ (0.032 g, 0.079 mmol) and K₂₈Li₅H₇P₈W₄₈O₁₈₄.92H₂O (0.1 g, 0.0068 mmol (for preparation see, e. g. , Inorg. Chem. 1985, 24, 4610-4614; Inorg. Synth. 1990, 27, 110)) were dissolved in a mixture of 1 M lithium acetate solution (5 mL, pH 3.0), 200 μl of a 1 M lithium perchlorate solution and 25 μl propylene oxide. The solution was heated in a water bath to 80° C. for 30 min, then 0.5 ml of 30% H₂O₂ were added dropwise and the solution was stirred for an additional 30 min at 80° C. The final brown solution was allowed to cool to room temperature and left for crystallization in an open vial. Brown octahedral crystals formed after approximately 2 to 3 days, which were collected by filtration and air-dried after one week. Yield: 0.03 g (30% based on W). This product was analyzed by XRD, IR, elemental analysis, TGA and ³¹P NMR and was identified as {Ir₂[P₈W₄₈O₁₈₄]}³⁴⁻ polyanion (“Ir₂P₈W₄₈”), isolated as hydrated salt K₂₂Li₁₀H₂[Ir₂P₈W₄₈O₁₈₄].129H₂O (“K₂₂Li₁₀H₂—Ir₂P₈W₄₈”).

### Example 12

### Analysis of “K₂₂Li₁₀H₂—Ir₂P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm-1 due to metal-oxygen stretching and bending vibrations: 1623 (s), 1384 (w), 1140 (s), 1088 (s), 1021 (m), 982(s), 932 (s), 919 (s), 814 (s), 693 (s), 572 (w), 528 (w), 464 (w). The FT-IR spectrum is shown in FIG. 9. Absorption bands between 1140 and 919 cm⁻¹ are attributed to the phosphate heterogroups. The absorption band near 1623 cm⁻¹ belongs to asymmetric vibrations of the crystal waters.

Elemental analysis for “K₂₂Li₁₀H₂—Ir₂P₈W₄₈” calculated (found): K 5.67(5.67), Li 0.46(0.44), Ir 2.50(1.94), P 1.64(1.71), W 58.29(59.92).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 11).

### Example 13

### Single Crystal X-Ray Diffraction (XRD) Data and Analysis of “K₂₂Li₁₀H₂—Ir₂P₈W₄₈”

Besides IR, elemental analysis and TGA the product was also characterized by single-crystal XRD. The crystal was mounted in Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all lithium and potassium counter cations by XRD, due to crystallographic disorder. The exact number of counter cations and crystal water in the POM were thus based on elemental analysis and TGA. Compound “K₂₂Li₁₀H₂—Ir₂P₈W₄₈” crystallizes in the tetragonal space group I4/m. Crystallographic data are detailed in Table 3.

TABLE 3
Crystal data for “K₂₂Li₁₀H₂-Ir₂P₈W₄₈”

| | |
|---|---|
| Empirical formula | K₂₂Li₁₀H₂[Ir₂P₈W₄₈O₁₈₄]•129H₂O |
| Formula weight, g/mol | 15656 |
| Crystal system | Tetragonal |
| Space group | I4/m |
| a, Å | 25.298 (2) |
| b, Å | 25.298 (2) |
| c, Å | 21.6394 (16) |
| α, ° | 90 |
| β, ° | 90 |
| γ, ° | 90 |
| Volume, Å³ | 13849 (2) |
| Z | 4 |
| D_{calc}, g/cm³ | 3.148 |
| Absorption coefficient, mm⁻¹ | 21.104 |
| F (000) | 11308.0 |
| Theta range for data collection, ° | 1.138 to 26.496 |
| Completeness to Θₘₐₓ % | 99.6% |
| Index ranges | −31 <= h <= 31, |
| | −31 <= k <= 31, |
| | −22 <= l <= 27 |
| Reflections collected | 179129 |
| Independent reflections | 7352 |
| R (int) | 0.1167 |
| Absorption correction | Semi-empirical |
| | from equivalents |
| Data/restraints/parameters | 7352/0/332 |
| Goodness-of-fit on F² | 1.054 |
| R₁^{[a]}, wR₂^{[b]} (I > 2σ(I)) | R₁ = 0.0696, |
| | wR₂ = 0.2158 |
| R₁^{[a]}, wR₂^{[b]} (all data) | R₁ = 0.1189, |
| | wR₂ = 0.2808 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 14

### Structure of the “Ir₂P₈W₄₈” Polyanion

The structure of the “Ir₂P₈W₄₈” polyanion is displayed in FIG. 12. The two iridium atoms are encapsulated in the cavity formed by the wheel-shaped {P₈W₄₈O₁₈₄} unit.

### Example 15

### ³¹P NMR Spectrum of “K₂₂Li₁₀H₂—Ir₂P₈W₄₈”

“K₂₂Li₁₀H₂—Ir₂P₈W₄₈” crystals were dissolved in D₂O. ³¹P NMR spectrum was recorded at 20° C. on a 400 MHz JEOL ECX instrument, using 5 mm tube with resonance frequency 161.6 MHz. The chemical shift is reported with respect to the reference 85 wt % H₃PO₄. The ³¹P NMR spectrum is shown in FIG. 10. “K₂₂Li₁₀H₂—Ir₂P₈W₄₈” shows multiple peaks between −6 and −7 ppm due to the disorder, where the two iridium atoms are disordered over 8 positions. As a result, the overall symmetry of the molecule is annihilated resulting in multiple peaks in the ³¹P NMR.

### Example 16

### Synthesis of K₂₉Li₂H₅[Pt₂P₈W₄₈O₁₈₄].91H₂O

K₂PtCl₄ (0.028 g, 0.067 mmol) and K₂₈Li₅H₇P₈W₄₈O₁₈₄.92H₂O (0.05 g, 0.0034 mmol (for preparation see, e.g., Inorg. Chem. 1985, 24, 4610-4614; Inorg. Synth. 1990, 27, 110)) was dissolved in a mixture of 1 M lithium acetate solution (5 mL, pH 3.0) and 500 μl of a 1 M lithium perchlorate solution. The solution was then heated in a water bath at 80° C. for 60 min. The final orange solution was allowed to cool to room temperature and left for crystallization in an open vial. Orange octahedral crystals started to form after approximately 2 to 3 days, which were collected by filtration and air-dried after two weeks. Yield: 0.027 g (55% based on W). This product was analyzed by XRD, IR, elemental analysis, TGA and ³¹P NMR and was identified as {Pt₂[P₈W₄₈O₁₈₄]}³⁶⁻ polyanion (“Pt₂P₈W₄₈”), isolated as hydrated salt K₂₉Li₂H₅[Pt₂P₈W₄₈O₁₈₄].91H₂O (“K₂₉Li₂H₅—Pt₂P₈W₄₈”).

### Example 17

### Analysis of “K₂₉Li₂H₅—Pt₂P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm-1 due to metal—oxygen stretching and bending vibrations: 1627 (s), 1140 (s), 1087(s), 1018 (m), 979 (w), 933 (s), 918 (s), 819 (s), 693 (s), 574 (w), 533 (w), 461 (w). The FT-IR spectrum is shown in FIG. 13. Absorption bands between 1140 and 918 cm⁻¹ are attributed to the phosphate heterogroups. The absorption band near 1627 cm⁻¹ belongs to asymmetric vibrations of the crystal waters.

Elemental analysis for “K₂₉Li₂H₅—Pt₂P₈W₄₈” calculated (found): K 7.4 (7.1), Li 0.09 (0.7), Pt 2.56 (1.86), P 1.77 (1.63), W 58.2 (59.2).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 15). Only one weight-loss step was observed on the thermogram below 800° C. This result is in good agreement with that obtained by elemental analysis to determine the amount of water of crystallization present in the POM.

### Example 18

### Single Crystal X-Ray Diffraction (XRD) Data and Analysis of “K₂₉Li₂H₅—Pt₂P₈W₄₈”

Besides IR, elemental analysis and TGA the product was also characterized by single-crystal XRD. The crystal was mounted in Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all lithium and potassium counter cations by XRD, due to crystallographic disorder. The exact number of counter cations and crystal water in the POM were thus based on elemental analysis and TGA. Compound “K₂₉Li₂H₅—Pt₂P₈W₄₈” crystallizes in the tetragonal space group I4/m. Crystallographic data are detailed in Table 4.

TABLE 4
Crystal data for “K₂₉Li₂H₅-Pt₂P₈W₄₈”

| | |
|---|---|
| Empirical formula | K₂₉Li₂H₅[Pt₂P₈W₄₈O₁₈₄]•91H₂O |
| Formula weight, g/mol | 15192 |
| Crystal system | Tetragonal |
| Space group | I4/m |
| a, Å | 25.488 (2) |
| b, Å | 25.488 (2) |
| c, Å | 21.7089 (16) |
| α, ° | 90 |
| β, ° | 90 |
| γ, ° | 90 |
| Volume, Å³ | 14103 (2) |
| Z | 4 |
| D_{calc}, g/cm³ | 3.407 |
| Absorption coefficient, mm⁻¹ | 20.921 |
| F (000) | 12640.0 |
| Theta range for data collection, ° | 1.130 to 25.995 |
| Completeness to Θₘₐₓ % | 99.8% |
| Index ranges | −31 <= h <= 31, |
| | −31 <= k <= 24, |
| | −26 <= l <= 26 |
| Reflections collected | 42847 |
| Independent reflections | 7125 |
| R (int) | 0.0594 |
| Absorption correction | Semi-empirical |
| | from equivalents |
| Data/restraints/parameters | 7125/0/223 |
| Goodness-of-fit on F² | 1.134 |
| R₁^{[a]}, wR₂^{[b]} (I > 2σ(I)) | R₁ = 0.0506, |
| | wR₂ = 0.1617 |
| R₁^{[a]}, wR₂^{[b]} (all data) | R₁ = 0.0747, |
| | wR₂ = 0.1960 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 19

### Structure of the “Pt₂P₈W₄₈” Polyanion

The structure of the “Pt₂P₈W₄₈” polyanion is displayed in FIG. 16. The two platinum atoms are encapsulated in the cavity formed by the wheel-shaped {P₈W₄₈O₁₈₄} unit.

### Example 20

### ³¹P NMR Spectrum of “K₂₉Li₂H₅—Pt₂P₈W₄₈”

“K₂₉Li₂H₅—Pt₂P₈W₄₈” crystals were dissolved in D₂O. ³¹P NMR spectrum was recorded at 20° C. on a 400 MHz JEOL ECX instrument, using 5 mm tube with resonance frequency 161.6 MHz. The chemical shift is reported with respect to the reference 85 wt % H₃PO₄. The ³¹P NMR spectrum is shown in FIG. 14. “K₂₂Li₁₀H₂—Ir₂P₈W₄₈” shows multiple peaks between −6 and −7 ppm due to the disorder, where the two platinum atoms are disordered over 8 positions. As a result, the overall symmetry of the molecule is annihilated resulting in multiple peaks in the ³¹P NMR.

### Example 21

### Synthesis of Supported POMs (“K₂₀Li₈—Rh₄P₈W₄₈”, “K₂₀Li₅H₇—Pd₄P₈W₄₈”, “K₂₂Li₁₀H₂—Ir₂P₈W₄₈” and “K₂₉Li₂H₅—Pt₂P₈W₄₈”)

### Synthesis of Mesoporous Silica Support SBA-15

8.0 g of Pluronic® P-123 gel (Sigma-Aldrich) were added to 40 mL of 2 M HCl and 208 mL H₂O. This mixture was stirred for 2 hours in a water bath at 35° C. until it was completely dissolved. Then 18 mL of tetraethylorthosilicate (TEOS) was added dropwise, and the mixture was kept under stirring for 4 hours. Afterwards, the mixture was heated in an oven at 95° C. for 3 days. The white precipitate was collected by filtration, washed and air-dried. Finally, the product was calcined by heating the as-synthesized material to 550° C. at a rate of 1-2° C./min and kept at 550° C. for 6 hours to remove the templates.

Synthesis of Modified SBA-15-apts

1.61 mL of 3-aminopropyltriethoxysilane (apts) was added to 3 g of SBA-15, prepared according to the synthesis described above, in 90 mL toluene. This mixture was refluxed for 5 hours and then filtered at room temperature. The obtained modified SBA-15-apts was heated at 100° C. for 5 hours.

Preparation of POMs Supported on SBA-15-apts (“Supported POMs”, i.e., Supported “K₂₀Li₈—Rh₄P₈W₄₈”, Supported “K₂₀Li₅H₇—Pd₄P₈W₄₈”, Supported “K₂₂Li₁₀H₂—Ir₂P₈W₄₈” and Supported “K₂₉Li₂H₅—Pt₂P₈W₄₈”)

The respective POM (“K₂₀Li₈—Rh₄P₈W₄₈”, “K₂₀Li₅H₇—Pd₄P₈W₄₈”, “K₂₂Li₁₀H₂—Ir₂P₈W₄₈” or “K₂₉Li₂H₅—Pt₂P₈W₄₈”) was dissolved in water (0.056 mmol/L), resulting in a colored solution. While stirring, SBA-15-apts was slowly added to the solution of the POM so that the respective amounts of the POM and SBA-15-apts were 5 wt % and 95 wt %, respectively. The mixture was kept under stirring for 24 hours at 40° C., filtered and then washed three times with water. The filtrate was colorless, indicating that the respective POM was quantitatively loaded on the SBA-15-apts support, resulting in a supported POM loading level on the solid support of about 5 wt %. The supported product was then collected and air-dried.

### Example 22

### Activation of Supported POM and Preparation of Supported POM-Derived Metal Cluster Units (Supported “K₂₀Li₈—Rh₄P₈W₄₈”-Derived Metal Cluster Unit, Supported “K₂₀Li₅H₇—Pd₄P₈W₄₈”-Derived Metal Cluster Unit, Supported “K₂₂Li₁₀H₂—Ir₂P₈W₄₈”-Derived Metal Cluster Unit and Supported “K₂₉Li₂H₅—Pt₂P₈W₄₈”-Derived Metal Cluster Unit)

The supported POMs prepared according to example 21 were activated or transformed into the corresponding supported metal cluster units.

In a first example 22a, supported POMs prepared according to example 21 were activated by air calcination at 300° C. for 3 hours. In a second example 22b, supported POMs prepared according to example 21 were converted into corresponding supported POM-derived metal cluster units by H₂ reduction at 300° C., 50 bar for 24 hours. In a third example 22c, supported POMs prepared according to example 21 were treated by the same method of example 22b, but followed with air calcination at 550° C. for 4.5 hours. In a fourth example 22d, supported POMs prepared according to example 21 were converted into corresponding supported POM-derived metal cluster units by a chemical reduction conducted by suspending 100 mg of supported POM in 15 mL of water followed by the addition of about 0.25 mL of hydrazine hydrate. The resulting solution was stirred for 12 hours, filtered, dried and then air calcined at 300° C. for 3 hours.

Without being bound by any theory, it is believed that calcination and optional hydrogenation or chemical reduction helps to activate the POMs by forming active sites.

### Example 23

### Activation of Supported POM and Preparation of Supported POM-Derived Metal Cluster Units (Supported “K₂₀Li₈—Rh₄P₈W₄₈”-Derived Metal Cluster Unit, Supported “K₂₀Li₅H₇—Pd₄P₈W₄₈”-Derived Metal Cluster Unit, Supported “K₂₂Li₁₀H₂—Ir₂P₈W₄₈”-Derived Metal Cluster Unit and Supported “K₂₉Li₂H₅—Pt₂P₈W₄₈”-Derived Metal Cluster Unit)

The supported POMs prepared according to example 21 were activated by air calcination and then transformed into the corresponding supported “supported POM-derived metal cluster units by H₂ reduction.

In a first example 23a, supported POMs prepared according to example 21 were activated by air calcination at 150° C. for 1 hour. In a second example 23b, supported POMs prepared according to example 21 were activated by air calcination at 200° C. for 1 hour. In a third example 23c, supported POMs prepared according to example 21 were activated by air calcination at 300° C. for 30 minutes. In a fourth example 23d, supported POMs prepared according to example 21 were activated by air calcination at 550° C. for 30 minutes.

The activated supported POMs of examples 23a, 23b, 23c and 23d were converted into corresponding supported POM-derived metal cluster units by H₂ reduction at 240° C. and 60 bar under stirring at 1500 rpm for 1-2 minutes. The H₂ reduction was conducted in-situ prior to the further use of the supported POM-derived metal cluster units in order to provide fresh supported POM-derived metal cluster units.

Without being bound by any theory, it is believed that calcination and hydrogenation helps to activate the POMs by forming active sites.

### Example 24

### Synthesis of K₁₆Li₁₀H₆[(Rh-Cp*)₄P₈W₄₈(H₂O)₄O₁₈₄].79H₂O

(RhCp*Cl₂)₂ (C₂₀H₃₀Cl₄Rh₂, 0.009 g, 0.014 mmol) and K₂₈Li₅H₇P₈W₄₈O₁₈₄.92H₂O (0.1 g, 0.0068 mmol (for preparation see, e.g., Inorg. Chem. 1985, 24, 4610-4614; Inorg. Synth. 1990, 27, 110)) were dissolved in 1 M lithium acetate solution (5 mL, pH 6.0). While stirring, 250 μl of a 1 M lithium perchlorate solution were added. The solution was heated in a water bath at 75° C. for 30 min. The resulting clear orange solution was allowed to cool to room temperature and left for crystallization in an open vial. Orange crystals formed after approximately 2 to 3 days, which were collected by filtration and air-dried. Yield: 75 mg (70% based on W). This product was analyzed by XRD, IR, TGA, ³¹P and ¹³C NMR and was identified as {(Rh-Cp*)₄[P₈W₄₈O₁₈₄]}³²⁻ polyanion (“(RhCp*)₄P₈W₄₈”), isolated as hydrated salt K₁₆Li₁₀H₆[(Rh-Cp*)₄P₈W₄₈(H₂O)₄O₁₈₄].79H₂O (“K₁₆Li₁₀H₆—(RhCp*)₄P₈W₄₈”).

### Example 25

### Analysis of “K₁₆Li₁₀H₆—(RhCp*)₄P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm⁻¹ due to metal-oxygen stretching and bending vibrations: 2922 (w), 2854 (w), 1616 (s), 1383 (w), 1134 (s), 1080 (s), 987 (m), 925 (s), 804 (s), 677 (s), 569 (w), 516 (w), 461 (w). The FT-IR spectrum is shown in FIG. 17. Absorption bands between 1134 and 925 cm⁻¹ are attributed to the phosphate heterogroups. The absorption band near 1616 cm⁻¹ belongs to asymmetric bending vibrations of the crystal waters.

Thermogravimetric analysis (TGA) was performed on a SDT Q 600 device from TA Instruments with 10-30 mg samples in 100 μL alumina pans, under a 100 mL/min N₂ flow with a heating rate of 3-5° C./min between 20° C. and 800° C. (FIG. 18). In the case of organometallic derivatives, two weight-loss steps were observed on the thermogram below 800° C. The first one corresponds to the loss of water of crystallization and the second loss corresponds to the loss of the Cp* group. This result is in good agreement with that obtained by elemental analysis to determine the amount of water of crystallization present in the POM.

### Example 26

### Single Crystal X-Ray Diffraction (XRD) Data and Analysis of “K₁₆Li₁₀H₆—(RhCp*)₄P₈W₄₈”

The product was also characterized by single-crystal XRD. The crystal was mounted in a Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all counter cations by XRD, due to crystallographic disorder. Compound “K₁₆Li₁₀H₆—(RhCp*)₄P₈W₄₈” crystallizes in the triclinic space group P-1.

Crystallographic data are detailed in Table 5.

TABLE 5
Crystal data for “K₁₆Li₁₀H₆-(RhCp*)₄P₈W₄₈”

| | |
|---|---|
| Empirical formula | K₁₆Li₁₀H₆(Rh-CP*)₄ |
| | P₈W₄₈(H₂O)₄O₁₈₄•79H₂O |
| Formula weight, g/mol | — |
| Crystal system | Triclinic |
| Space group | P-1 |
| a, Å | 19.9112 (17) |
| b, Å | 22.6883 (19) |
| c, Å | 37.535 (3) |
| α, ° | 80.624 (3) |
| β, ° | 76.490 (2) |
| γ, ° | 83.367 (3) |
| Volume, Å³ | 16214 (2) |
| Z | 2 |
| D_{calc}, g/cm³ | 3.908 |
| Absorption coefficient, mm⁻¹ | 26.106 |
| F (000) | 16344 |
| Theta range for data collection, ° | 1.347 to 25.027 |
| Completeness to Θₘₐₓ % | 100% |
| Index ranges | −23 <= h <= 23, |
| | −27 <= k <= 27, |
| | −44 <= l <= 44 |
| Reflections collected | 327569 |
| Independent reflections | 57250 |
| R (int) | 0.2132 |
| Absorption correction | Semi-empirical |
| | from equivalents |
| Data/restraints/parameters | 57250/48/1677 |
| Goodness-of-fit on F² | 1.053 |
| R₁^{[a]}, wR₂^{[b]} (I > 2σ(I)) | R₁ = 0.0863, |
| | wR₂ = 0.2225 |
| R₁^{[a]}, wR₂^{[b]} (all data) | R₁ = 0.1582, |
| | wR₂ = 0.2723 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 27

### Structure of the “(RhCp*)₄P₈W₄₈” Polyanion

The structure of the “(RhCp*)₄P₈W₄₈” polyanion is displayed in FIGS. 19, 20 and 21. The structure of the “(RhCp*)₄P₈W₄₈” polyanion can be described as the wheel-shaped {P₈W₄₈O₁₈₄} unit encapsulating four pentamethylcyclopentadienyl rhodium (RhCp*) units located slightly outside the cavity due to the steric effect of the pentamethylcyclopentadiene. A water molecule is also connected to each of the four metal centers adjacent to the Cp* ligand.

### Example 28

### ³¹P NMR Spectrum of “K₁₆Li₁₀H₆—(RhCp*)₄P₈W₄₈”

“K₁₆Li₁₀H₆—(RhCp*)₄P₈W₄₈” crystals were dissolved in D₂O. ³¹P NMR spectrum was recorded at 20° C. on a 400 MHz JEOL ECX instrument, using 5 mm tube with resonance frequency 161.9 MHz. The chemical shift is reported with respect to the reference 85 wt % H₃PO₄. The ³¹P NMR spectrum is shown in FIG. 22. “K₁₆Li₁₀H₆—(RhCp*)₄P₈W₄₈” shows two overlapping peaks at −5.65 and −5.76 ppm respectively. The presence of two different peaks in the ³¹P NMR spectrum is consistent with the symmetry of the structure where the two pairs of rhodium atoms are sitting on the opposite sides in the cavity of the wheel. As a result, the four P atoms adjacent to the rhodium atoms have the same environment and will result in a singlet, and the other four P atoms which are further away from the rhodium atoms are also magnetically equivalent and will result in another singlet.

### Example 29

### ¹³C NMR Spectrum of “K₁₆Li₁₀H₆—(RhCp*)₄P₈W₄₈”

“K₁₆Li₁₀H₆—(RhCp*)₄P₈W₄₈” crystals were dissolved in D₂O. ¹³C NMR spectrum was recorded at 20° C. on a 400 MHz JEOL ECX instrument, using 5 mm tube with resonance frequency 100.71 MHz. The chemical shift is reported with respect to the reference Si(CH₃)₄. The ¹³C NMR spectrum is shown in FIG. 23 (top). “K₁₆Li₁₀H₆—(RhCp*)₄P₈W₄₈” showed the two expected carbon signals at 8.8 ppm and 94.1 ppm. The absence of the Rh—C coupling is attributed to the fluxional behavior of the molecule. This hypothesis was confirmed by cooling down the samples to approximately 0° C. and quickly performing a ¹³C NMR measurement. Upon cooling the sample, the broad singlet observed in the measurement performed at room temperature splits and results in the expected doublet showing the Rh—C coupling. FIG. 23 (bottom) shows the ¹³C NMR spectrum of (RhCp*Cl₂)₂ in dichloromethane.

### Example 30

### Synthesis of Kₙ₁Liₙ₂Hₙ₃[(Rh-Cp*)₄P₈W₄₉(H₂O)₄O₁₈₈].wH₂O

(RhCp*Cl₂)₂ (C₂₀H₃₀Cl₄Rh₂ (0.009 g, 0.014 mmol) and K₁₆Li₂H₆P₄W₂₄O₉₄.33H₂O (0.05 g, 0.0068 mmol) were dissolved in a mixture of 1 M sodium acetate solution (3 mL, pH 6.0). While stirring, 250 μl of a 1 M lithium perchlorate solution were added. The solution was heated in a water bath at 60° C. for 30 min, centrifuged to remove the turbidity and left for crystallization. The resulting orange solution was allowed to cool to room temperature and left for crystallization in an open vial. Orange-yellow needles formed after approximately 2 to 3 days, which were collected by filtration and air-dried after one week. This product was analyzed by XRD and IR and was identified as {(Rh-Cp*)₄[P₈W₄₉O₁₈₈]}³⁰⁻ polyanion (“(RhCp*)₄P₈W₄₉”), isolated as hydrated salt Kₙ₁Liₙ₂Hₙ₃[(Rh-Cp*)₄P₈W₄₉(H₂O)₄O₁₈₈].wH₂O (“A₃₀-(RhCp*)₄P₈W₄₉”). The exact counter cation composition and amount of water molecules were not identified.

### Example 31

### Analysis of “A₃₀-(RhCp*)₄P₈W₄₉”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm⁻¹ due to metal-oxygen stretching and bending vibrations: 2923 (w), 2853 (w), 1633 (s), 1569 (m), 1413 (w), 1134 (s), 1084 (s), 1015 (m), 977 (w), 921 (s), 806 (s), 689 (s), 575 (w), 534 (w), 460 (w). The FT-IR spectrum is shown in FIG. 24. Absorption bands between 1134 and 921 cm⁻¹ are attributed to the phosphate heterogroups. The absorption band near 1633 cm⁻¹ belongs to asymmetric vibrations of the crystal waters.

### Example 32

### Single Crystal X-Ray Diffraction (XRD) Data and Analysis of “Aₙ-(RhCp*)₄P₈W₄₉”

The product was also characterized by single-crystal XRD. The crystal was mounted in a Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all counter cations by XRD, due to crystallographic disorder. Compound “A₃₀-(RhCp*)₄P₈W₄₉” crystallizes in the monoclinic space group P 21/n. Crystallographic data are detailed in Table 6.

TABLE 6
Crystal data for “A₃₀-(RhCp*)₄P₈W₄₉”

| | |
|---|---|
| Empirical formula | Kₙ₁Liₙ₂Hₙ₃(Rh-Cp*)₄ |
| | P₈W₄₉(H₂O)₄•wH₂O |
| Formula weight, g/mol | — |
| Crystal system | Monoclinic |
| Space group | P 21/n |
| a, Å | 24.696 (2) |
| b, Å | 29.818 (3) |
| c, Å | 47.445 (4) |
| α, ° | 90 |
| β, ° | 96.989 (3) |
| γ, ° | 90 |
| Volume, Å³ | 34678 (5) |
| Z | 4 |
| D_{calc}, g/cm³ | 4.961 |
| Absorption coefficient, mm⁻¹ | 39.677 |
| F (000) | 43200 |
| Theta range for data collection, ° | 1.366 to 26.466 |
| Completeness to Θₘₐₓ % | 100% |
| Index ranges | −30 <= h <= 30, |
| | −37 <= k <= 37, |
| | −59 <= l <= 59 |
| Reflections collected | 603974 |
| Independent reflections | 71303 |
| R (int) | 0.2345 |
| Absorption correction | Semi-empirical |
| | from equivalents |
| Data/restraints/parameters | 71303/0/1577 |
| Goodness-of-fit on F² | 1.095 |
| R₁^{[a]}, wR₂^{[b]} (I > 2σ(I)) | R₁ = 0.1047, |
| | wR₂ = 0.2413 |
| R₁^{[a]}, wR₂^{[b]} (all data) | R₁ = 0.1963, |
| | wR₂ = 0.2998 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 33

### Structure of the “(RhCp*)₄P₈W₄₉” Polyanion

The structure of the “(RhCp*)₄P₈W₄₉” polyanion can be described as a wheel-shaped {P₈W₄₈O₁₈₄} unit encapsulating four pentamethylcyclopentadienyl rhodium (RhCp*) units located slightly outside the cavity due to the steric effect of the pentamethylcyclopentadiene, similarly to the structure disclosed in FIGS. 19, 20 and 21, but wherein an extra tungsten atom occupies one of the four vacant sites in the cavity of the {P₈W₄₈O₁₈₄} unit, said tungsten atom being in the form of a WO₄²⁻ group. A water molecule is also connected to each of the four metal centers adjacent to the Cp* ligand.

### Example 34

### Synthesis of K₁₆Li₁₀H₆[(Ir-Cp*)₄P₈W₄₈(H₂O)₄O₁₈₄].101H₂O

(IrCp*Cl₂)₂ (C₂₀H₃₀Cl₄Ir₂, 0.011 g, 0.014 mmol) and K₂₈Li₅H₇P₈W₄₈O₁₈₄.92H₂O (0.10 g, 0.0034 mmol (for preparation see, e.g., Inorg. Chem. 1985, 24, 4610-4614; Inorg. Synth. 1990, 27, 110)) were dissolved in a mixture of 1 M sodium acetate solution (3 mL, pH 4.0). While stirring, 250 μl of a 1 M lithium perchlorate solution were added. The solution was heated in a water bath at 75-80° C. for 30 min, centrifuged to remove the turbidity and left for crystallization. The resulting orange solution was allowed to cool to room temperature and left for crystallization in an open vial. Orange-yellow needles formed after approximately 2 to 3 days, which were collected by filtration and air-dried after three days. Yield: 60 mg (56% based on W). This product was analyzed by XRD, IR, elemental analysis, TGA, ³¹P NMR and ¹³C NMR and was identified as {(Ir-Cp*)₄[P₈W₄₈O₁₈₄]}³²⁻ polyanion (“(IrCp*)₄P₈W₄₈”), isolated as hydrated salt K₁₆Li₁₀H₆[(Ir-Cp*)₄P₈W₄₈(H₂O)₄O₁₈₄].wH₂O (“K₁₆Li₁₀H₆—(IrCp*)₄P₈W₄₈”).

### Example 35

### Analysis of “K₁₆Li₁₀H₆—(IrCp*)₄P₈W₄₈”

The IR spectrum with 4 cm⁻¹ resolution was recorded on a Nicolet Avatar 370 FT-IR spectrophotometer on KBr pellet sample (peak intensities: w=weak; m=medium; s=strong). The characteristic region of the polyanion is the fingerprint region or the region between 1000-400 cm⁻¹ due to metal-oxygen stretching and bending vibrations: 2924 (w), 1626 (s), 1384 (w), 1136 (s), 1086 (s), 1020 (m), 928 (s), 808 (s), 688 (s), 573 (w), 532 (w), 463 (w). The FT-IR spectrum is shown in FIG. 25. Absorption bands between 1136 and 928 cm⁻¹ are attributed to the phosphate heterogroups. The absorption band near 1626 cm⁻¹ belongs to asymmetric vibrations of the crystal waters.

Elemental analysis for “K₁₆Li₁₀H₆—(IrCp*)₄P₈W₄₈” calculated (found): K 3.92(3.90), Li 0.44 (0.45), Ir 4.83 (4.82), P 1.56 (1.61), W 55.43 (55.82).

Thermogravimetric analysis (TGA) was performed on a SDT Q 600 device from TA Instruments with 10-30 mg samples in 100 μL alumina pans, under a 100 mL/min N₂ flow with a heating rate of 5° C./min between 20° C. and 800° C. (FIG. 26). Two weight-loss steps were observed on the thermogram below 800° C. The first one corresponds to the loss of water of crystallization and the second loss corresponds to the loss of the Cp* groups.

### Example 36

### Single Crystal X-Ray Diffraction (XRD) Data and Analysis of “K₁₆Li₁₀H₆—(IrCp*)₄P₈W₄₈”

The product was also characterized by single-crystal XRD. The crystal was mounted in a Hampton cryoloop at 100 K using light oil for data collection. Indexing and data collection were carried on a Bruker Kappa X8 APEX II CCD single crystal diffractometer with κ geometry and Mo Kα radiation (λ=0.71073 \acute{Å}). The SHELX software package (Bruker) was used to solve and refine the structure. An empirical absorption correction was applied using the SADABS program as disclosed in G. M. Sheldrick, SADABS, Program for empirical X-ray absorption correction, Bruker-Nonius: Madison, Wis. (1990). The structure was solved by direct method and refined by the full-matrix least squares method (Σw(|Fₒ|²−|F_{c}|²)²) with anisotropic thermal parameters for all heavy atoms included in the model. The H atoms were not located. Also, it was not possible to locate all counter cations by XRD, due to crystallographic disorder. Compound “K₁₆Li₁₀H₆—(IrCp*)₄P₈W₄₈” crystallizes in the triclinic space group P-1. Crystallographic data are detailed in Table 7.

TABLE 7
Crystal data for “K₁₆Li₁₀H₆-(IrCp*)₄P₈W₄₈”

| | |
|---|---|
| Empirical formula | K₁₆Li₁₀H₆(Ir-Cp*)₄ |
| | P₈W₄₈(H₂O)₄O₁₈₄•wH₂O |
| Formula weight, g/mol | — |
| Crystal system | Triclinic |
| Space group | P-1 |
| a, Å | 23.3584 (19) |
| b, Å | 28.210 (2) |
| c, Å | 29.917 (2) |
| α, ° | 68.540 (2) |
| β, ° | 89.697 (3) |
| γ, ° | 69.867 (2) |
| Volume, Å³ | 17061 (2) |
| Z | 2 |
| D_{calc}, g/cm³ | 4.582 |
| Absorption coefficient, mm⁻¹ | 32.326 |
| F (000) | 20096 |
| Theta range for data collection, ° | 1.386 to 27.609 |
| Completeness to Θₘₐₓ % | 99.9% |
| Index ranges | −30 <= h <= 30, |
| | −36 <= k <= 36, |
| | −38 <= l <= 38 |
| Reflections collected | 325517 |
| Independent reflections | 78692 |
| R (int) | 0.1749 |
| Absorption correction | Semi-empirical |
| | from equivalents |
| Data/restraints/parameters | 78692/0/1540 |
| Goodness-of-fit on F² | 1.038 |
| R₁^{[a]}, wR₂^{[b]} (I > 2σ(I)) | R₁ = 0.0966, |
| | wR₂ = 0.2462 |
| R₁^{[a]}, wR₂^{[b]} (all data) | R₁ = 0.1986, |
| | wR₂ = 0.3175 |

^{[a]}R₁ = Σ | |Fₒ| − |F_{c}| | / Σ |Fₒ|.
^{[b]}wR₂ = [Σw(Fₒ² − F_{c}²)²/ Σw(Fₒ²)²]^{1/2}

### Example 37

### Structure of the “(IrCp*)₄P₈W₄₈” Polyanion

The structure of the “(IrCp*)₄P₈W₄₈” polyanion is displayed in FIGS. 27, 28 and 29. The structure of the “(IrCp*)₄P₈W₄₈” polyanion can be described as the wheel-shaped {P₈W₄₈O₁₈₄} unit encapsulating four pentamethylcyclopentadienyl iridium (IrCp*) units located slightly outside the cavity due to the steric effect of the pentamethylcyclopentadiene. A water molecule is also connected to each of the four metal centers adjacent to the Cp* ligand.

### Example 38

### ³¹P NMR Spectrum of “K₁₆Li₁₀H₆—(IrCp*)₄P₈W₄₈”

“K₁₆Li₁₀H₆—(IrCp*)₄P₈W₄₈” crystals were dissolved in D₂O. ³¹P NMR spectrum was recorded at 20° C. on a 400 MHz JEOL ECX instrument, using 5 mm tube with resonance frequency 161.9 MHz. The chemical shift is reported with respect to the reference 85 wt % H₃PO₄. The ³¹P NMR spectrum is shown in FIG. 30. “K₁₆Li₁₀H₆—(IrCp*)₄P₈W₄₈” shows two overlapping peaks at −4.91 and −5.06 ppm. The presence of two different peaks in the ³¹P NMR spectrum is consistent with the symmetry of the structure where the two pairs of iridium atoms are sitting on the opposite sides in the cavity of the wheel. As a result, the four P atoms adjacent to the iridium atoms have the same environment and will result in a singlet, and the other four P atoms which are further away from the iridium atoms are also magnetically equivalent and will result in another singlet. In addition, the ³¹P NMR spectrum shows the presence of an impurity resulting in the peak at −4.0 ppm.

### Example 39

### ¹³C NMR Spectrum of “K₁₆Li₁₀H₆—(IrCp*)₄P₈W₄₈”

“K₁₆Li₁₀H₆—(IrCp*)₄P₈W₄₈” crystals were dissolved in D₂O. ¹³C NMR spectrum was recorded at 20° C. on a 400 MHz JEOL ECX instrument, using 5 mm tube with resonance frequency 100.71 MHz. The chemical shift is reported with respect to the reference Si(CH₃)₄. The ¹³C NMR spectrum is shown in FIG. 31 (top). “K₁₆Li₁₀H₆—(IrCp*)₄P₈W₄₈” shows two peaks, a singlet at 9.5 ppm corresponding to the 5 carbons of the methyl groups and another singlet at 84.4 ppm corresponding to the 5 carbons of the cyclopentadienyl groups. The peak integration shows a ratio of 1:1 corresponding to 5 carbons each which is also consistent with the structure determined by XRD analysis. FIG. 31 (bottom) shows the ¹³C NMR spectrum of (IrCp*Cl₂)₂ in dichloromethane.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

Additionally or alternately, the invention relates to:

Embodiment 1: A polyoxometalate represented by the formula

(Aₙ)^{m+}[(MR′ₜ)ₛO_{y}H_{q}R_{z}(X₈W₄₈₊ᵣO₁₈₄₊₄ᵣ)]^{m-}

or solvates thereof, wherein
each A independently represents a cation,
n is the number of cations,
each M is independently selected from the group consisting of Pd, Pt, Rh, Ir, Ag and Au,
each X is independently selected from the group consisting of P, As, Se and Te,
each R is independently selected from the group consisting of monovalent anions,
each R′ is independently selected from the group consisting of organometallic ligands,
s is a number from 2 to 12,
y is a number from 0 to 24,
q is a number from 0 to 24,
z is a number selected from 0 or 1,
t is a number selected from 0 or 1,
r is 0, 1 or 2, and
m is a number representing the total positive charge m+ of n cations A and the corresponding negative charge m− of the polyanion [(MR′ₜ)ₛO_{y}H_{q}R_{z}(X₈W₄₈₊ᵣO₁₈₄₊₄ᵣ)].

Embodiment 2: Polyoxometalate according to embodiment 1, wherein X₈W₄₈₊ᵣO₁₈₄₊₄ᵣ forms a {X₈W₄₈₊ᵣO₁₈₄₊₄ᵣ} unit and wherein the {X₈W₄₈₊ᵣO₁₈₄₊₄ᵣ} unit has a central cavity, preferably
with the proviso that, if r is 0, the {X₈W₄₈O₁₈₄} unit is a cyclic fragment consisting of 4 X₂W₁₂-based units, wherein each X₂W₁₂-based unit is bonded to two adjacent X₂W₁₂-based units via 4 O atoms, wherein each of said 4 O atoms is bonded to a different W atom of each X₂W₁₂-based unit and wherein every two X₂W₁₂-based units are linked to each other by 2 of said 4 O atoms, wherein in the {X₈W₄₈O₁₈₄} unit each X is linked to 6 different W via a 1 O atom bridge, respectively, and wherein each X is bonded to 4 O and each W is bonded to 6 O, in particular wherein the {X₈W₄₈O₁₈₄} unit is represented by the following formula 1
wherein each O is presented in small Black dots, each W is presented in dark Gray spheres and each X is presented in light Gray sphere,
with the proviso that, if r is 1, the {X₈W₄₈₊₁O₁₈₄₊₄} unit comprises the {X₈W₄₈O₁₈₄} unit and the one extra tungsten atom occupies one of the vacant sites in the cavity of the {X₈W₄₈O₁₈₄} unit, or
with the proviso that, if r is 2, the {X₈W₄₈₊₂O₁₈₄₊₈} unit comprises the {X₈W₄₈O₁₈₄} unit and the two extra tungsten atoms occupy two of the vacant sites in the cavity of the {X₈W₄₈O₁₈₄} unit.

Embodiment 3: Polyoxometalate according to embodiment 1 or 2, wherein all X are the same; preferably wherein all X are P or As, more preferably wherein all X are P.

Embodiment 4: Polyoxometalate according to any one of the preceding embodiments, wherein each M is independently selected from the group consisting of Pd, Pt, Rh and Ir; preferably wherein all M are the same and all M are Pd or Pt or Rh or Ir, or wherein all M are selected from mixtures of Pd and Pt.

Embodiment 5: Polyoxometalate according to any one of the preceding embodiments, wherein t is 1, and R′ is selected from the group of arenes, more preferably benzene (Bz), p-cymene, cyclopentadiene (Cp), or pentamethylcyclopentadiene (Cp*), in particular cyclopentadiene (Cp) or pentamethylcyclopentadiene (Cp*), such as pentamethylcyclopentadiene (Cp*), most preferably each R′ is bonded to one or more M in the form of an organometallic bond, preferably in the form of at least one M-arene organometallic bond, more preferably in the form of at least one M-benzene (M-Bz), M-p-cymene, M-cyclopentadiene (M-Cp), or M-pentamethylcyclopentadiene (M-Cp*) organometallic bond, in particular in the form of M-cyclopentadiene (M-Cp) or M-pentamethylcyclopentadiene (M-Cp*) organometallic bond, such as in the form of M-pentamethylcyclopentadiene (M-Cp*) organometallic bond.

Embodiment 6: Polyoxometalate according to any one of the preceding embodiments, wherein each R is independently selected from the group consisting of F, Cl, Br, I, CN, N₃, CP, FHF, SH, SCN, NCS, SeCN, CNO, NCO and OCN, preferably F, Cl, Br, I, CN, and N₃, more preferably Cl, Br, I and N₃, most preferably Cl, Br and I, in particular Cl.

Embodiment 7: Polyoxometalate according to any one of the preceding embodiments, wherein s is 2, 4, 6, 8, 10 or 12 and r is 0, 1 or 2; preferably wherein s is 2, 4, 6, 8, 10 or 12 and r is 0 or 1; more preferably wherein s is 2, 4, 6, 8, or 12 and r is 0 or 1; most preferably wherein s is 2, 4 or 6 and r is 0 or 1.

Embodiment 8: Polyoxometalate according to any one of the preceding embodiments, wherein q is 0 to 18, preferably wherein q is 0 to 12; more preferably wherein q is 0 to 10; most preferably wherein q is 0 to 8, in particular wherein q is 0, 1, 2, 3, 4, 5, 6, 7, 8, 9, 10, 11, 12 or 24, more particularly wherein q is 0, 1, 2, 3, 4, 5, 6, 7, 8 or 12; even more particularly wherein q is 0, 2, 4, 5, 6, 7 or 8.

Embodiment 9: Polyoxometalate according to any one of the preceding embodiments, wherein y is 0, 2, 4, 6, 8, 10, 12 or 24, preferably wherein y is 0, 2, 4, 6, 8 or 12; more preferably wherein y is 0, 2, 4, 6 or 8; most preferably wherein y is 0, 2, 4 or 8, in particular y is 0.

Embodiment 10: Polyoxometalate according to any one of the preceding embodiments, wherein z is 0.

Embodiment 11: Polyoxometalate according to any one of the preceding embodiments, wherein all M are Ir, Rh, Pd or Pt or wherein M is a mixture of Pd and Pt, and X is P, preferably wherein s is 2, 4 or 6, r is 0 or 1, and z is 0, more preferably wherein s is 2, 4 or 6, r is 0 or 1, and z is 0; in particular all M are Ir, Rh, Pd or Pt and X is P; more particularly wherein s is 4 or 6, r is 0 or 1, and z is 0.

Embodiment 12: Polyoxometalate according to any one of the preceding embodiments, wherein, each A is independently selected from the group consisting of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof; preferably from the group consisting of Li, K, Na and combinations thereof.

Embodiment 13: Polyoxometalate according to any one of the preceding embodiments, represented by the formula

(Aₙ)^{m+}[(MR′ₜ)ₛO_{y}H_{q}R_{z}(X₈W₄₈₊ᵣO₁₈₄₊₄ᵣ)]^{m-}.wH₂O

wherein w represents the number of attracted water molecules per polyanion [(MR′ₜ)ₛO_{y}H_{q}R_{z}(X₈W₄₈₊ᵣO₁₈₄₊₄ᵣ)], and ranges from 1 to 180, preferably from 20 to 160, more preferably from 50 to 150, most preferably from 80 to 140.

Embodiment 14: Polyoxometalate according to any one of the preceding embodiments, wherein the polyoxometalate is in the form of a solution-stable polyanion.

Embodiment 15: Process for the preparation of the polyoxometalate of any one of embodiments 1 to 14, said process comprising:
(a) reacting at least one source of M and at least one source of {X₈W₄₈₊ᵣO₁₈₄₊₄ᵣ} and optionally at least one source of R and/or R′ to form a salt of the polyanion [(MR′ₜ)ₛO_{y}H_{q}R_{z}(X₈W₄₈₊ᵣO₁₈₄₊₄ᵣ)] or a solvate thereof,
(b) optionally adding at least one salt of A to the reaction mixture of step (a) to form a polyoxometalate (Aₙ)^{m+}[(MR′ₜ)ₛO_{y}H_{q}R_{z}(X₈W₄₈₊ᵣO₁₈₄₊₄ᵣ)]^{m-} or a solvate thereof, and
(c) recovering the polyoxometalate or solvate thereof.

Embodiment 16: Process according to embodiment 15, wherein the at least one source of {X₈W₄₈₊ᵣO₁₈₄₊₄ᵣ} is an X₂W₁₂-based species, an X₄W₂₄-based species, an X₈W₄₈-based species, or a combination thereof, wherein the X₂W₁₂-based species and/or the X₄W₂₄-based species form an X₈W₄₈-based species in situ.

Embodiment 17: Process according to embodiment 15 or 16, wherein in step (a) the concentration of the metal ions originating from the source of M ranges from 0.001 to 1 mole/1, the concentration of the X₈W₄₈-based species originating from the sources of {X₈W₄₈₊ᵣO₁₈₄₊₄ᵣ} ranges from 0.0001 to 0.1 mole/l, optionally the concentration of the R-containing starting material ranges from 0.001 to 1 mole/l and optionally the concentration of the R′-containing starting material ranges from 0.001 to 5 mole/l.

Embodiment 18: Process according to any one of embodiments 15 to 17, wherein in step (a) at least one source of M is used and wherein all M are the same such as all M are Pd or Pt or Ir or Rh or wherein M is a mixture of Pd and Pt.

Embodiment 19: Process according to any one of embodiments 15 to 18, wherein water, an organic solvent or a combination thereof is used as solvent, preferably water or a combination of water with an organic solvent is used as solvent, in particular water is used as solvent.

Embodiment 20: Process according to embodiment 19, wherein the solvent contains water and the at least one source of M is a water-soluble salt of Pt^{II} or Pd^{II} or Rh^{III} or Ir^{III} or Au^{III} or Ag^{III}, preferably wherein M is Pt, platinum chloride (PtCl₂) or potassium tetrachloroplatinate (K₂PtCl₄); wherein M is Pd, palladium nitrate (Pd(NO₃)₂), palladium sulphate (PdSO₄), palladium chloride (PdCl₂) or palladium acetate (Pd(CH₃COO)₂); wherein M is Rh, rhodium chloride (RhCl₃), rhodocene ([Rh(Cp)₂]), pentamethylcyclopentadienyl rhodium chloride ([Rh(Cp*)Cl₂]₂), benzene rhodium chloride ([Rh(Bz)Cl₂]₂), p-cymene rhodium chloride ([Rh(p-cymene)Cl₂]₂), rhodium(II) acetate (C₈H₁₂O₈Rh₂); wherein M is Ir, iridium chloride (IrCl₃), pentamethylcyclopentadienyl iridium chloride ([Ir(Cp*)Cl₂]₂), benzene iridium chloride ([Ir(Bz)Cl₂]₂), or p-cymene iridium chloride ([Ir(p-cymene)Cl₂]₂); wherein M is Au, gold chloride (AuCl₃), gold hydroxide (Au(OH)₃) or chloroauric acid (HAuCl₄); wherein M is Ag, Ag^{III} salts preferably generated with oxidizing agents from Ag^{I} salts such as silver nitrate (AgNO₃), silver fluoride (AgF) or silver chloride (AgCl); the at least one source of {X₈W₄₈₊ᵣO₁₈₄₊₄ᵣ} is a water-soluble [X₄W₂₄O₉₄]²⁴⁻ or [X₈W₄₈O₁₈₄]⁴⁰⁻ salt, preferably a [X₄W₂₄O₉₄]²⁴⁻ or [X₈W₄₈O₁₈₄]⁴⁰⁻ salt of lithium, sodium, potassium, hydrogen or a combination thereof, more preferably a [X₄W₂₄O₉₄]²⁴⁻ or [X₈W₄₈O₁₈₄]⁴⁰⁻ salt of lithium, potassium, hydrogen or a combination thereof, in particular a [X₄W₂₄O₉₄]²⁴⁻ or [X₈W₄₈O₁₈₄]⁴⁰⁻ salt of a combination of lithium, potassium and hydrogen.

Embodiment 21: Process according to any one of embodiments 15 to 20, wherein step (a) is carried out in an aqueous solution, and the pH of the aqueous solution ranges from 1 to 10, preferably from 2 to 8, and more preferably from 3 to 7.

Embodiment 22: Process according to embodiment 21, wherein in step (a) the at least one source of M and the at least one source of {X₈W₄₈₊ᵣO₁₈₄₊₄ᵣ} are dissolved in a solution of a buffer, preferably a 0.1 to 5.0 M solution of a buffer, in particular a 0.25 to 2.5 M solution of a buffer, and most preferred a 1.0 M solution of a buffer; wherein preferably the buffer is a acetate buffer and most preferably said acetate buffer is derived from lithium acetate or sodium acetate.

Embodiment 23: Process according to any one of embodiments 15 to 22, wherein in step (a) the reaction mixture is heated to a temperature of from 20° C. to 100° C., preferably from 50° C. to 90° C., more preferably from 60° C. to 80° C.

Embodiment 24: Supported polyoxometalate comprising polyoxometalate according to any one of embodiments 1 to 14 or prepared according to any one of embodiments 15 to 23, on a solid support.

Embodiment 25: Supported polyoxometalate according to embodiment 24, wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.

Embodiment 26: Process for the preparation of supported polyoxometalate according to embodiment 24 or 25, comprising the step of contacting polyoxometalate according to any one of embodiments 1 to 14 or prepared according to any one of embodiments 15 to 23, with a solid support.

Embodiment 27: Metal cluster unit of the formula

(A′_{n′})^{m′+}[M⁰ₛ(X₈W₄₈₊ᵣO₁₈₄₊₄ᵣ)]^{m′-},

wherein
each A′ independently represents a cation,
n′ is the number of cations,
each M⁰ is independently selected from the group consisting of Pd⁰, Pt⁰, Rh⁰, Ir⁰, Ag⁰, and Au⁰,
each X is independently selected from the group consisting of P, As, Se and Te,
s is a number from 2 to 12,
r is 0, 1 or 2, and
m′ is a number representing the total positive charge m′+ of n′ cations A′ and the corresponding negative charge m′− of the metal cluster unit anion [M⁰ₛ(X₈W₄₈₊ᵣO₁₈₄₊₄ᵣ)].

Embodiment 28: Metal cluster unit according to embodiment 27, wherein r is 0 and X₈W₄₈O₁₈₄ forms a {X₈W₄₈O₁₈₄}′ unit, preferably the {X₈W₄₈O₁₈₄}′ unit has a central cavity, more preferably the {X₈W₄₈O₁₈₄}′ unit is a cyclic fragment consisting of 4 X₂W₁₂-based units, wherein each X₂W₁₂-based unit is bonded to two adjacent X₂W₁₂-based units via 4 O atoms, wherein each of said 4 O atoms is bonded to a different W atom of each X₂W₁₂-based unit and wherein every two X₂W₁₂-based units are linked to each other by 2 of said 4 O atoms, wherein in the {X₈W₄₈O₁₈₄}′ unit each X is linked to 6 different W via a 1 O atom bridge, respectively, and wherein each X is bonded to 4 O and each W is bonded to 6 O, in particular wherein the {X₈W₄₈O₁₈₄}′ unit is represented by the following formula 1

wherein each O is presented in small Black dots, each W is presented in dark Gray spheres and each X is presented in light Gray sphere.

Embodiment 29: Metal cluster unit according to embodiment 27 or 28, wherein all X are the same; preferably wherein all X are P or As, more preferably wherein all X are P.

Embodiment 30: Metal cluster unit according to any one of the embodiments 27 to 29, wherein each M⁰ is independently selected from the group consisting of Pd⁰, Pt⁰, Rh⁰ and Ir⁰; in particular wherein all M⁰ are the same and all M⁰ are Pd⁰ or Pt⁰ or Rh⁰ or Ir⁰, or wherein all M are selected from mixtures of Pd⁰ and Pt⁰.

Embodiment 31: Metal cluster unit according to any one of the embodiments 27 to 30, wherein s is 2, 4, 6, 8, 10 or 12 and r is 0, 1 or 2; preferably wherein s is 2, 4, 6, 8, 10 or 12 and r is 0 or 1; more preferably wherein s is 2, 4, 6, 8 or 12 and r is 0 or 1; most preferably wherein s is 2, 4 or 6 and r is 0 or 1.

Embodiment 32: Metal cluster unit according to any one of the embodiments 27 to 31, wherein m′ is 40 when r is 0, m′ is 42 when r is 1, and m′ is 44 when r is 2.

Embodiment 33: Metal cluster unit according to any one of the embodiments 27 to 32, wherein, each A′ is independently selected from the group consisting of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof; preferably from the group consisting of Li, K, Na, and combinations thereof.

Embodiment 34: Metal cluster unit according to any one of the embodiments 27 to 33, wherein the metal cluster unit is in the form of particles, preferably wherein at least 90 wt % of the metal cluster unit particles are in the form of primary particles.

Embodiment 35: Metal cluster unit according to any one of the embodiments 27 to 34, wherein the metal cluster unit is dispersed in a liquid carrier medium thereby forming a dispersion of metal cluster unit in said liquid carrier medium; and wherein preferably a dispersing agent is present to prevent agglomeration of the primary particles of metal cluster unit, and in particular the dispersing agent forms micelles containing one primary particle of metal cluster unit per micelle.

Embodiment 36: Metal cluster unit according to any one of the embodiments 27 to 34, wherein the metal cluster unit is immobilized on a solid support thereby forming supported metal cluster unit.

Embodiment 37: Supported metal cluster unit according to embodiment 36, wherein the solid support is selected from polymers, graphite, carbon nanotubes, electrode surfaces, aluminum oxide and aerogels of aluminum oxide and magnesium oxide, titanium oxide, zirconium oxide, cerium oxide, silicon dioxide, silicates, active carbon, mesoporous silica, zeolites, aluminophosphates (ALPOs), silicoaluminophosphates (SAPOs), metal organic frameworks (MOFs), zeolitic imidazolate frameworks (ZIFs), periodic mesoporous organosilicas (PMOs), and mixtures thereof.

Embodiment 38: Process for the preparation of the dispersion of metal cluster unit of embodiment 35, said process comprising the steps of
(a) dissolving the polyoxometalate of any one of embodiments 1 to 14 or prepared according to any one of embodiments 15 to 23, in a liquid carrier medium,
(b) optionally providing additive means to prevent agglomeration of the metal cluster unit to be prepared, and
(c) subjecting the dissolved polyoxometalate to chemical or electrochemical reducing conditions sufficient to at least partially reduce said polyoxometalate into corresponding metal cluster unit.

Embodiment 39: Process for the preparation of the supported metal cluster units of embodiment 36 or 37, comprising the steps of
(a) contacting the dispersion of metal cluster unit of embodiment 35 or prepared according to embodiment 38 with a solid support, thereby immobilizing at least part of the dispersed metal cluster unit onto the support; and
(b) optionally isolating the supported metal cluster unit.

Embodiment 40: Process for the preparation of the supported metal cluster units of embodiment 36 or 37, comprising the steps of
(a) subjecting the supported polyoxometalate of embodiment 24 or 25 or prepared according to embodiment 26 to chemical or electrochemical reducing conditions sufficient to at least partially reduce said polyoxometalate into corresponding metal cluster unit; and
(b) optionally isolating the supported metal cluster unit.

Embodiment 41: Process according to any one of embodiments 38 or 40, wherein the chemical reducing conditions comprise the use of a reducing agent selected from organic and inorganic materials which are oxidizable by Pd^{II}, Pt^{II}, Rh^{I} and Rh^{III}, Ir^{I} and Ir^{III}, Ag^{I} and Ag^{III}, and Au^{I} and Au^{III}.

Embodiment 42: Process for the homogeneous or heterogeneous conversion of organic substrate comprising contacting said organic substrate with the polyoxometalate of any one of embodiments 1 to 14 or prepared according to any one of embodiments 15 to 23, and/or with the supported polyoxometalate of embodiment 24 or 25 or prepared according to embodiment 26, and/or with the metal cluster unit of any one of embodiments 27 to 34, and/or with the dispersion of metal cluster unit of embodiment 35 or prepared according to embodiment 38 or 41, and/or with the supported metal cluster unit of embodiment 36 or 37 or prepared according to any one of embodiments 39 to 41.

Embodiment 43: Process according to embodiment 42, comprising:
(a) contacting a first organic substrate with one or more optionally supported polyoxometalates and/or one or more supported metal cluster units,
(b) recovering the one or more optionally supported polyoxometalates and/or the one or more supported metal cluster units;
(c) contacting the one or more optionally supported polyoxometalates and/or the one or more supported metal cluster units with a solvent at a temperature of 50° C. or more, and/or hydrogen stripping the one or more optionally supported polyoxometalates and/or the one or more supported metal cluster units at elevated temperature, and/or calcining the one or more optionally supported polyoxometalates and/or the one or more supported metal cluster units at elevated temperature under an oxygen containing gas, e.g. air, or under an inert gas, e.g. nitrogen or argon, to obtain recycled one or more optionally supported polyoxometalates and/or one or more supported metal cluster units;
(d) contacting the recycled one or more optionally supported polyoxometalates and/or the one or more supported metal cluster units with a second organic substrate which may be the same as or different from the first organic substrate; and
(e) optionally repeating steps (b) to (d).

1. Polyoxometalate represented by the formula
(Aₙ)^{m+}[(MR′ₜ)ₛO_{y}H_{q}R_{z}(X₈W₄₈₊ᵣO₁₈₄₊₄ᵣ)]^{m-}
or solvates thereof, wherein
each A independently represents a cation,
n is the number of cations,
each M is independently selected from the group consisting of Pd, Pt, Rh, Ir, Ag and Au,
each X is independently selected from the group consisting of P, As, Se and Te,
each R is independently selected from the group consisting of monovalent anions,
each R′ is independently selected from the group consisting of organometallic ligands,
s is a number from 2 to 12,
y is a number from 0 to 24,
q is a number from 0 to 24,
z is a number selected from 0 or 1,
t is a number selected from 0 or 1,
r is a number selected from 0, 1 or 2, and
m is a number representing the total positive charge m+ of n cations A and the corresponding negative charge m− of the polyanion [(MR′ₜ)ₛO_{y}H_{q}R_{z}(X₈W₄₈₊ᵣO₁₈₄₊₄ᵣ)].

2. The polyoxometalate according to claim 1, wherein X₈W₄₈₊ᵣO₁₈₄₊₄ᵣ forms a {X₈W₄₈₊ᵣO₁₈₄₊₄ᵣ} unit and wherein the {X₈W₄₈₊ᵣO₁₈₄₊₄ᵣ} unit has a central cavity,
with the proviso that, if r is 0, the {X₈W₄₈O₁₈₄} unit is a cyclic fragment consisting of 4 X₂W₁₂-based units, wherein each X₂W₁₂-based unit is bonded to two adjacent X₂W₁₂-based units via 4 O atoms, wherein each of said 4 O atoms is bonded to a different W atom of each X₂W₁₂-based unit and wherein every two X₂W₁₂-based units are linked to each other by 2 of said 4 O atoms, wherein in the {X₈W₄₈O₁₈₄} unit each X is linked to 6 different W via a 1 O atom bridge, respectively, and wherein each X is bonded to 4 O and each W is bonded to 6 O, in particular wherein the {X₈W₄₈O₁₈₄} unit is represented by the following formula 1 [symbol]
wherein each O is presented in small Black dots, each W is presented in dark Gray spheres and each X is presented in light Gray sphere,
with the proviso that, if r is 1, the {X₈W₄₈₊₁O₁₈₄₊₄} unit comprises the {X₈W₄₈O₁₈₄} unit and the one extra tungsten atom occupies one of the vacant sites in the cavity of the {X₈W₄₈O₁₈₄} unit, or
with the proviso that, if r is 2, the {X₈W₄₈₊₂O₁₈₄₊₈} unit comprises the {X₈W₄₈O₁₈₄} unit and the two extra tungsten atoms occupy two of the vacant sites in the cavity of the {X₈W₄₈O₁₈₄} unit.

3. The polyoxometalate according to claim 1, wherein all M are Ir, Rh, Pd or Pt or wherein M is a mixture of Pd and Pt, and X is P or As, wherein s is 2, 4 or 6, r is 0 or 1, and z is 0.

4. The polyoxometalate according to claim 1, wherein t is 1, and R′ is selected from the group of arenes.

5. The polyoxometalate according to claim 1, wherein each R is independently selected from the group consisting of F, Cl, Br, I, CN, N₃, CP, FHF, SH, SCN, NCS, SeCN, CNO, NCO and OCN and wherein, each A is independently selected from the group consisting of Li, Na, K, Rb, Cs, Mg, Ca, Sr, Ba, Sc, Ti, V, Cr, Mn, Fe, Co, Ni, Cu, Zn, Y, Zr, Nb, Mo, Ru, Rh, Pd, Ag, Cd, Hf, Re, Os, Ir, Pt, Au, Hg, lanthanide metal, actinide metal, Al, Ga, In, Tl, Sn, Pb, Sb, Bi, phosphonium, ammonium, guanidinium, tetraalkylammonium, protonated aliphatic amines, protonated aromatic amines or combinations thereof.

6. The polyoxometalate according to claim 1, represented by the formula
(Aₙ)^{m+}[(MR′ₜ)ₛO_{y}H_{q}R_{z}(X₈W₄₈₊ᵣO₁₈₄₊₄ᵣ)]^{m-}.wH₂O
wherein w represents the number of attracted water molecules per polyanion [(MR′ₜ)ₛO_{y}H_{q}R_{z}(X₈W₄₈₊ᵣO₁₈₄₊₄ᵣ)], and ranges from 1 to 180.

7. The polyoxometalate according to claim 1, wherein the polyoxometalate is in the form of a solution-stable polyanion.

8. Process for the preparation of the polyoxometalate of claim 1, said process comprising:
(a) reacting at least one source of M and at least one source of {X₈W₄₈₊ᵣO₁₈₄₊₄ᵣ} and optionally at least one source of R and/or R′ to form a salt of the polyanion [(MR′ₜ)ₛO_{y}H_{q}R_{z}(X₈W₄₈₊ᵣO_{184′4r})]^{m-} or a solvate thereof,
(b) optionally adding at least one salt of A to the reaction mixture of step (a) to form a polyoxometalate (Aₙ)^{m+}[(MR′ₜ)ₛO_{y}H_{q}R_{z}(X₈W₄₈₊ᵣO₁₈₄₊₄ᵣ)]^{m-} or a solvate thereof, and
(c) recovering the polyoxometalate or solvate thereof.

9. The process according to claim 8, wherein the at least one source of {X₈W₄₈₊ᵣO₁₈₄₊₄ᵣ} is an X₂W₁₂-based species, an X₄W₂₄-based species, an X₈W₄₈-based species, or a combination thereof, wherein the X₂W₁₂-based species and/or the X₄W₂₄-based species form an X₈W₄₈-based species in situ.

10. Supported polyoxometalate comprising the polyoxometalate according to claim 1, on a solid support.

11. (canceled)

12. Metal cluster unit of the formula
(A′_{n′})^{m+}[M⁰ₛ(X₈W₄₈₊ᵣO₁₈₄₊₄ᵣ)]^{m′-},
wherein
each A′ independently represents a cation,
n′ is the number of cations,
each M⁰ is independently selected from the group consisting of Pd⁰, Pt⁰, Rh⁰, Ir⁰, Ag⁰, and Au⁰,
each X is independently selected from the group consisting of P, As, Se and Te,
s is a number from 2 to 12,
r is 0, 1 or 2, and
m′ is a number representing the total positive charge m′+ of n′ cations A′ and the corresponding negative charge m′− of the metal cluster unit anion [M⁰ₛ(X₈W₄₈₊ᵣO₁₈₄₊₄ᵣ)].

13. The metal cluster unit according to claim 12, wherein all X are the same and are P or As; all M⁰ are the same and all M⁰ are Pd⁰ or Pt⁰ or Rh⁰ or Ir⁰, or wherein all M are selected from mixtures of Pd⁰ and Pt⁰; s is 2, 4, 6, 8 or 12 and r is 0 or 1.

14. The metal cluster unit according to claim 12, wherein the metal cluster unit is in the form of particles.

15. The metal cluster unit according to claim 12, wherein the metal cluster unit is dispersed in a liquid carrier medium thereby forming a dispersion of metal cluster unit in said liquid carrier medium.

16. The metal cluster unit according to claim 12, wherein the metal cluster unit is immobilized on a solid support thereby forming supported metal cluster unit.

17-20. (canceled)
